(19) United States
(12) Patent Application Publication
(10) Pub. No.: US 2025/0259536 A1
(43) Pub. Date: Aug. 14, 2025

(54) DIGITAL ROAD NETWORK TRAFFIC STATE RECKONING METHOD BASED ON MULTI-SCALE CALCULATION

(71) Applicant: SOUTH CHINA UNIVERSITY OF TECHNOLOGY, Guangzhou, Guangdong (CN)

(72) Inventors: Kai LU, Guangzhou (CN); Yaoting WU, Guangzhou (CN); Shuyan JIANG, Guangzhou (CN); Yanglin CHEN, Guangzhou (CN); Yanfang SHOU, Guangzhou (CN)

(73) Assignee: SOUTH CHINA UNIVERSITY OF TECHNOLOGY, Guangzhou, Guangdong (CN)

(21) Appl. No.: 18/864,585

(22) PCT Filed: Oct. 12, 2022
(86) PCT No.: PCT/CN2022/124945

§ 371 Date: Nov. 11, 2024

(30) Foreign Application Priority Data
May 11, 2022 (CN) 202210506795.8

(51) Int. Cl. G08G 1/01

(52) U.S. Cl. CPC G08G 1/0133

(57) ABSTRACT

The present invention discloses a digital road network traffic state reckoning method based on multi-scale calculation, including: S1, acquiring traffic weight coefficients of vehicles according to free-flow driving times of the vehicles and an overall free-flow driving time of a road network; S2, calculating traffic weight coefficients of evaluation objects in the road network at different spatial scales in combination with the traffic weight coefficients of the vehicles and a composition structure of the road network; S3, reckoning traffic operation indexes of the different evaluation objects in the road network by using an average travel time and the traffic weight coefficients of the vehicles; S4, reckoning delay time indexes and average delay times of the different evaluation objects in the road network by using an average delay time and the traffic weight coefficients of the vehicles; S5, reckoning indexes of the numbers of times of stopping and average numbers of times of stopping of the different evaluation objects in the road network by using an average number of times of stopping and the traffic weight coefficients of the vehicles; and S6, reckoning indexes of mileages of congested roads and proportions of mileages of heavily congested roads of the different evaluation objects in the road network by using the mileages of the heavily congested roads and the traffic weight coefficients of the vehicles.

### CROSS-REFERENCE TO RELATED APPLICATION

This is the U.S. National Stage of International Patent Application No. PCT/CN2022/124945 filed on Oct. 12, 2022, which claims the benefit of priority to Chinese Patent Application No. 202210506795.8, filed May 11, 2022.

### FIELD OF THE INVENTION

The present invention relates to the technical field of traffic operation evaluation, and in particular to a digital road network traffic state reckoning method based on multi-scale calculation.

### BACKGROUND OF THE INVENTION

As characteristic indexes for evaluating urban road network traffic operation states, a traffic operation index, an average delay time, an average number of times of stopping, and a proportion of a mileage of a heavily congested road have been proposed in the national and local urban traffic operation state evaluation norms and standards consecutively. They are important indexes that comprehensively reflect smooth flows and congestion of urban road traffic operation, and have good comparability, relative independence, and an ability of quantitatively describing the road traffic operation states.

However, at present, relevant evaluation and analysis on traffic operation states of a road network based on the traffic operation state evaluation indexes are mainly to calculate evaluation indexes reflecting traffic operation states of one evaluation object within different evaluation periods, so as to perform comparison to obtain relevant evaluation conclusions. An existing method is usually difficultly applicable to analysis and calculation on various evaluation objects in different sizes, with different structures, and at different scales in a road network. At the same time, deepening development of an intelligent transportation technology puts forward new requirements for research, judgment, and analysis on the urban road network traffic operation states. How to construct a digital urban traffic road network and analyze the operation states from a macro-view road network to a medium-view road to a lane and even a single vehicle has become an internal need for intelligent urban traffic management and control.

Therefore, how to unify traffic operation state calculation methods for various evaluation objects through scientific and reasonable normalization processing to form a digital road network traffic state reckoning method based on multi-scale calculation, which provides technical support for a design on an urban traffic digital road network architecture, so as to have important theoretical value and practical significance.

### SUMMARY OF THE INVENTION

A purpose of the present invention is to provide a digital road network traffic state reckoning method based on multi-scale calculation, which, on the basis of normalizing traffic operation state evaluation indexes, weights different compositions in a road network by means of traffic weight coefficients, so as to unify traffic operation state evaluation methods in aspects of an evaluation time, an evaluation space, and an evaluation range, thereby enabling relevant evaluation indexes to be applied to evaluation on urban road network traffic operation states in different sizes, with different structures, and at different scales.

In order to achieve the above purpose of the present invention, the present invention provides the following technical solution:

A digital road network traffic state reckoning method based on multi-scale calculation provided by the present invention includes the following steps:
S1, acquiring traffic weight coefficients of vehicles according to free-flow driving times of the vehicles and an overall free-flow driving time of a road network;
S2, calculating traffic weight coefficients of evaluation objects in the road network at different spatial scales level by level in combination with the traffic weight coefficients of the vehicles and a composition structure of the road network;
S3, reckoning traffic operation indexes of various lanes, various sub-sections, various sections, various intersections, various roads, various sub-zones, and the road network by using an average travel time, the free-flow driving times, and the traffic weight coefficients of the vehicles;
S4, reckoning delay time indexes of various lanes, various sub-sections, various sections, various intersections, various roads, various sub-zones, and the road network by using an average delay time, the free-flow driving times, and the traffic weight coefficients of the vehicles, and calculating average delay times of various evaluation objects at the different spatial scales in combination with the free-flow driving times of the vehicles;
S5, reckoning indexes of numbers of times of stopping of various lanes, various sub-sections, various sections, various intersections, various roads, various sub-zones, and the road network by using an average number of times of stopping, the free-flow driving times, and the traffic weight coefficients of the vehicles, and calculating average numbers of times of stopping of various evaluation objects at the different spatial scales in combination with the free-flow driving times of the vehicles; and
S6, reckoning indexes of mileages of congested roads of various lanes, various sub-sections, various sections, various intersections, various roads, various sub-zones, and the road network by using mileages of heavily congested roads, the free-flow driving times, and the traffic weight coefficients of the vehicles, and calculating proportions of the mileages of the heavily congested roads of various evaluation objects at the different spatial scales in combination with free-flow driving speeds of the vehicles.

As a preferred technical solution, in step S1, the traffic weight coefficient of each vehicle is a ratio of the overall free-flow driving time of a certain passing vehicle in the road network to the overall free-flow driving time of all vehicles in the road network, which is obtained by summing the traffic weight coefficients of the vehicle on various through lanes in the road network, and reflects a proportion of the certain passing vehicle occupying an overall road time-space resource of the road network; and a formula of the traffic weight coefficient is as follows:

$${w}_{v}^{V} = \frac{{t}_{{f}_{v}}^{V}}{{\sum }_{v = 1}^{{N}^{V}} {t}_{{f}_{v}}^{V}} = \frac{{\sum }_{l ∈ {S}_{V , v}^{L}} {t}_{{f}_{( v , l )}}^{V}}{{\sum }_{v = 1}^{{N}^{V}} {\sum }_{l ∈ {S}_{V , v}^{L}} {t}_{{f}_{( v , l )}}^{V}} = \frac{{\sum }_{l ∈ {S}_{V , v}^{L}} {t}_{{f}_{l}}^{L}}{{\sum }_{v = 1}^{{N}^{V}} {\sum }_{l ∈ {S}_{V , v}^{L}} {t}_{{f}_{l}}^{L}} = {\sum }_{l ∈ {S}_{V , v}^{L}} \frac{{t}_{{f}_{l}}^{L}}{{\sum }_{v = 1}^{{N}^{V}} {\sum }_{l ∈ {S}_{V , v}^{L}} {t}_{{f}_{l}}^{L}} = {\sum }_{l ∈ {S}_{V , v}^{L}} {w}_{( v , l )}^{V}$$

wherein wᵥ^{V} is a traffic weight coefficient of the v^{th} vehicle Vᵥ in the road network; t_{fv}^{V} is an overall free-flow driving time of the vehicle Vᵥ passing the road network; N^{V} is the number of vehicles passing the road network within an evaluation period; S_{V,v}^{L} is a set of lanes through which the vehicle Vᵥ passes in the road network within the evaluation period; t_{f(v,l)}^{V} is a free-flow driving time of the vehicle Vᵥ passing the l^{th} lane Lₗ in the road network; t_{fl}^{L} is an average free-flow driving time of the vehicles passing the lane Lₗ; and w_{(v,l)}^{V} is a traffic weight coefficient of the vehicle Vᵥ on the lane Lₗ.

As a preferred technical solution, step S2 is specifically as follows:
according to a definition of the traffic weight coefficient, for the traffic weight coefficients of each evaluation object in the road network at the different spatial scales, each value is a ratio of the overall free-flow driving time of all the passing vehicles within a period of time to the overall free-flow driving time of all the vehicles in the whole road network for each evaluation object; and the traffic weight coefficients of all compositions belonging to one evaluation object at a same spatial scale are summed to obtain the traffic weight coefficient of the evaluation object, which is specifically as follows:
a traffic weight coefficient of the vehicle Vᵥ passing the lane Lₗ is reckoned as follows:

$${w}_{( v , l )}^{V} = \frac{{t}_{{f}_{( v , l )}}^{V}}{{\sum }_{v = 1}^{{N}^{V}} {\sum }_{l ∈ {S}_{V , v}^{L}} {t}_{{f}_{( v , l )}}^{V}}$$

a traffic weight coefficient of the lane Lₗ is reckoned as follows:

$${w}_{l}^{L} = \frac{{\sum }_{v ∈ {S}_{L , l}^{V}} {t}_{{f}_{( v , l )}^{V}}}{{\sum }_{v = 1}^{{N}^{V}} {\sum }_{l ∈ {S}_{V , v}^{L}} {t}_{{f}_{( v , l )}^{V}}} = {\sum }_{V ∈ {S}_{L , l}^{V}} \frac{{t}_{{f}_{( v , l )}^{V}}}{{\sum }_{v = 1}^{{N}^{V}} {\sum }_{l ∈ {S}_{V , v}^{L}} {t}_{{f}_{( v , l )}^{V}}} = {\sum }_{v ∈ {S}_{L , l}^{V}} {w}_{( v , l )}^{V}$$

a traffic weight coefficient of a subsection Uᵤ is reckoned as follows:

$${w}_{u}^{U} = \frac{{\sum }_{l ∈ {S}_{U , u}^{L}} {\sum }_{v ∈ {S}_{L , l}^{V}} {t}_{{f}_{( v , l )}^{V}}}{{\sum }_{v = 1}^{{N}^{V}} {\sum }_{l ∈ {S}_{V , v}^{L}} {t}_{{f}_{( v , l )}^{V}}} = {\sum }_{l ∈ {S}_{U , u}^{L}} \frac{{\sum }_{v ∈ {S}_{L , l}^{V}} {t}_{{f}_{( v , l )}^{V}}}{{\sum }_{v = 1}^{{N}^{V}} {\sum }_{l ∈ {S}_{V , v}^{L}} {t}_{{f}_{( v , l )}^{V}}} = {\sum }_{l ∈ {S}_{U , u}^{L}} {w}_{l}^{L}$$

a traffic weight coefficient of a section Sₛ is reckoned as follows:

$$\begin{matrix}{w}_{s}^{S} = \frac{{\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}^{V}}}{{\sum }_{v = 1}^{{N}^{V}} {\sum }_{l ∈ {S}_{V , v}^{L}} {t}_{{f}_{( v , l )}^{V}}} \\ = {\sum }_{u ∈ {S}_{S , s}^{U}} \frac{{\sum }_{l ∈ {S}_{U , u}^{L}} {\sum }_{v ∈ {S}_{L , l}^{V}} {t}_{{f}_{( v , l )}^{V}}}{{\sum }_{v = 1}^{{N}^{V}} {\sum }_{l ∈ {S}_{V , v}^{L}} {t}_{{f}_{( v , l )}^{V}}} \\ = {\sum }_{u ∈ {S}_{S , s}^{U}} {w}_{u}^{U} \\ = {\sum }_{l ∈ {S}_{S , s}^{L}} {w}_{l}^{L}\end{matrix}$$

a traffic weight coefficient of an intersection Iᵢ is reckoned as follows:

$${w}_{i}^{I} = \frac{{\sum }_{l ∈ {S}_{I , i}^{L}} {\sum }_{v ∈ {S}_{L , l}^{V}} {t}_{{f}_{( v , l )}^{V}}}{{\sum }_{v = 1}^{{N}^{V}} {\sum }_{l ∈ {S}_{V , v}^{L}} {t}_{{f}_{( v , l )}^{V}}} = {\sum }_{l ∈ {S}_{I , i}^{L}} \frac{{\sum }_{v ∈ {S}_{L , l}^{V}} {t}_{{f}_{( v , l )}^{V}}}{{\sum }_{v = 1}^{{N}^{V}} {\sum }_{l ∈ {S}_{V , v}^{L}} {t}_{{f}_{( v , l )}^{V}}} = {\sum }_{l ∈ {S}_{I , i}^{L}} {w}_{l}^{L}$$

a traffic weight coefficient of a road Rᵣ is reckoned as follows:

$$\begin{matrix}{w}_{r}^{R} = \frac{\begin{matrix}{\sum }_{s ∈ {S}_{R , r}^{S}} {\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}^{V}} + \\ {\sum }_{i ∈ {S}_{R , r}^{I}} {\sum }_{l ∈ {S}_{I , i}^{L}} {\sum }_{v ∈ {S}_{L , l}^{V}} {t}_{{f}_{( v , l )}^{V}}\end{matrix}}{{\sum }_{v = 1}^{{N}^{V}} {\sum }_{l ∈ {S}_{V , v}^{L}} {t}_{{f}_{( v , l )}^{V}}} \\ = {\sum }_{s ∈ {S}_{R , r}^{S}} {w}_{s}^{S} + {\sum }_{i ∈ {S}_{R , r}^{I}} {w}_{i}^{I} = {\sum }_{l ∈ {S}_{R , r}^{L}} {w}_{l}^{L}\end{matrix}$$

a traffic weight coefficient of a sub-zone Z_{z} is reckoned as follows:

$$\begin{matrix}{w}_{z}^{Z} = \frac{\begin{matrix}{\sum }_{s ∈ {S}_{Z , z}^{S}} {\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}^{V}} + \\ {\sum }_{i ∈ {S}_{Z , z}^{I}} {\sum }_{l ∈ {S}_{I , i}^{L}} {\sum }_{v ∈ {S}_{L , l}^{V}} {t}_{{f}_{( v , l )}^{V}}\end{matrix}}{{\sum }_{v = 1}^{{N}^{V}} {\sum }_{l ∈ {S}_{V , v}^{L}} {t}_{{f}_{( v , l )}^{V}}} \\ = {\sum }_{s ∈ {S}_{Z , z}^{S}} {w}_{s}^{S} + {\sum }_{i ∈ {S}_{Z , z}^{I}} {w}_{i}^{I} \\ = {\sum }_{l ∈ {S}_{Z , z}^{L}} {w}_{l}^{L}\end{matrix}$$

wherein wₗ^{L} is the traffic weight coefficient of the lane Lₗ; S_{L,l}^{V} is a set of vehicles passing the lane Lₗ within the evaluation period; wᵤ^{U} is the traffic weight coefficient of the u^{th} subsection Uᵤ in the road network; S_{U,u}^{L} is a set of lanes contained in the subsection Uᵤ; wₛ^{S} is the traffic weight coefficient of the s^{th} section Sₛ in the road network; S_{S,s}^{U} is a set of sub-sections contained in the section Sₛ; S_{S,s}^{L} is a set of lanes contained in the section Sₛ; wᵢ^{I} is the traffic weight coefficient of the i^{th} intersection Iᵢ in the road network; S_{I,i}^{L} is a set of lanes contained in the intersection Iᵢ; wᵣ^{R} is the traffic weight coefficient of the r^{th} road Rᵣ in the road network; S_{R,r}^{S} is a set of sections contained in the road Rᵣ; S_{R,r}^{I} is a set of intersections contained in the road Rᵣ; S_{R,r}^{L} is a set of lanes contained in the road Rᵣ; w_{z}^{Z} is the traffic weight coefficient of the z^{th} sub-zone Z_{z} in the road network; S_{Z,z}^{S} is a set of sections contained in the sub-zone Z_{z}; S_{Z,z}^{I} is a set of intersections contained in the sub-zone Z_{z}; and S_{Z,z}^{L} is a set of lanes contained in the sub-zone Z_{z}; and
according to the definition of the traffic weight coefficient of the road network, the traffic weight coefficients of all the vehicles, lanes, road sections, and intersections in the road network are summed respectively, with each sum being 1; and a formula is as follows:

$$\begin{matrix}{w}^{A} = \frac{\begin{matrix}{\sum }_{s = 1}^{{N}^{S}} {\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}^{V}} + \\ {\sum }_{i = 1}^{{N}^{I}} {\sum }_{l ∈ {S}_{I , i}^{L}} {\sum }_{v ∈ {S}_{L , l}^{V}} {t}_{{f}_{( v , l )}^{V}}\end{matrix}}{{\sum }_{v = 1}^{{N}^{V}} {\sum }_{l ∈ {S}_{V , v}^{L}} {t}_{{f}_{( v , l )}^{V}}} \\ = {\sum }_{s = 1}^{{N}^{S}} {w}_{s}^{S} + {\sum }_{i = 1}^{{N}^{I}} {w}_{i}^{I} \\ = {\sum }_{u = 1}^{{N}^{U}} {w}_{u}^{U} + {\sum }_{i = 1}^{{N}^{I}} {w}_{i}^{I} \\ = {\sum }_{l = 1}^{{N}^{L}} {w}_{l}^{L} \\ = {\sum }_{v = 1}^{{N}^{V}} {w}_{v}^{V} \\ = {\sum }_{l ∈ {S}_{A}^{L}} {\sum }_{v ∈ {S}_{L , l}^{V}} {w}_{( v , l )}^{V} \\ = 1\end{matrix}$$

wherein w^{A} is the overall traffic weight coefficient of the road network; N^{S} is the number of sections in the road network; N^{I} is the number of intersections in the road network; N^{U} is the number of sub-sections in the road network; and N^{L} is the number of lanes in the road network.

As a preferred technical solution, step S3 is specifically as follows:
the traffic operation index of each evaluation object in the road network is a ratio of an overall travel time of all the passing vehicles in each evaluation object to the overall free-flow driving time, that is, an average travel time of all the passing vehicles in a distance corresponding to a unit free-flow driving time; and
the traffic operation index of each evaluation object may be obtained by weighted summation of the traffic weight coefficients and the traffic operation indexes of the vehicles, the lanes, the sub-sections, the sections, and the intersections belonging to the evaluation object, and the traffic operation index is dimensionless, specifically as follows:
a traffic operation index of the vehicle Vᵥ passing the lane Lₗ is reckoned as follows:

$${PI}_{( v , l )}^{V} = \frac{{t}_{( v , l )}^{V}}{{t}_{{f}_{( v , l )}^{V}}}$$

a traffic operation index of the vehicle Vᵥ is reckoned as follows:

$$\begin{matrix}{PI}_{v}^{V} = \frac{{\sum }_{l ∈ {S}_{V , v}^{L}} {t}_{( v , l )}^{V}}{{\sum }_{l ∈ {S}_{V , v}^{L}} {t}_{{f}_{l}^{L}}} \\ = \frac{{\sum }_{l ∈ {S}_{V , v}^{L}} ( {PI}_{( v , l )}^{V} \times {t}_{{f}_{( v , l )}^{V}} )}{{\sum }_{v = 1}^{{N}^{V}} {\sum }_{l ∈ {S}_{V , v}^{L}} {t}_{{f}_{l}^{L}}} \times \frac{{\sum }_{v = 1}^{{N}^{V}} {\sum }_{l ∈ {S}_{V , v}^{L}} {t}_{{f}_{l}^{L}}}{{\sum }_{l ∈ {S}_{V , v}^{L}} {t}_{{f}_{l}^{L}}} \\ = \frac{{\sum }_{l ∈ {S}_{V , v}^{L}} ( {PI}_{( v , l )}^{V} \times {w}_{( v , l )}^{V} )}{{\sum }_{l ∈ {S}_{V , v}^{L}} {w}_{( v , l )}^{V}}\end{matrix}$$

a traffic operation index of the lane Lₗ is reckoned as follows:

$$\begin{matrix}{PI}_{l}^{L} = \frac{{\sum }_{v ∈ {S}_{L , l}^{V}} {t}_{( v , l )}^{V}}{{\sum }_{v ∈ {S}_{L , l}^{V}} {t}_{{f}_{( v , l )}^{V}}} \\ = \frac{{\sum }_{v ∈ {S}_{L , l}^{V}} {t}_{( v , l )}^{V}}{{\sum }_{v = 1}^{{N}^{V}} {\sum }_{l ∈ {S}_{V , v}^{L}} {t}_{{f}_{( v , l )}^{V}}} \times \frac{{\sum }_{v = 1}^{{N}^{V}} {\sum }_{l ∈ {S}_{V , v}^{L}} {t}_{{f}_{( v , l )}^{V}}}{{\sum }_{v ∈ {S}_{L , l}^{V}} {t}_{( v , l )}^{V}} \\ = \frac{{\sum }_{v ∈ {S}_{L , l}^{V}} ( {PI}_{( v , l )}^{V} \times {w}_{( v , l )}^{V} )}{{\sum }_{v ∈ {S}_{L , l}^{V}} {w}_{( v , l )}^{V}}\end{matrix}$$

a traffic operation index of a subsection Uᵤ is reckoned as follows:

$$\begin{matrix}{PI}_{u}^{U} = \frac{{\sum }_{l ∈ {S}_{U , u}^{L}} {\sum }_{v ∈ {S}_{L , l}^{V}} {t}_{( v , l )}^{V}}{{\sum }_{l ∈ {S}_{U , u}^{L}} {\sum }_{v ∈ {S}_{L , l}^{V}} {t}_{{f}_{( v , l )}^{V}}} \\ = \frac{{\sum }_{l ∈ {S}_{U , u}^{L}} {\sum }_{v ∈ {S}_{L , l}^{V}} ( {PI}_{( v , l )}^{V} \times {w}_{( v , l )}^{V} )}{{\sum }_{l ∈ {S}_{U , u}^{L}} {\sum }_{v ∈ {S}_{L , l}^{V}} {w}_{( v , l )}^{V}} \\ = \frac{{\sum }_{l ∈ {S}_{U , u}^{L}} ( {PI}_{l}^{L} \times {w}_{l}^{L} )}{{\sum }_{l ∈ {S}_{U , u}^{L}} {w}_{l}^{L}} ;\end{matrix}$$

a traffic operation index of the section Sₛ is reckoned as follows:

$$\begin{matrix}{PI}_{s}^{S} = \frac{{\sum }_{u ∈ {S}_{S , s}^{U}} {\sum }_{l ∈ {S}_{U , u}^{L}} {\sum }_{v ∈ {S}_{L , l}^{V}} {t}_{( v , l )}^{V}}{{\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}^{V}}} \\ = \frac{{\sum }_{l ∈ {S}_{S , s}^{L}} {\sum }_{v ∈ {S}_{L , l}^{V}} ( {PI}_{( v , l )}^{V} \times {w}_{( v , l )}^{V} )}{{\sum }_{l ∈ {S}_{S , s}^{L}} {\sum }_{v ∈ {S}_{L , l}^{V}} {w}_{( v , l )}^{V}} \\ = \frac{{\sum }_{l ∈ {S}_{S , s}^{L}} ( {PI}_{l}^{L} \times {w}_{l}^{L} )}{{\sum }_{l ∈ {S}_{S , s}^{L}} {w}_{i}^{L}} \\ = \frac{{\sum }_{u ∈ {S}_{S , s}^{U}} ( {PI}_{u}^{U} \times {w}_{u}^{U} )}{{\sum }_{u ∈ {S}_{S , s}^{U}} {w}_{u}^{U}}\end{matrix}$$

a traffic operation index of the intersection Iᵢ is reckoned as follows:

$$\begin{matrix}{PI}_{i}^{I} = \frac{{\sum }_{l ∈ {S}_{I , i}^{L}} {\sum }_{v ∈ {S}_{L , l}^{V}} {t}_{( v , l )}^{V}}{{\sum }_{l ∈ {S}_{I , i}^{L}} {\sum }_{v ∈ {S}_{L , l}^{V}} {t}_{{f}_{( v , l )}^{V}}} \\ = \frac{{\sum }_{l ∈ {S}_{I , i}^{L}} {\sum }_{v ∈ {S}_{L , l}^{V}} ( {PI}_{( v , l )}^{V} \times {w}_{( v , l )}^{V} )}{{\sum }_{l ∈ {S}_{I , i}^{L}} {\sum }_{v ∈ {S}_{L , l}^{V}} {w}_{( v , l )}^{V}} \\ = \frac{{\sum }_{l ∈ {S}_{I , i}^{L}} ( {PI}_{l}^{L} \times {w}_{l}^{L} )}{{\sum }_{l ∈ {S}_{I , i}^{L}} {w}_{l}^{L}}\end{matrix}$$

a traffic operation index of the road Rᵣ is reckoned as follows:

$$\begin{matrix}{PI}_{r}^{R} = \frac{\begin{matrix}{\sum }_{s ∈ {S}_{R , r}^{S}} {\sum }_{u ∈ {S}_{S , s}^{U}} {\sum }_{l ∈ {S}_{U , u}^{L}} {\sum }_{v ∈ {S}_{L , l}^{V}} {t}_{( v , l )}^{V} + \\ {\sum }_{i ∈ {S}_{R , r}^{I}} {\sum }_{l ∈ {S}_{I , i}^{L}} {\sum }_{v ∈ {S}_{L , l}^{V}} {t}_{( v , l )}^{V}\end{matrix}}{\begin{matrix}{\sum }_{s ∈ {S}_{R , r}^{S}} {\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}^{V}} + \\ {\sum }_{i ∈ {S}_{R , r}^{I}} {\sum }_{l ∈ {S}_{I , i}^{L}} {\sum }_{v ∈ {S}_{L , l}^{V}} {t}_{( v , l )}^{V}\end{matrix}} \\ = \frac{{\sum }_{l ∈ {S}_{R , r}^{L}} {\sum }_{v ∈ {S}_{L , l}^{V}} {r}_{( v , l )}^{V}}{{\sum }_{l ∈ {S}_{R , r}^{L}} {\sum }_{v ∈ {S}_{L , l}^{V}} {t}_{{f}_{( v , l )}^{V}}} \\ = \frac{{\sum }_{l ∈ {S}_{R , r}^{L}} ( {PI}_{l}^{L} \times {w}_{l}^{L} )}{{\sum }_{l ∈ {S}_{R , r}^{L}} {w}_{l}^{L}}\end{matrix}$$

a traffic operation index of a sub-zone Z_{z} is reckoned as follows:

$$\begin{matrix}{PI}_{z}^{Z} = \frac{\begin{matrix}{\sum }_{s ∈ {S}_{Z , z}^{S}} {\sum }_{u ∈ {S}_{S , s}^{U}} {\sum }_{l ∈ {S}_{U , u}^{L}} {\sum }_{v ∈ {S}_{L , l}^{V}} {t}_{( v , l )}^{V} + \\ {\sum }_{i ∈ {S}_{Z , z}^{I}} {\sum }_{l ∈ {S}_{I , i}^{L}} {\sum }_{v ∈ {S}_{L , l}^{V}} {t}_{( v , l )}^{V}\end{matrix}}{\begin{matrix}{\sum }_{s ∈ {S}_{Z , z}^{S}} {\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}^{V}} + \\ {\sum }_{i ∈ {S}_{Z , z}^{I}} {\sum }_{l ∈ {S}_{I , i}^{L}} {\sum }_{v ∈ {S}_{L , l}^{V}} {t}_{( v , l )}^{V}\end{matrix}} \\ = \frac{{\sum }_{l ∈ {S}_{Z , z}^{L}} {\sum }_{v ∈ {S}_{L , l}^{V}} {r}_{( v , l )}^{V}}{{\sum }_{l ∈ {S}_{Z , z}^{L}} {\sum }_{v ∈ {S}_{L , l}^{V}} {t}_{{f}_{( v , l )}^{V}}} \\ = \frac{{\sum }_{l ∈ {S}_{Z , z}^{L}} ( {PI}_{l}^{L} \times {w}_{l}^{L} )}{{\sum }_{l ∈ {S}_{Z , z}^{L}} {w}_{l}^{L}}\end{matrix}$$

a traffic operation index of a zone is reckoned as follows:

$${PI}^{A} = \frac{\begin{matrix}{\sum }_{s ∈ {S}_{A}^{S}} {\sum }_{u ∈ {S}_{S , s}^{U}} {\sum }_{l ∈ {S}_{U , u}^{L}} {\sum }_{v ∈ {S}_{L , l}^{V}} {t}_{( v , l )}^{V} + \\ {\sum }_{i ∈ {S}_{A}^{I}} {\sum }_{l ∈ {S}_{I , i}^{L}} {\sum }_{v ∈ {S}_{L , l}^{V}} {t}_{( v , l )}^{V}\end{matrix}}{\begin{matrix}{\sum }_{s ∈ {S}_{A}^{S}} {\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}}^{V} + \\ {\sum }_{i ∈ {S}_{A}^{I}} {\sum }_{l ∈ {S}_{I , i}^{L}} {\sum }_{v ∈ {S}_{L , l}^{V}} {t}_{{f}_{( v , l )}}^{V}\end{matrix}} = \frac{{\sum }_{l ∈ {S}_{A}^{L}} {\sum }_{v ∈ {S}_{L , l}^{V}} {t}_{( v , l )}^{V}}{{\sum }_{l ∈ {S}_{A}^{L}} {\sum }_{v ∈ {S}_{L , l}^{V}} {t}_{{f}_{( v , l )}}^{V}} = {\sum }_{l ∈ {S}_{A}^{L}} ( {PI}_{l}^{L} \times {w}_{l}^{L} )$$

wherein PI_{(v,l)}^{V} is the traffic operation index of the vehicle Vᵥ on the lane Lₗ; t_{(v,l)}^{V} is a travel time of the vehicle Vᵥ passing the lane Lₗ; PIᵥ^{V}, PIₗ^{L}, PIᵤ^{U}, PIₛ^{S}, PIₗ^{I}, PIᵣ^{R}, PI_{z}^{Z}, and PI^{A} represent traffic operation indexes of the vehicle Vᵥ, the lane Lₗ, the subsection Uᵤ, the section, Sₛ, the intersection Iᵢ, the road Rᵣ, the sub-zone Z_{z}, and the zone respectively; S_{A}^{S} is a set of sections contained in the zone; S_{A}^{I} is a set of intersections contained in the zone; and S_{A}^{L} is a set of lanes contained in the zone.

As a preferred technical solution, step S4 is specifically as follows:
S401, reckoning the delay time indexes of various evaluation objects at multiple spatial scales, wherein
the delay time index of each evaluation object in the road network is a ratio of an overall delay time of all the passing vehicles in each evaluation object to the overall free-flow driving time, that is, an average delay time of all the passing vehicles in the distance corresponding to the unit free-flow driving time; and
the delay time index of each evaluation object may be obtained by weighted summation of the traffic weight coefficients and the delay time indexes of the vehicles, the lanes, the sub-sections, the sections, and the intersections belonging to the evaluation object, and the traffic operation index is dimensionless, having an ability to further calculate the average delay time, specifically as follows:
a delay time index of the vehicle Vᵥ passing the lane Lₗ is reckoned as follows:

$${DI}_{( v , l )}^{V} = \frac{{d}_{( v , l )}^{V}}{{t}_{{f}_{( v , l )}}^{V}}$$

a delay time index of the vehicle Vᵥ is reckoned as follows:

$${DI}_{v}^{V} = \frac{{\sum }_{l ∈ {S}_{V , v}^{L}} {d}_{( v , l )}^{V}}{{\sum }_{l ∈ {S}_{V , v}^{L}} {t}_{{f}_{l}}^{L}} = \frac{{\sum }_{l ∈ {S}_{V , v}^{L}} ( {DI}_{( v , l )}^{V} \times {t}_{{f}_{( v , l )}}^{V} )}{{\sum }_{v = 1}^{{N}^{V}} {\sum }_{l ∈ {S}_{V , v}^{L}} {t}_{{f}_{l}}^{L}} \times \frac{{\sum }_{v = 1}^{{N}^{V}} {\sum }_{l ∈ {S}_{V , v}^{L}} {t}_{{f}_{l}}^{L}}{{\sum }_{l ∈ {S}_{V , v}^{L}} {t}_{{f}_{l}}^{L}} = \frac{{\sum }_{l ∈ {S}_{V , v}^{L}} ( {DI}_{( v , l )}^{V} \times {w}_{( v , l )}^{V} )}{{\sum }_{l ∈ {S}_{V , v}^{L}} {w}_{( v , l )}^{V}}$$

a delay time index of the lane Lₗ is reckoned as follows:

$${DI}_{l}^{L} = \frac{{\sum }_{v ∈ {S}_{L , l}^{V}} {d}_{( v , l )}^{V}}{{\sum }_{v ∈ {S}_{L , l}^{V}} {t}_{{f}_{( v , l )}}^{V}} = \frac{{\sum }_{v ∈ {S}_{L , l}^{V}} {d}_{( v , l )}^{V}}{{\sum }_{v = 1}^{{N}^{V}} {\sum }_{l ∈ {S}_{V , v}^{L}} {t}_{{f}_{( v , l )}}^{V}} \times \frac{{\sum }_{v = 1}^{{N}^{V}} {\sum }_{l ∈ {S}_{V , v}^{L}} {t}_{{f}_{( v , l )}}^{V}}{{\sum }_{v ∈ {S}_{L , l}^{V}} {t}_{{f}_{( v , l )}}^{V}} = \frac{{\sum }_{v ∈ {S}_{L , l}^{V}} ( {DI}_{( v , l )}^{V} \times {w}_{( v , l )}^{V} )}{{\sum }_{v ∈ {S}_{L , l}^{V}} {w}_{( v , l )}^{V}}$$

a delay time index of a subsection Uᵤ is reckoned as follows:

$${DI}_{u}^{U} = \frac{{\sum }_{l ∈ {S}_{U , u}^{L}} {\sum }_{v ∈ {S}_{L , l}^{V}} {d}_{( v , l )}^{V}}{{\sum }_{l ∈ {S}_{U , u}^{L}} {\sum }_{v ∈ {S}_{L , l}^{V}} {t}_{{f}_{( v , l )}}^{V}} = \frac{{\sum }_{l ∈ {S}_{U , u}^{L}} {\sum }_{v ∈ {S}_{L , l}^{V}} ( {DI}_{( v , l )}^{V} \times {w}_{( v , l )}^{V} )}{{\sum }_{l ∈ {S}_{U , u}^{L}} {\sum }_{v ∈ {S}_{L , l}^{V}} {w}_{( v , l )}^{V}} = \frac{{\sum }_{l ∈ {S}_{U , u}^{L}} ( {DI}_{l}^{L} \times {w}_{l}^{L} )}{{\sum }_{l ∈ {S}_{U , u}^{L}} {w}_{l}^{L}}$$

a delay time index of the section Sₛ is reckoned as follows:

$${DI}_{s}^{S} = \frac{{\sum }_{u ∈ {S}_{S , s}^{U}} {\sum }_{l ∈ {S}_{U , u}^{L}} {\sum }_{v ∈ {S}_{L , l}^{V}} {d}_{( v , l )}^{V}}{{\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}}^{V}} = \frac{{\sum }_{l ∈ {S}_{S , s}^{L}} {\sum }_{v ∈ {S}_{L , l}^{V}} ( {DI}_{( v , l )}^{V} \times {w}_{( v , l )}^{V} )}{{\sum }_{l ∈ {S}_{S , s}^{L}} {Σ}_{v ∈ {S}_{L , l}^{V}} {w}_{( v , l )}^{V}} = \frac{{\sum }_{l ∈ {S}_{S , s}^{L}} ( {DI}_{l}^{L} \times {w}_{l}^{L} )}{{\sum }_{l ∈ {S}_{S , s}^{L}} {w}_{l}^{L}} = \frac{{\sum }_{u ∈ {S}_{S , s}^{U}} ( {DI}_{u}^{U} \times {w}_{u}^{U} )}{{\sum }_{u ∈ {S}_{S , s}^{U}} {w}_{u}^{U}}$$

a delay time index of the intersection Iᵢ is reckoned as follows:

$${DI}_{i}^{I} = \frac{{\sum }_{l ∈ {S}_{I , i}^{L}} {\sum }_{v ∈ {S}_{L , l}^{V}} {d}_{( v , l )}^{V}}{{\sum }_{l ∈ {S}_{I , i}^{L}} {\sum }_{v ∈ {S}_{L , l}^{V}} {t}_{{f}_{( v , l )}}^{V}} = \frac{{\sum }_{l ∈ {S}_{I , i}^{L}} {\sum }_{v ∈ {S}_{L , l}^{V}} ( {DI}_{( v , l )}^{V} \times {w}_{( v , l )}^{V} )}{{\sum }_{l ∈ {S}_{I , i}^{L}} {\sum }_{v ∈ {S}_{L , l}^{V}} {w}_{( v , l )}^{V}} = \frac{{\sum }_{l ∈ {S}_{I , i}^{L}} ( {DI}_{l}^{L} \times {w}_{l}^{L} )}{{\sum }_{l ∈ {S}_{I , i}^{L}} {w}_{l}^{L}}$$

a delay time index of the road Rᵣ is reckoned as follows:

$${DI}_{r}^{R} = \frac{\begin{matrix}{\sum }_{s ∈ {S}_{R , r}^{S}} {\sum }_{u ∈ {S}_{S , s}^{U}} {\sum }_{l ∈ {S}_{U , u}^{L}} {\sum }_{v ∈ {S}_{L , l}^{V}} {d}_{( v , l )}^{V} + \\ {\sum }_{i ∈ {S}_{R , r}^{I}} {\sum }_{l ∈ {S}_{I , i}^{L}} {\sum }_{v ∈ {S}_{L , l}^{V}} {d}_{( v , l )}^{V}\end{matrix}}{\begin{matrix}{\sum }_{s ∈ {S}_{R , r}^{S}} {\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}}^{V} + \\ {\sum }_{i ∈ {S}_{R , r}^{I}} {\sum }_{l ∈ {S}_{I , i}^{L}} {\sum }_{v ∈ {S}_{L , l}^{V}} {t}_{{f}_{( v , l )}}^{V}\end{matrix}} = \frac{{\sum }_{l ∈ {S}_{R , r}^{L}} {\sum }_{v ∈ {S}_{L , l}^{V}} {d}_{( v , l )}^{V}}{{\sum }_{l ∈ {S}_{R , r}^{L}} {\sum }_{v ∈ {S}_{L , l}^{V}} {t}_{{f}_{( v , l )}}^{V}} = \frac{{\sum }_{l ∈ {S}_{R , r}^{L}} ( {DI}_{l}^{L} \times {w}_{l}^{L} )}{{\sum }_{l ∈ {S}_{R , r}^{L}} {w}_{l}^{L}}$$

a delay time index of a sub-zone Z_{z} is reckoned as follows:

$${DI}_{z}^{Z} = \frac{\begin{matrix}{\sum }_{s ∈ {S}_{Z , z}^{S}} {\sum }_{u ∈ {S}_{S , s}^{U}} {\sum }_{l ∈ {S}_{U , u}^{L}} {\sum }_{v ∈ {S}_{L , l}^{V}} {d}_{( v , l )}^{V} + \\ {\sum }_{i ∈ {S}_{Z , z}^{I}} {\sum }_{l ∈ {S}_{I , i}^{L}} {\sum }_{v ∈ {S}_{L , l}^{V}} {d}_{( v , l )}^{V}\end{matrix}}{\begin{matrix}{\sum }_{s ∈ {S}_{Z , z}^{S}} {\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}}^{V} + \\ {\sum }_{i ∈ {S}_{Z , z}^{I}} {\sum }_{l ∈ {S}_{I , i}^{L}} {\sum }_{v ∈ {S}_{L , l}^{V}} {t}_{{f}_{( v , l )}}^{V}\end{matrix}} = \frac{{\sum }_{l ∈ {S}_{Z , z}^{L}} {\sum }_{v ∈ {S}_{L , l}^{V}} {d}_{( v , l )}^{V}}{{\sum }_{l ∈ {S}_{Z , z}^{L}} {\sum }_{v ∈ {S}_{L , l}^{V}} {t}_{{f}_{( v , l )}}^{V}} = \frac{{\sum }_{l ∈ {S}_{Z , z}^{L}} ( {DI}_{l}^{L} \times {w}_{l}^{L} )}{{\sum }_{l ∈ {S}_{Z , z}^{L}} {w}_{l}^{L}}$$

a delay time index of a zone is reckoned as follows:

$${DI}^{A} = \frac{\begin{matrix}{\sum }_{s ∈ {S}_{A}^{S}} {\sum }_{u ∈ {S}_{S , s}^{U}} {\sum }_{l ∈ {S}_{U , u}^{L}} {\sum }_{v ∈ {S}_{L , l}^{V}} {d}_{( v , l )}^{V} + \\ {\sum }_{i ∈ {S}_{A}^{I}} {\sum }_{l ∈ {S}_{I , i}^{L}} {\sum }_{v ∈ {S}_{L , l}^{V}} {d}_{( v , l )}^{V}\end{matrix}}{\begin{matrix}{\sum }_{s ∈ {S}_{A}^{S}} {\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}}^{V} + \\ {\sum }_{i ∈ {S}_{A}^{I}} {\sum }_{l ∈ {S}_{I , i}^{L}} {\sum }_{v ∈ {S}_{L , l}^{V}} {t}_{{f}_{( v , l )}}^{V}\end{matrix}} = \frac{{\sum }_{l ∈ {S}_{A}^{L}} {\sum }_{v ∈ {S}_{L , l}^{V}} {d}_{( v , l )}^{V}}{{\sum }_{l ∈ {S}_{A}^{L}} {\sum }_{v ∈ {S}_{L , l}^{V}} {t}_{{f}_{( v , l )}}^{V}} = {\sum }_{l ∈ {S}_{A}^{L}} ( {DI}_{l}^{L} \times {w}_{l}^{L} )$$

wherein DI_{(v,l)}^{V} is the delay time index of the vehicle Vᵥ on the lane Lₗ; d_{(v,l)}^{V} is the delay time of the vehicle Vᵥ passing the lane Lₗ; and DIᵥ^{V}, DIₗ^{L}, DIᵤ^{U}, DIₛ^{S}, DIᵢ^{I}, DIᵣ^{R}, DI_{z}^{Z}, and DI^{A} represent the delay time indexes of the vehicle Vᵥ, the lane Lₗ, the subsection Uᵤ, the road Sₛ, the intersection Iᵢ, the road Rᵣ, the sub-zone Z_{z}, and the zone respectively; and
S402, calculating the average delay times of various evaluation objects, wherein
according to the acquired delay time indexes of the different evaluation objects at the multiple spatial scales, the average delay time of each evaluation object is calculated, which is specifically as follows:
an average delay time of the vehicle Vᵥ passing the lane Lₗ is reckoned as follows:

$${d}_{( v , l )}^{V} = {DI}_{( v , l )}^{V} \times {t}_{{f}_{( v , l )}}^{V}$$

an average delay time of the vehicle Vᵥ is reckoned as follows:

$${d}_{v}^{V} = {\sum }_{l ∈ {S}_{V , v}^{L}} {d}_{( v , l )}^{V} = {DI}_{v}^{V} \times {\sum }_{l ∈ {S}_{V , v}^{L}} {t}_{{f}_{l}}^{L} = {DI}_{v}^{V} \times {t}_{{f}_{v}}^{V}$$

an average delay time of the lane Lₗ is reckoned as follows:

$${\overline{d}}_{l}^{L} = \frac{{\sum }_{v ∈ {S}_{L , l}^{V}} {d}_{( v , l )}^{V}}{{N}_{L , l}^{V}} = \frac{{\sum }_{v ∈ {S}_{L , l}^{V}} {d}_{( v , l )}^{V}}{{\sum }_{v ∈ {S}_{L , l}^{V}} {t}_{{f}_{( v , l )}}^{V}} \times \frac{{\sum }_{v ∈ {S}_{L , l}^{V}} {t}_{{f}_{( v , l )}}^{V}}{{N}_{L , l}^{V}} = {DI}_{l}^{L} \times {t}_{{f}_{l}}^{L}$$

an average delay time of a subsection Uᵤ is reckoned as follows:

$${\overline{d}}_{u}^{U} = \frac{{\sum }_{l ∈ {S}_{U , u}^{L}} {\sum }_{v ∈ {S}_{L , l}^{V}} {d}_{( v , l )}^{V}}{{N}_{U , u}^{V}} = \frac{{\sum }_{l ∈ {S}_{U , u}^{L}} {\sum }_{v ∈ {S}_{L , l}^{V}} {d}_{( v , l )}^{V}}{{\sum }_{l ∈ {S}_{U , u}^{L}} {\sum }_{v ∈ {S}_{L , l}^{V}} {t}_{{f}_{( v , l )}}^{V}} \times \frac{{\sum }_{l ∈ {S}_{U , u}^{L}} {\sum }_{v ∈ {S}_{L , l}^{V}} {t}_{{f}_{( v , l )}}^{V}}{{N}_{U , u}^{V}} = {DI}_{u}^{U} \times {t}_{{f}_{u}}^{U}$$

an average delay time of the section Sₛ is reckoned as follows:

$${\overline{d}}_{s}^{S} = \frac{{\sum }_{u ∈ {S}_{S , s}^{U}} {\sum }_{l ∈ {S}_{U , u}^{L}} {\sum }_{v ∈ {S}_{L , l}^{V}} {d}_{( v , l )}^{V}}{{N}_{S , s}^{V}} = \frac{{\sum }_{u ∈ {S}_{S , s}^{U}} {\sum }_{l ∈ {S}_{U , u}^{L}} {\sum }_{v ∈ {S}_{L , l}^{V}} {d}_{( v , l )}^{V}}{{\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}}^{V}} \times \frac{{\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}}^{V}}{{N}_{S , s}^{V}} = {DI}_{s}^{S} \times {t}_{{f}_{s}}^{S}$$

an average delay time of the intersection Iᵢ is reckoned as follows:

$${\overline{d}}_{i}^{I} = \frac{{\sum }_{l ∈ {S}_{I , i}^{L}} {\sum }_{v ∈ {S}_{L , l}^{V}} {d}_{( v , l )}^{V}}{{N}_{I , i}^{V}} = \frac{{\sum }_{l ∈ {S}_{I , i}^{L}} {\sum }_{v ∈ {S}_{L , l}^{V}} {d}_{( v , l )}^{V}}{{\sum }_{l ∈ {S}_{I , i}^{L}} {\sum }_{v ∈ {S}_{L , l}^{V}} {t}_{{f}_{( v , l )}^{V}}} \times \frac{{\sum }_{l ∈ {S}_{I , i}^{L}} {\sum }_{v ∈ {S}_{L , l}^{V}} {t}_{{f}_{( v , l )}^{V}}}{{N}_{I , i}^{V}} = {DI}_{i}^{I} \times {t}_{{f}_{i}^{I}}$$

an average delay time of the road Rᵣ is reckoned as follows:

$${\overline{d}}_{r}^{R} = \frac{{\sum }_{l ∈ {S}_{R , r}^{L}} {\sum }_{v ∈ {S}_{L , l}^{V}} {d}_{( v , l )}^{V}}{{N}_{R , r}^{V}} = \frac{{\sum }_{l ∈ {S}_{R , r}^{L}} {\sum }_{v ∈ {S}_{L , l}^{V}} {d}_{( v , l )}^{V}}{{\sum }_{l ∈ {S}_{R , r}^{L}} {\sum }_{v ∈ {S}_{L , l}^{V}} {t}_{{f}_{( v , l )}^{V}}} \times \frac{{\sum }_{l ∈ {S}_{R , r}^{L}} {\sum }_{v ∈ {S}_{L , l}^{V}} {t}_{{f}_{( v , l )}^{V}}}{{N}_{R , r}^{V}} = {DI}_{r}^{R} \times {t}_{{f}_{r}^{R}}$$

an average delay time of a sub-zone Z_{z} is reckoned as follows:

$${\overline{d}}_{z}^{Z} = \frac{{\sum }_{l ∈ {S}_{Z , z}^{L}} {\sum }_{v ∈ {S}_{L , l}^{V}} {d}_{( v , l )}^{V}}{{N}_{Z , z}^{V}} = \frac{{\sum }_{l ∈ {S}_{Z , z}^{L}} {\sum }_{v ∈ {S}_{L , l}^{V}} {d}_{( v , l )}^{V}}{{\sum }_{l ∈ {S}_{Z , z}^{L}} {\sum }_{v ∈ {S}_{L , l}^{V}} {t}_{{f}_{( v , l )}^{V}}} \times \frac{{\sum }_{l ∈ {S}_{Z , z}^{L}} {\sum }_{v ∈ {S}_{L , l}^{V}} {t}_{{f}_{( v , l )}^{V}}}{{N}_{Z , z}^{V}} = {DI}_{z}^{Z} \times {t}_{{f}_{z}^{Z}}$$

an average delay time of the zone is reckoned as follows:

$${\overline{d}}^{A} = \frac{{\sum }_{l ∈ {S}_{A}^{L}} {\sum }_{v ∈ {S}_{L , l}^{V}} {d}_{( v , l )}^{V}}{{N}^{V}} = \frac{{\sum }_{l ∈ {S}_{A}^{L}} {\sum }_{v ∈ {S}_{L , l}^{V}} {d}_{( v , l )}^{V}}{{\sum }_{l ∈ {S}_{A}^{L}} {\sum }_{v ∈ {S}_{L , l}^{V}} {t}_{{f}_{( v , l )}^{V}}} \times \frac{{\sum }_{l ∈ {S}_{A}^{L}} {\sum }_{v ∈ {S}_{L , l}^{V}} {t}_{{f}_{( v , l )}^{V}}}{{N}^{V}} = {DI}^{A} \times {{t}_{f}}^{A}$$

wherein dᵥ^{V} is the delay time of the vehicle Vᵥ; d̅ₗ^{L}, d̅ᵤ^{U}, d̅ₛ^{S}, d̅ᵢ^{I}, d̅ᵣ^{R}, d̅_{z}^{Z}, and d̅^{A} represent the average delay times of the lane Lₗ, the subsection Uᵤ, the section Sₛ, the intersection Iᵢ, the road Rᵣ, the sub-zone Z_{z}, and the zone respectively; N_{L,l}^{V}, N_{U,u}^{V}, N_{S,s}^{V}, N_{I,i}^{V}, N_{R,r}^{V}, and N_{Z,z}^{V} represent numbers of vehicles passing the lane Lₗ, the subsection Uᵤ, the section Sₛ, the intersection Iᵢ, the road Rᵣ, the sub-zone Z_{z} within the evaluation period respectively; and t_{fu}^{U}, t_{fs}^{S}, t_{fi}^{I}, t_{fr}^{R}, t_{fz}^{Z}, and t_{f}^{A} represent the average free-flow driving times of the subsection Uᵤ, the section Sₛ, the intersection Iᵢ, the road Rᵣ, the sub-zone Z_{z}, and the zone respectively.

As a preferred technical solution, step S5 is specifically as follows:
S501, reckoning the indexes of the numbers of times of stopping of various evaluation objects at the multiple spatial scales, wherein
the index of the number of times of stopping of each evaluation object in the road network is a ratio of an overall number of times of stopping of all the passing vehicles in each evaluation object to the overall free-flow driving time, that is, an average number of times of stopping of all the passing vehicles in the distance corresponding to the unit free-flow driving time; and
the index of the number of times of stopping of each evaluation object may be obtained by weighted summation of the traffic weight coefficients and the indexes of the numbers of times of stopping of the vehicles, the lanes, the sub-sections, the sections, and the intersections belonging to the evaluation object, and the index of the number of times of stopping is in a unit of “times/min”, having an ability to further calculate the average number of times of stopping, specifically as follows:
an index of number of times of stopping of the vehicle Vᵥ passing the lane Lₗ is reckoned as follows:

$${HI}_{( v , l )}^{V} = \frac{{h}_{( v , l )}^{V}}{{t}_{{f}_{( v , l )}^{V}}}$$

an index of number of times of stopping of the vehicle Vᵥ is reckoned as follows:

$$\begin{matrix}{HI}_{v}^{V} = \frac{{\sum }_{l ∈ {S}_{V , v}^{L}} {h}_{( v , l )}^{V}}{{\sum }_{l ∈ {S}_{V , v}^{L}} {t}_{{f}_{l}^{L}}} = \frac{{\sum }_{l ∈ {S}_{V , v}^{L}} ( {HI}_{( v , l )}^{V} \times {t}_{{f}_{( v , l )}^{V}} )}{{\sum }_{v = 1}^{{N}^{V}} {\sum }_{l ∈ {S}_{V , v}^{L}} {t}_{{f}_{l}^{L}}} \times \frac{{\sum }_{v = 1}^{{N}^{V}} {\sum }_{l ∈ {S}_{V , v}^{L}} {t}_{{f}_{l}^{L}}}{{\sum }_{l ∈ {S}_{V , v}^{L}} {t}_{{f}_{l}^{L}}} \\ = \frac{{\sum }_{l ∈ {S}_{V , v}^{L}} ( {HI}_{( v , l )}^{V} \times {w}_{( v , l )}^{V} )}{{\sum }_{l ∈ {S}_{V , v}^{L}} {w}_{( v , l )}^{V}}\end{matrix}$$

an index of number of times of stopping of the lane Lₗ is reckoned as follows:

$$\begin{matrix}{HI}_{l}^{L} = \frac{{\sum }_{v ∈ {S}_{L , l}^{V}} {h}_{( v , l )}^{V}}{{\sum }_{v ∈ {S}_{L , l}^{V}} {t}_{{f}_{( v , l )}^{V}}} = \frac{{\sum }_{l ∈ {S}_{L , l}^{V}} {h}_{( v , l )}^{V}}{{\sum }_{v = 1}^{{N}^{V}} {\sum }_{l ∈ {S}_{V , v}^{L}} {t}_{{f}_{( v , l )}^{V}}} \times \frac{{\sum }_{v = 1}^{{N}^{V}} {\sum }_{l ∈ {S}_{V , v}^{L}} {t}_{{f}_{( v , l )}^{V}}}{{\sum }_{v ∈ {S}_{L , l}^{V}} {t}_{{f}_{( v , l )}^{V}}} \\ = \frac{{\sum }_{v ∈ {S}_{L , l}^{V}} ( {HI}_{( v , l )}^{V} \times {w}_{( v , l )}^{V} )}{{\sum }_{v ∈ {S}_{L , l}^{V}} {w}_{( v , l )}^{V}}\end{matrix}$$

an index of number of times of stopping of the subsection Uᵤ is reckoned as follows:

$${HI}_{u}^{U} = \frac{{\sum }_{l ∈ {S}_{U , u}^{L}} {\sum }_{v ∈ {S}_{L , l}^{V}} {h}_{( v , l )}^{V}}{{\sum }_{l ∈ {S}_{U , u}^{L}} {\sum }_{v ∈ {S}_{L , l}^{V}} {t}_{{f}_{( v , l )}^{V}}} = \frac{{\sum }_{l ∈ {S}_{U , u}^{L}} {\sum }_{v ∈ {S}_{L , l}^{V}} ( {HI}_{( v , l )}^{V} \times {w}_{( v , l )}^{V} )}{{\sum }_{l ∈ {S}_{U , u}^{L}} {\sum }_{v ∈ {S}_{L , l}^{V}} {w}_{( v , l )}^{V}} = \frac{{\sum }_{l ∈ {S}_{U , u}^{L}} ( {HI}_{l}^{L} \times {w}_{l}^{L} )}{{\sum }_{l ∈ {S}_{U , u}^{L}} {w}_{l}^{L}}$$

an index of number of times of stopping of the section Sₛ is reckoned as follows:

$$\begin{matrix}{HI}_{s}^{S} = \frac{{\sum }_{u ∈ {S}_{S , s}^{U}} {\sum }_{l ∈ {S}_{U , u}^{L}} {\sum }_{v ∈ {S}_{L , l}^{V}} {h}_{( v , l )}^{V}}{{\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}^{V}}} \\ = \frac{{\sum }_{l ∈ {S}_{S , s}^{L}} {\sum }_{v ∈ {S}_{L , l}^{V}} ( {HI}_{( v , l )}^{V} \times {w}_{( v , l )}^{V} )}{{\sum }_{l ∈ {S}_{S , s}^{L}} {\sum }_{v ∈ {S}_{L , l}^{V}} {w}_{( v , l )}^{V}} \\ = \frac{{\sum }_{l ∈ {S}_{S , s}^{L}} ( {HI}_{l}^{L} \times {w}_{l}^{L} )}{{\sum }_{l ∈ {S}_{S , s}^{L}} {w}_{l}^{L}} = \frac{{\sum }_{u ∈ {S}_{S , s}^{U}} ( {HI}_{u}^{U} \times {w}_{u}^{U} )}{{\sum }_{u ∈ {S}_{S , s}^{U}} {w}_{u}^{U}}\end{matrix}$$

an index of number of times of stopping of the intersection Iᵢ is reckoned as follows:

$${HI}_{i}^{I} = \frac{{\sum }_{l ∈ {S}_{I , i}^{L}} {\sum }_{v ∈ {S}_{L , l}^{V}} {h}_{( v , l )}^{V}}{{\sum }_{l ∈ {S}_{I , i}^{L}} {\sum }_{v ∈ {S}_{L , l}^{V}} {t}_{{f}_{( v , l )}^{V}}} = \frac{{\sum }_{l ∈ {S}_{I , i}^{L}} {\sum }_{v ∈ {S}_{L , l}^{V}} ( {HI}_{( v , l )}^{V} \times {w}_{( v , l )}^{V} )}{{\sum }_{l ∈ {S}_{I , i}^{L}} {\sum }_{v ∈ {S}_{L , l}^{V}} {w}_{( v , l )}^{V}} = \frac{{\sum }_{l ∈ {S}_{I , i}^{L}} ( {HI}_{l}^{L} \times {w}_{l}^{L} )}{{\sum }_{l ∈ {S}_{I , i}^{L}} {w}_{l}^{L}}$$

an index of number of times of stopping of the road Rᵣ is reckoned as follows:

$$\begin{matrix}{HI}_{r}^{R} = \frac{\begin{matrix}{\sum }_{s ∈ {S}_{R , r}^{S}} {\sum }_{u ∈ {S}_{S , s}^{U}} {\sum }_{l ∈ {S}_{U , u}^{L}} {\sum }_{v ∈ {S}_{L , l}^{V}} {h}_{( v , l )}^{V} + \\ {\sum }_{i ∈ {S}_{R , r}^{I}} {\sum }_{l ∈ {S}_{I , i}^{L}} {\sum }_{v ∈ {S}_{L , l}^{V}} {h}_{( v , l )}^{V}\end{matrix}}{\begin{matrix}{\sum }_{s ∈ {S}_{R , r}^{S}} {\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}^{V}} + \\ {\sum }_{i ∈ {S}_{R , r}^{I}} {\sum }_{l ∈ {S}_{I , i}^{L}} {\sum }_{v ∈ {S}_{L , l}^{V}} {t}_{{f}_{( v , l )}^{V}}\end{matrix}} \\ = \frac{{\sum }_{l ∈ {S}_{R , r}^{L}} {\sum }_{v ∈ {S}_{L , l}^{V}} {h}_{( v , l )}^{V}}{{\sum }_{l ∈ {S}_{R , r}^{L}} {\sum }_{v ∈ {S}_{L , l}^{V}} {t}_{{f}_{( v , l )}^{V}}} \\ = \frac{{\sum }_{l ∈ {S}_{Z , z}^{L}} ( {HI}_{l}^{L} \times {w}_{l}^{L} )}{{\sum }_{l ∈ {S}_{Z , z}^{L}} {w}_{l}^{L}}\end{matrix}$$

an index of number of times of stopping of the sub-zone Z_{z} is reckoned as follows:

$$\begin{matrix}{HI}_{z}^{Z} = \frac{\begin{matrix}{\sum }_{s ∈ {S}_{Z , z}^{S}} {\sum }_{u ∈ {S}_{S , s}^{U}} {\sum }_{l ∈ {S}_{U , u}^{L}} {\sum }_{v ∈ {S}_{L , l}^{V}} {h}_{( v , l )}^{V} + \\ {\sum }_{i ∈ {S}_{Z , z}^{I}} {\sum }_{l ∈ {S}_{I , i}^{L}} {\sum }_{v ∈ {S}_{L , l}^{V}} {h}_{( v , l )}^{V}\end{matrix}}{\begin{matrix}{\sum }_{s ∈ {S}_{Z , z}^{S}} {\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}^{V}} + \\ {\sum }_{i ∈ {S}_{Z , z}^{I}} {\sum }_{l ∈ {S}_{I , i}^{L}} {\sum }_{v ∈ {S}_{L , l}^{V}} {t}_{{f}_{( v , l )}^{V}}\end{matrix}} \\ = \frac{{\sum }_{l ∈ {S}_{Z , z}^{L}} {\sum }_{v ∈ {S}_{L , l}^{V}} {h}_{( v , l )}^{V}}{{\sum }_{l ∈ {S}_{Z , z}^{L}} {\sum }_{v ∈ {S}_{L , l}^{V}} {t}_{{f}_{( v , l )}^{V}}} \\ = \frac{{\sum }_{l ∈ {S}_{Z , z}^{L}} ( {HI}_{l}^{L} \times {w}_{l}^{L} )}{{\sum }_{l ∈ {S}_{Z , z}^{L}} {w}_{l}^{L}}\end{matrix}$$

an index of number of times of stopping of the zone is reckoned as follows:

$$\begin{matrix}{HI}^{A} = \frac{\begin{matrix}{\sum }_{s ∈ {S}_{A}^{S}} {\sum }_{u ∈ {S}_{S , s}^{U}} {\sum }_{l ∈ {S}_{U , u}^{L}} {\sum }_{v ∈ {S}_{L , l}^{V}} {h}_{( v , l )}^{V} + \\ {\sum }_{i ∈ {S}_{A}^{I}} {\sum }_{l ∈ {S}_{I , i}^{L}} {\sum }_{v ∈ {S}_{L , l}^{V}} {h}_{( v , l )}^{V}\end{matrix}}{\begin{matrix}{\sum }_{s ∈ {S}_{A}^{S}} {\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}^{V}} + \\ {\sum }_{i ∈ {S}_{A}^{I}} {\sum }_{l ∈ {S}_{I , i}^{L}} {\sum }_{v ∈ {S}_{L , l}^{V}} {t}_{{f}_{( v , l )}^{V}}\end{matrix}} \\ = \frac{{\sum }_{l ∈ {S}_{A}^{L}} {\sum }_{v ∈ {S}_{L , l}^{V}} {h}_{( v , l )}^{V}}{{\sum }_{l ∈ {S}_{A}^{L}} {\sum }_{v ∈ {S}_{L , l}^{V}} {t}_{{f}_{( v , l )}^{V}}} \\ = {{\sum }_{l ∈ {S}_{A}^{L}}}_{} ( {HI}_{l}^{L} \times {w}_{l}^{L} )\end{matrix}$$

wherein HI_{(v,l)}^{V} is the index of the number of times of stopping of the vehicle Vᵥ on the lane Lₗ; h_{(v,l)}^{V} is the number of times of stopping of the vehicle Vᵥ passing the lane Lₗ; and HIᵥ^{V}, HIₗ^{L}, HIᵤ^{U}, HIₛ^{S}, HIᵢ^{I}, HIᵣ^{R}, HI_{z}^{Z}, and HI^{A} represent the indexes of number of times of stopping of the vehicle Vᵥ, the lane Lₗ, the subsection Uᵤ, the section Sₛ, the intersection Iᵢ, the road Rᵣ, the sub-zone Z_{z}, and the zone respectively; and
S502, calculating the average numbers of times of stopping of various evaluation objects, wherein
according to the acquired indexes of number of times of stopping of the different evaluation objects at the multiple spatial scales, the average numbers of times of stopping of various evaluation objects are calculated, which are specifically as follows:
an average number of times of stopping of the vehicle Vᵥ passing the lane Lₗ is reckoned as follows:

$${h}_{( v , l )}^{V} = {HI}_{( v , l )}^{V} \times {t}_{{f}_{( v , l )}^{V}}$$

an average number of times of stopping of the vehicle Vᵥ is reckoned as follows:

$${h}_{v}^{V} = {\sum }_{l ∈ {S}_{V , v}^{L}} {h}_{( v , l )}^{V} = {HI}_{v}^{V} \times {\sum }_{l ∈ {S}_{V , v}^{L}} {t}_{{f}_{l}^{L}} = {HI}_{v}^{V} \times {t}_{{f}_{v}^{V}}$$

an average number of times of stopping of the lane Lₗ is reckoned as follows:

$${\overline{h}}_{l}^{L} = \frac{{\sum }_{v ∈ {S}_{L , l}^{V}} {h}_{( v , l )}^{V}}{{N}_{L , l}^{V}} = \frac{{\sum }_{v ∈ {S}_{L , l}^{V}} {h}_{( v , l )}^{V}}{{\sum }_{v ∈ {S}_{L , l}^{V}} {t}_{{f}_{( v , l )}^{V}}} \times \frac{{\sum }_{v ∈ {S}_{L , l}^{V}} {t}_{{f}_{( v , l )}^{V}}}{{N}_{L , l}^{V}} = {HI}_{l}^{L} \times {t}_{{f}_{l}^{L}}$$

an average number of times of stopping of the subsection Uᵤ is reckoned as follows:

$${\overline{h}}_{u}^{U} = \frac{{\sum }_{l ∈ {S}_{U , u}^{L}} {\sum }_{v ∈ {S}_{L , l}^{V}} {h}_{( v , l )}^{V}}{{N}_{U , u}^{V}} = \frac{{\sum }_{l ∈ {S}_{U , u}^{L}} {\sum }_{v ∈ {S}_{L , l}^{V}} {h}_{( v , l )}^{V}}{{\sum }_{l ∈ {S}_{U , u}^{L}} {\sum }_{v ∈ {S}_{L , l}^{V}} {t}_{{f}_{( v , l )}^{V}}} \times \frac{{\sum }_{l ∈ {S}_{U , u}^{L}} {\sum }_{v ∈ {S}_{L , l}^{V}} {t}_{{f}_{( v , l )}^{V}}}{{N}_{U , u}^{V}} = {HI}_{u}^{U} \times {t}_{{f}_{u}^{U}}$$

an average number of times of stopping of the section Sₛ is reckoned as follows:

$${\overline{h}}_{s}^{S} = \frac{{\sum }_{u ∈ {S}_{S , s}^{U}} {\sum }_{l ∈ {S}_{U , u}^{L}} {\sum }_{v ∈ {S}_{L , l}^{V}} {h}_{( v , l )}^{V}}{{N}_{S , s}^{V}} = \frac{{\sum }_{u ∈ {S}_{S , s}^{U}} {\sum }_{l ∈ {S}_{U , u}^{L}} {\sum }_{v ∈ {S}_{L , l}^{V}} {h}_{( v , l )}^{V}}{{\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}^{V}}} \times \frac{{\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}^{V}}}{{N}_{S , s}^{V}} = {HI}_{s}^{S} \times {t}_{{f}_{s}^{S}}$$

an average number of times of stopping of the intersection Iᵢ is reckoned as follows:

$${\overline{h}}_{i}^{I} = \frac{{\sum }_{l ∈ {S}_{I , i}^{L}} {\sum }_{v ∈ {S}_{L , l}^{V}} {h}_{( v , l )}^{V}}{{N}_{I , i}^{V}} = \frac{{\sum }_{l ∈ {S}_{I , i}^{L}} {\sum }_{v ∈ {S}_{L , l}^{V}} {h}_{( v , l )}^{V}}{{\sum }_{l ∈ {S}_{I , i}^{L}} {\sum }_{v ∈ {S}_{L , l}^{V}} {t}_{{f}_{( v , l )}^{V}}} \times \frac{{\sum }_{l ∈ {S}_{I , i}^{L}} {\sum }_{v ∈ {S}_{L , l}^{V}} {t}_{{f}_{( v , l )}^{V}}}{{N}_{I , i}^{V}} = {HI}_{i}^{I} \times {t}_{{f}_{i}^{I}}$$

an average number of times of stopping of the road Rᵣ is reckoned as follows:

$${\overline{h}}_{r}^{R} = \frac{{\sum }_{l ∈ {S}_{R , r}^{L}} {\sum }_{v ∈ {S}_{L , l}^{V}} {h}_{( v , l )}^{V}}{{N}_{R , r}^{V}} = \frac{{\sum }_{l ∈ {S}_{R , r}^{L}} {\sum }_{v ∈ {S}_{L , l}^{V}} {h}_{( v , l )}^{V}}{{\sum }_{l ∈ {S}_{R , r}^{L}} {\sum }_{v ∈ {S}_{L , l}^{V}} {t}_{{f}_{( v , l )}^{V}}} \times \frac{{\sum }_{l ∈ {S}_{R , r}^{L}} {\sum }_{v ∈ {S}_{L , l}^{V}} {t}_{{f}_{( v , l )}^{V}}}{{N}_{R , r}^{V}} = {HI}_{r}^{R} \times {t}_{{f}_{r}^{R}}$$

an average number of times of stopping of the sub-zone Z_{z} is reckoned as follows:

$${\overline{h}}_{z}^{Z} = \frac{{\sum }_{l ∈ {S}_{Z , z}^{L}} {\sum }_{v ∈ {S}_{L , l}^{V}} {h}_{( v , l )}^{V}}{{N}_{Z , z}^{V}} = \frac{{\sum }_{l ∈ {S}_{Z , z}^{L}} {\sum }_{v ∈ {S}_{L , l}^{V}} {h}_{( v , l )}^{V}}{{\sum }_{l ∈ {S}_{Z , z}^{L}} {\sum }_{v ∈ {S}_{L , l}^{V}} {t}_{{f}_{( v , l )}^{V}}} \times \frac{{\sum }_{l ∈ {S}_{Z , z}^{L}} {\sum }_{v ∈ {S}_{L , l}^{V}} {t}_{{f}_{( v , l )}^{V}}}{{N}_{Z , z}^{V}} = {HI}_{z}^{Z} \times {t}_{{f}_{z}^{Z}}$$

an average number of times of stopping of the zone is reckoned as follows:

$${\overline{h}}^{A} = \frac{{\sum }_{l ∈ {S}_{A}^{L}} {\sum }_{v ∈ {S}_{L , l}^{V}} {h}_{( v , l )}^{V}}{{N}_{A}^{V}} = \frac{{\sum }_{l ∈ {S}_{A}^{L}} {\sum }_{v ∈ {S}_{L , l}^{V}} {h}_{( v , l )}^{V}}{{\sum }_{l ∈ {S}_{A}^{L}} {\sum }_{v ∈ {S}_{L , l}^{V}} {t}_{{f}_{( v , l )}^{V}}} \times \frac{{\sum }_{l ∈ {S}_{A}^{L}} {\sum }_{v ∈ {S}_{L , l}^{V}} {t}_{{f}_{( v , l )}^{V}}}{{N}_{A}^{V}} = {HI}^{A} \times {t}_{{f}^{A}}$$

wherein hᵥ^{V} is the number of times of stopping of the vehicle Vᵥ; and h̅ₗ^{L}, h̅ᵤ^{U}, h̅ₛ^{S}, h̅ᵢ^{I}, h̅ᵣ^{R}, h̅_{z}^{Z}, and h̅^{A} represent the average numbers of times of stopping of the lane Lₗ, the subsection Uᵤ, the second Sₛ, the intersection Iᵢ, the road Rᵣ, the sub-zone Z_{z}, and the zone respectively.

As a preferred technical solution, step S6 is specifically as follows:
S601, reckoning the indexes of the mileages of the congested roads of various evaluation objects at the multiple spatial scales, wherein
the index of the mileage of the congested road of each evaluation object in the road network is a ratio of an overall mileage of a heavily congested road of all the passing vehicles in each evaluation object to the overall free-flow driving time, that is, an average mileage of a heavily congested road of all the passing vehicles in the distance corresponding to the unit free-flow driving time; and
the index of the mileage of the congested road of each evaluation object may be obtained by weighted summation of the traffic weight coefficients and the indexes of the mileages of the congested roads of the vehicles, the lanes, the sub-sections, the sections, and the intersections belonging to the evaluation object, and the index of the mileage of the congested road is in a unit of “m/min”, having an ability to further calculate the proportion of the mileage of the heavily congested road, specifically as follows:
an index of a mileage of a congested road of the vehicle Vᵥ passing the lane Lₗ is reckoned as follows:

$${MI}_{( v , l )}^{V} = \frac{{l}_{{c}_{( v , l )}^{V}}}{{t}_{{f}_{( v , l )}^{V}}}$$

an index of a mileage of a congested road of the vehicle Vᵥ is reckoned as follows:

$${MI}_{v}^{V} = \frac{{\sum }_{l ∈ {S}_{V , v}^{L}} {l}_{{c}_{( v , l )}^{V}}}{{\sum }_{l ∈ {S}_{V , v}^{L}} {t}_{{f}_{l}^{L}}} = \frac{{\sum }_{l ∈ {S}_{V , v}^{L}} ( {MI}_{( v , l )}^{V} \times {t}_{{f}_{( v , l )}^{V}} )}{{\sum }_{v = 1}^{{N}^{V}} {\sum }_{l ∈ {S}_{V , v}^{L}} {t}_{{f}_{l}^{L}}} \times \frac{{\sum }_{v = 1}^{{N}^{V}} {\sum }_{l ∈ {S}_{V , v}^{L}} {t}_{{f}_{l}^{L}}}{{\sum }_{l ∈ {S}_{V , v}^{L}} {t}_{{f}_{l}^{L}}} = \frac{{\sum }_{l ∈ {S}_{V , v}^{L}} ( {MI}_{( v , l )}^{V} \times {w}_{( v , l )}^{V} )}{{\sum }_{l ∈ {S}_{V , v}^{L}} {w}_{( v , l )}^{V}}$$

an index of a mileage of a congested road of the lane Lₗ is reckoned as follows:

$${MI}_{l}^{L} = \frac{{\sum }_{v ∈ {S}_{L , l}^{V}} {l}_{{c}_{( v , l )}^{V}}}{{\sum }_{v ∈ {S}_{L , l}^{V}} {t}_{{f}_{( v , l )}^{V}}} = \frac{{\sum }_{v ∈ {S}_{L , l}^{V}} {l}_{{c}_{( v , l )}^{V}}}{{\sum }_{v = 1}^{{N}^{V}} {\sum }_{l ∈ {S}_{V , v}^{L}} {t}_{{f}_{( v , l )}^{V}}} \times \frac{{\sum }_{v = 1}^{{N}^{V}} {\sum }_{l ∈ {S}_{V , v}^{L}} {t}_{{f}_{( v , l )}^{V}}}{{\sum }_{v ∈ {S}_{L , l}^{V}} {t}_{{f}_{( v , l )}^{V}}} = \frac{{\sum }_{v ∈ {S}_{L , l}^{V}} ( {MI}_{( v , l )}^{V} \times {w}_{( v , l )}^{V} )}{{\sum }_{v ∈ {S}_{L , l}^{V}} {w}_{( v , l )}^{V}}$$

an index of a mileage of a congested road of the subsection Uᵤ is reckoned as follows:

$${MI}_{u}^{U} = \frac{{\sum }_{l ∈ {S}_{U , u}^{L}} {\sum }_{v ∈ {S}_{L , l}^{V}} {l}_{{c}_{( v , l )}^{V}}}{{\sum }_{l ∈ {S}_{U , u}^{L}} {\sum }_{v ∈ {S}_{L , l}^{V}} {t}_{{f}_{( v , l )}^{V}}} = \frac{{\sum }_{l ∈ {S}_{U , u}^{L}} {\sum }_{v ∈ {S}_{L , l}^{V}} ( {MI}_{( v , l )}^{V} \times {w}_{( v , l )}^{V} )}{{\sum }_{l ∈ {S}_{U , u}^{L}} {\sum }_{v ∈ {S}_{L , l}^{V}} {w}_{( v , l )}^{V}} = \frac{{\sum }_{l ∈ {S}_{U , u}^{L}} ( {MI}_{l}^{L} \times {w}_{l}^{L} )}{{\sum }_{l ∈ {S}_{U , u}^{L}} {w}_{l}^{L}}$$

an index of a mileage of a congested road of the section Sₛ is reckoned as follows:

$${MI}_{s}^{S} = \frac{{\sum }_{u ∈ {S}_{S , s}^{U}} {\sum }_{l ∈ {S}_{U , u}^{L}} {\sum }_{v ∈ {S}_{L , l}^{V}} {l}_{{c}_{( v , l )}^{V}}}{{\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}^{V}}} = \frac{{\sum }_{l ∈ {S}_{S , s}^{L}} {\sum }_{v ∈ {S}_{L , l}^{V}} ( {MI}_{( v , l )}^{V} \times {w}_{( v , l )}^{V} )}{{\sum }_{l ∈ {S}_{S , s}^{L}} {\sum }_{v ∈ {S}_{L , l}^{V}} {w}_{( v , l )}^{V}} = \frac{{\sum }_{l ∈ {S}_{S , s}^{L}} ( {MI}_{l}^{L} \times {w}_{l}^{L} )}{{\sum }_{l ∈ {S}_{S , s}^{L}} {w}_{l}^{L}} = \frac{{\sum }_{u ∈ {S}_{S , s}^{U}} ( {MI}_{u}^{U} \times {w}_{u}^{U} )}{{\sum }_{u ∈ {S}_{S , s}^{U}} {w}_{u}^{U}}$$

an index of a mileage of a congested road of the intersection Iᵢ is reckoned as follows:

$${MI}_{i}^{I} = \frac{{\sum }_{l ∈ {S}_{I , i}^{L}} {\sum }_{v ∈ {S}_{L , l}^{V}} {l}_{{c}_{( v , l )}^{V}}}{{\sum }_{l ∈ {S}_{I , i}^{L}} {\sum }_{v ∈ {S}_{L , l}^{V}} {t}_{{f}_{( v , l )}^{V}}} = \frac{{\sum }_{l ∈ {S}_{I , i}^{L}} {\sum }_{v ∈ {S}_{L , l}^{V}} ( {MI}_{( v , l )}^{V} \times {w}_{( v , l )}^{V} )}{{\sum }_{l ∈ {S}_{I , i}^{L}} {\sum }_{v ∈ {S}_{L , l}^{V}} {w}_{( v , l )}^{V}} = \frac{{\sum }_{l ∈ {S}_{I , i}^{L}} ( {MI}_{l}^{L} \times {w}_{l}^{L} )}{{\sum }_{l ∈ {S}_{I , i}^{L}} {w}_{l}^{L}}$$

an index of a mileage of a congested road of the road Rᵣ is reckoned as follows:

$${MI}_{r}^{R} = \frac{{\sum }_{s ∈ {S}_{R , r}^{S}} {\sum }_{u ∈ {S}_{S , s}^{U}} {\sum }_{l ∈ {S}_{U , u}^{L}} {\sum }_{v ∈ {S}_{L , l}^{V}} {l}_{{c}_{( v , l )}^{V}} + {\sum }_{i ∈ {S}_{R , r}^{I}} {\sum }_{l ∈ {S}_{I , i}^{L}} {\sum }_{v ∈ {S}_{L , l}^{V}} {l}_{{c}_{( v , l )}^{V}}}{{\sum }_{s ∈ {S}_{R , r}^{S}} {\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}^{V}} + {\sum }_{i ∈ {S}_{R , r}^{I}} {\sum }_{l ∈ {S}_{I , i}^{L}} {\sum }_{v ∈ {S}_{L , l}^{V}} {t}_{{f}_{( v , l )}^{V}}} = \frac{{\sum }_{l ∈ {S}_{R , r}^{L}} {\sum }_{v ∈ {S}_{L , l}^{V}} {l}_{{c}_{( v , l )}^{V}}}{{\sum }_{l ∈ {S}_{R , r}^{L}} {\sum }_{v ∈ {S}_{L , l}^{V}} {t}_{{f}_{( v , l )}^{V}}} = \frac{{\sum }_{l ∈ {S}_{R , r}^{L}} ( {MI}_{l}^{L} \times {w}_{l}^{L} )}{{\sum }_{l ∈ {S}_{R , r}^{L}} {w}_{l}^{L}}$$

an index of a mileage of a congested road of the sub-zone Z_{z} is reckoned as follows:

$${MI}_{z}^{Z} = \frac{{\sum }_{s ∈ {S}_{Z , z}^{S}} {\sum }_{u ∈ {S}_{S , s}^{U}} {\sum }_{l ∈ {S}_{U , u}^{L}} {\sum }_{v ∈ {S}_{L , l}^{V}} {l}_{{c}_{( v , l )}^{V}} + {\sum }_{i ∈ {S}_{Z , z}^{I}} {\sum }_{l ∈ {S}_{I , i}^{L}} {\sum }_{v ∈ {S}_{L , l}^{V}} {l}_{{c}_{( v , l )}^{V}}}{{\sum }_{s ∈ {S}_{Z , z}^{S}} {\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}^{V}} + {\sum }_{i ∈ {S}_{Z , z}^{I}} {\sum }_{l ∈ {S}_{I , i}^{L}} {\sum }_{v ∈ {S}_{L , l}^{V}} {t}_{{f}_{( v , l )}^{V}}} = \frac{{\sum }_{l ∈ {S}_{Z , z}^{L}} {\sum }_{v ∈ {S}_{L , l}^{V}} {l}_{{c}_{( v , l )}^{V}}}{{\sum }_{l ∈ {S}_{Z , z}^{L}} {\sum }_{v ∈ {S}_{L , l}^{V}} {t}_{{f}_{( v , l )}^{V}}} = \frac{{\sum }_{l ∈ {S}_{Z , z}^{L}} ( {MI}_{l}^{L} \times {w}_{l}^{L} )}{{\sum }_{l ∈ {S}_{Z , z}^{L}} {w}_{l}^{L}}$$

an index of a mileage of a congested road of the zone is reckoned as follows:

$$\begin{matrix}{MI}^{A} = \frac{{\sum }_{s ∈ {S}_{A}^{S}} {\sum }_{u ∈ {S}_{S , s}^{U}} {\sum }_{l ∈ {S}_{U , u}^{L}} {\sum }_{v ∈ {S}_{L , l}^{V}} {l}_{{c}_{( v , l )}}^{V} + {\sum }_{i ∈ {S}_{A}^{I}} {\sum }_{l ∈ {S}_{I , i}^{L}} {\sum }_{v ∈ {S}_{L , l}^{V}} {l}_{{c}_{( v , l )}}^{V}}{{\sum }_{s ∈ {S}_{A}^{S}} {\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}}^{V} + {\sum }_{i ∈ {S}_{A}^{I}} {\sum }_{l ∈ {S}_{I , i}^{L}} {\sum }_{v ∈ {S}_{L , l}^{V}} {t}_{{f}_{( v , l )}}^{V}} \\ = \frac{{\sum }_{l ∈ {S}_{A}^{L}} {\sum }_{v ∈ {S}_{L . l}^{V}} {l}_{{c}_{( v , l )}}^{V}}{{\sum }_{l ∈ {S}_{A}^{L}} {\sum }_{v ∈ {S}_{L . l}^{V}} {t}_{{f}_{( v , l )}}^{V}} = {\sum }_{l ∈ {S}_{A}^{L}} ( {MI}_{l}^{L} \times {w}_{l}^{L} )\end{matrix}$$

wherein MI_{(v,l)}^{V} is the index of the mileage of the congested road of the vehicle Vᵥ on the lane Lₗ; l_{c(v,l)}^{V} is the mileage of the congested road of the vehicle V, passing the lane Lₗ; and MIᵥ^{V}, MIₗ^{L}, MIᵤ^{U}, MIₛ^{S}, MIᵢ^{I}, MIᵣ^{R}, MI_{z}^{Z}, and MI^{A} represent the indexes of the mileages of the congested roads of the vehicle Vᵥ, the lane Lₗ, the subsection Uᵤ, the section Sₛ, the intersection Iᵢ, the road Rᵣ, the sub-zone Z_{z}, and the zone respectively; and
S602, calculating the proportions of the mileages of the heavily congested roads of various evaluation objects, wherein
according to the acquired index of the mileage of the congested road of the different evaluation objects at the multiple spatial scales, the proportion of the mileage of the heavily congested road of each evaluation object is calculated, which is specifically as follows:
a proportion of a mileage of a heavily congested road of the vehicle Vᵥ passing the lane Lₗ is reckoned as follows:

$${m}_{( v , l )}^{V} = \frac{{l}_{{c}_{( v , l )}}^{V}}{{l}_{( v , l )}^{V}} = \frac{{l}_{{c}_{( v , l )}}^{V}}{{t}_{{f}_{( v , l )}}^{V}} \times \frac{{t}_{{f}_{( v , l )}}^{V}}{{l}_{( v , l )}^{V}} = \frac{{MI}_{( v , l )}^{V}}{{V}_{{f}_{( v , l )}}^{V}}$$

a proportion of a mileage of a heavily congested road of the vehicle Vᵥ is reckoned as follows:

$${m}_{v}^{V} = \frac{{\sum }_{l ∈ {S}_{V , v}^{L}} {l}_{{c}_{( v , l )}}^{V}}{{\sum }_{l ∈ {S}_{V , v}^{L}} {l}_{( v , l )}^{V}} = \frac{{\sum }_{l ∈ {S}_{V , v}^{L}} {l}_{{c}_{( v , l )}}^{V}}{{\sum }_{l ∈ {S}_{V , v}^{L}} {t}_{{f}_{l}}^{L}} \times \frac{{\sum }_{l ∈ {S}_{V , v}^{L}} {t}_{{f}_{l}}^{L}}{{\sum }_{l ∈ {S}_{V , v}^{L}} {l}_{( v , l )}^{V}} = \frac{{MI}_{v}^{V}}{{\overline{V}}_{{f}_{v}}^{V}}$$

a proportion of a mileage of a heavily congested road of the lane Lₗ is reckoned as follows:

$${m}_{l}^{L} = \frac{{\sum }_{v ∈ {S}_{L , l}^{V}} {l}_{{c}_{( v , l )}}^{V}}{{\sum }_{v ∈ {S}_{L , l}^{V}} {l}_{( v , l )}^{V}} = \frac{{\sum }_{v ∈ {S}_{L , l}^{V}} {l}_{{c}_{( v , l )}}^{V}}{{\sum }_{v ∈ {S}_{L , l}^{V}} {t}_{{f}_{( v , l )}}^{V}} \times \frac{{\sum }_{v ∈ {S}_{L , l}^{V}} {t}_{{f}_{( v , l )}}^{V}}{{\sum }_{v ∈ {S}_{L , l}^{V}} {l}_{( v , l )}^{V}} = \frac{{MI}_{l}^{L}}{{\overline{V}}_{{f}_{l}}^{L}}$$

a proportion of a mileage of a heavily congested road of the subsection Uᵤ is reckoned as follows:

$${m}_{u}^{U} = \frac{{\sum }_{l ∈ {S}_{U , u}^{L}} {\sum }_{v ∈ {S}_{L , l}^{V}} {l}_{{c}_{( v , l )}}^{V}}{{\sum }_{l ∈ {S}_{U , u}^{L}} {\sum }_{v ∈ {S}_{L , l}^{V}} {l}_{( v , l )}^{V}} = \frac{{\sum }_{l ∈ {S}_{U , u}^{L}} {\sum }_{v ∈ {S}_{L , l}^{V}} {l}_{{c}_{( v , l )}}^{V}}{{\sum }_{l ∈ {S}_{U , u}^{L}} {\sum }_{v ∈ {S}_{L , l}^{V}} {t}_{{f}_{( v , l )}}^{V}} \times \frac{{\sum }_{l ∈ {S}_{U , u}^{L}} {\sum }_{v ∈ {S}_{L , l}^{V}} {t}_{{f}_{( v , l )}}^{V}}{{\sum }_{l ∈ {S}_{U , u}^{L}} {\sum }_{v ∈ {S}_{L , l}^{V}} {l}_{( v , l )}^{V}} = \frac{{MI}_{u}^{U}}{{\overline{V}}_{{f}_{u}}^{U}}$$

a proportion of a mileage of a heavily congested road of the section Sₛ is reckoned as follows:

$${m}_{s}^{S} = \frac{{\sum }_{u ∈ {S}_{S , s}^{U}} {\sum }_{l ∈ {S}_{U , u}^{L}} {\sum }_{v ∈ {S}_{L , l}^{V}} {l}_{{c}_{( v , l )}}^{V}}{{\sum }_{u ∈ {S}_{S , s}^{U}} {\sum }_{l ∈ {S}_{U , u}^{L}} {\sum }_{v ∈ {S}_{L , l}^{V}} {l}_{( v , l )}^{V}} = \frac{{\sum }_{u ∈ {S}_{S , s}^{U}} {\sum }_{l ∈ {S}_{U , u}^{L}} {\sum }_{v ∈ {S}_{L , l}^{V}} {l}_{{c}_{( v , l )}}^{V}}{{\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}}^{V}} \times \frac{{\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}}^{V}}{{\sum }_{u ∈ {S}_{S , s}^{U}} {\sum }_{l ∈ {S}_{U , u}^{L}} {\sum }_{v ∈ {S}_{L , l}^{V}} {l}_{( v , l )}^{V}} = \frac{{MI}_{s}^{S}}{{\overline{V}}_{{f}_{s}}^{S}}$$

a proportion of a mileage of a heavily congested road of the intersection I; is reckoned as follows:

$${m}_{i}^{I} = \frac{{\sum }_{I ∈ {S}_{I , i}^{L}} {\sum }_{v ∈ {S}_{L , l}^{V}} {l}_{{c}_{( v , l )}}^{V}}{{\sum }_{l ∈ {S}_{I , i}^{L}} {\sum }_{v ∈ {S}_{L , l}^{V}} {l}_{( v , l )}^{V}} = \frac{{\sum }_{l ∈ {S}_{I , i}^{L}} {\sum }_{v ∈ {S}_{L , l}^{V}} {l}_{{c}_{( v , l )}}^{V}}{{\sum }_{l ∈ {S}_{I , i}^{L}} {\sum }_{v ∈ {S}_{L , l}^{V}} {t}_{{f}_{( v , l )}}^{V}} \times \frac{{\sum }_{l ∈ {S}_{I , i}^{L}} {\sum }_{v ∈ {S}_{L , l}^{V}} {t}_{{f}_{( v , l )}}^{V}}{{\sum }_{l ∈ {S}_{I , i}^{L}} {\sum }_{v ∈ {S}_{L , l}^{V}} {l}_{( v , l )}^{V}} = \frac{{MI}_{i}^{I}}{{\overline{V}}_{{f}_{i}}^{I}}$$

a proportion of a mileage of a heavily congested road of the road Rᵣ is reckoned as follows:

$${m}_{r}^{R} = \frac{{\sum }_{l ∈ {S}_{R , r}^{L}} {\sum }_{v ∈ {S}_{L , l}^{V}} {l}_{{c}_{( v , l )}}^{V}}{{\sum }_{l ∈ {S}_{R , r}^{L}} {\sum }_{v ∈ {S}_{L , l}^{V}} {l}_{( v , l )}^{V}} = \frac{{\sum }_{l ∈ {S}_{R , r}^{L}} {\sum }_{v ∈ {S}_{L , l}^{V}} {l}_{{c}_{( v , l )}}^{V}}{{\sum }_{l ∈ {S}_{R , r}^{L}} {\sum }_{v ∈ {S}_{L , l}^{V}} {t}_{{f}_{( v , l )}}^{V}} \times \frac{{\sum }_{l ∈ {S}_{R , r}^{L}} {\sum }_{v ∈ {S}_{L , l}^{V}} {t}_{{f}_{( v , l )}}^{V}}{{\sum }_{l ∈ {S}_{I , i}^{L}} {\sum }_{v ∈ {S}_{L , l}^{V}} {l}_{( v , l )}^{V}} = \frac{{MI}_{r}^{R}}{{\overline{V}}_{{f}_{r}}^{R}}$$

a proportion of a mileage of a heavily congested road of the sub-zone Z, is reckoned as follows:

$${m}_{z}^{Z} = \frac{{\sum }_{l ∈ {S}_{Z , z}^{L}} {\sum }_{v ∈ {S}_{L , l}^{V}} {l}_{{c}_{( v , l )}}^{V}}{{\sum }_{l ∈ {S}_{Z , z}^{L}} {\sum }_{v ∈ {S}_{L , l}^{V}} {l}_{( v , l )}^{V}} = \frac{{\sum }_{l ∈ {S}_{Z , z}^{L}} {\sum }_{v ∈ {S}_{L , l}^{V}} {l}_{{c}_{( v , l )}}^{V}}{{\sum }_{l ∈ {S}_{Z , z}^{L}} {\sum }_{v ∈ {S}_{L , l}^{V}} {t}_{{f}_{( v , l )}}^{V}} \times \frac{{\sum }_{l ∈ {S}_{Z , z}^{L}} {\sum }_{v ∈ {S}_{L , l}^{V}} {t}_{{f}_{( v , l )}}^{V}}{{\sum }_{l ∈ {S}_{Z , z}^{L}} {\sum }_{v ∈ {S}_{L , l}^{V}} {l}_{{c}_{( v , l )}}^{V}} = \frac{{MI}_{z}^{Z}}{{\overline{V}}_{{f}_{z}}^{Z}}$$

a proportion of a mileage of a heavily congested road of the zone is reckoned as follows:

$${M}^{A} = \frac{{\sum }_{l ∈ {S}_{A}^{L}} {\sum }_{v ∈ {S}_{L , l}^{V}} {l}_{{c}_{( v , l )}}^{V}}{{\sum }_{l ∈ {S}_{A}^{L}} {\sum }_{v ∈ {S}_{L , l}^{V}} {l}_{( v , l )}^{V}} = \frac{{\sum }_{l ∈ {S}_{A}^{L}} {\sum }_{v ∈ {S}_{L , l}^{V}} {l}_{{c}_{( v , l )}}^{V}}{{\sum }_{l ∈ {S}_{A}^{L}} {\sum }_{v ∈ {S}_{L , l}^{V}} {t}_{{f}_{( v , l )}}^{V}} \times \frac{{\sum }_{l ∈ {S}_{A}^{L}} {\sum }_{v ∈ {S}_{L , l}^{V}} {t}_{{f}_{( v , l )}}^{V}}{{\sum }_{l ∈ {S}_{A}^{L}} {\sum }_{v ∈ {S}_{L , l}^{V}} {l}_{{c}_{( v , l )}}^{V}} = \frac{{MI}^{A}}{{\overline{V}}_{f}^{A}}$$

wherein m_{(v,l)}^{V} is the proportion of the mileage of the heavily congested road of the vehicle Vᵥ on the lane Lₗ; l_{(v,l)}^{V} is a vehicle mileage of the vehicle Vᵥ passing the lane Lₗ; V_{f(v,l)}^{V} is a flow-free driving speed of the vehicle Vᵥ passing the lane Lₗ; mᵥ^{V}, mₗ^{L}, mᵤ^{U}, mₛ^{S}, mᵢ^{I}, mᵣ^{R}, m_{z}^{Z}, and m^{A} represent proportions of mileages of heavily congested roads of the vehicle Vᵥ, the lane Lₗ, the subsection Uᵤ, the section Sₛ, the intersection Iᵢ, the road Rᵣ, the sub-zone Z_{z}, and the zone respectively; and V̅_{fv}^{V}, V̅_{fl}^{L}, V̅_{fu}^{U}, V̅_{fs}^{S}, \hat{V}_{fi}^{I}, V̅fr^{R}, V̅fz^{Z}, and V̅_{f}^{A} represent average flow-free driving speeds of the vehicle Vᵥ, the lane Lₗ, the subsection Uᵤ, the section Sₛ, the intersection Iᵢ, the road Rᵣ, the sub-zone Z_{z}, and the zone respectively.

As a preferred technical solution, a new method for calculating traffic operation state evaluation characteristic indexes is formed collectively by four indexes: the traffic operation index, the delay time index, the index of the number of times of stopping, and the index of the mileage of the congested road, wherein the larger the traffic operation index, the delay time index, the index of the number of times of stopping, and the index of the mileage of the congested road are, the worse the traffic operation state is, that is, the more congested the road traffic is.

Compared with the prior art, the present invention has the beneficial effects that:
1. The present invention provides a method for determining the traffic weight coefficients for combined calculation of the traffic operation states of the road network, to reckon the traffic weight coefficients of various evaluation objects at the different spatial scales, which can effectively reflect the proportions of the road time-space resources of various evaluation objects in the whole road network.
2. With the unit free-flow driving time as a quantitative standard, on the basis of a similar capability of calculating original traffic operation state evaluation indexes, the present invention re-establishes a new evaluation index system calculation method, which normalizes the traffic state characteristic indexes, and can be applicable to analysis and comparison on the traffic operation states of different road networks.
3. In combination with the traffic weight coefficients, the present invention reckons the traffic operation indexes, the average delay times, the average numbers of times of stopping, the proportions of the mileages of the heavily congested roads, and other traffic operation characteristic indexes at the different spatial scales by weighting different compositions of the roads at the different spatial scales in the road network, which further enriches a theoretical method for digital construction of the urban road network.

### BRIEF DESCRIPTION OF THE DRAWINGS

FIG. 1 is a flowchart of a digital road network traffic state reckoning method based on multi-scale calculation;

FIG. 2 is a schematic structural diagram of a road network according to an embodiment; and

FIG. 3 is a division schematic diagram of a traffic sub-zone Z₁ in a road network according to an embodiment.

### DETAILED DESCRIPTION OF THE EMBODIMENTS

The present invention will be further described in detail below in combination with the accompanying drawings and the specific embodiments, which is not to be construed as limiting to the present invention.

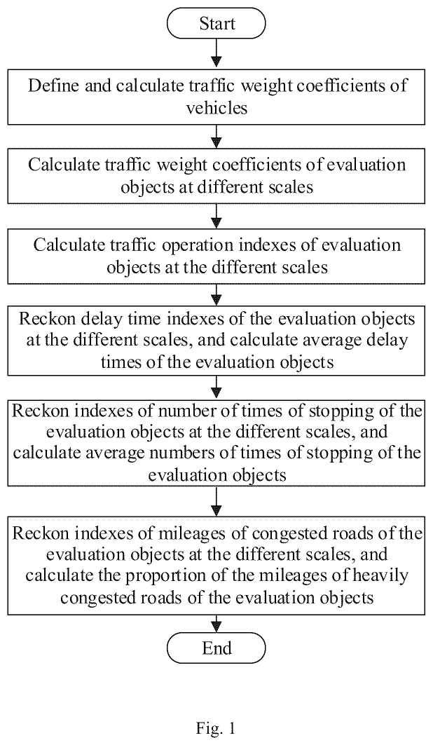

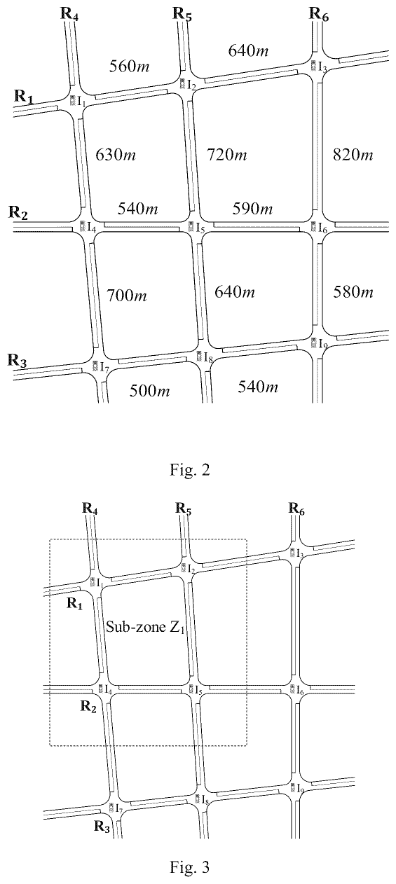

As shown in FIG. 2, assuming that a road network consists of three east-west roads (R₁, R₂, and R₃) and three north-south roads (R₄, R₅, and R₆), including 9 signal control intersections, 48 sections, and 336 lanes in total. FIG. 1 is a flowchart of a digital road network traffic state reckoning method based on multi-scale calculation provided by an example, specifically including the following implementation steps:
Step 1, acquiring traffic weight coefficients of vehicles according to free-flow driving times of the vehicles and an overall free-flow driving time of a road network.

Based on a vehicle detector and other road traffic data acquisition tools, basic traffic operation data of various passing vehicles in the road network is acquired. According to the acquired free-flow driving times t_{f(v,l)}^{V} of various passing vehicles on different lanes in the road network, the traffic weight coefficients w_{(v,l)}^{V} of the vehicles Vᵥ in various lanes Lₗ are calculated, and the traffic weight coefficients w_{(v,l)}^{V} of the different lanes in the road network belonging to the vehicles Vᵥ are summed, to obtain the traffic weight coefficient wᵥ^{V} of the v^{th} vehicle in the road network as follows:

$${w}_{v}^{V} = {\sum }_{l ∈ {S}_{V , v}^{L}} \frac{{t}_{{f}_{l}}^{L}}{{\sum }_{v = 1}^{{N}^{V}} {\sum }_{l ∈ {S}_{v , v}^{L}} {t}_{{f}_{l}}^{L}} = {\sum }_{l ∈ {S}_{V , v}^{L}} {w}_{( v , l )}^{V}$$

Taking vehicles V₄₆ and V₄₇ as examples, calculation results of the traffic weight coefficients of the vehicles are shown in Table 1.

TABLE 1
Traffic Weight Coefficients of Vehicles

| Vehicle number | Lane number | t_{f(v, l)}^{v}/s | w_{(v, l)}^{V} | wᵥ^{V} |
|---|---|---|---|---|
| . . . | . . . | . . . | . . . | . . . |
| V₄₆ | L₄ | 35.0 | 0.00013 | 0.00067 |
| | L₅ | 37.8 | 0.00014 | |
| | L₇ | 2.4 | 0.00015 | |
| | L₁₁ | 27.0 | 0.00010 | |
| | L₁₃ | 2.4 | 0.00013 | |
| | L₁₂₃ | 0.7 | 0.00000 | |
| | L₂₀₀ | 3.2 | 0.00001 | |
| | L₂₁₄ | 3.1 | 0.00001 | |
| V₄₇ | L₂₁ | 39.0 | 0.00014 | 0.00035 |
| | L₂₅ | 1.0 | 0.00000 | |
| | L₂₆ | 2.7 | 0.00019 | |
| | L₂₇₆ | 3.8 | 0.00002 | |
| . . . | . . . | . . . | . . . | . . . |

| | | | |
|---|---|---|---|
| Total | 169623.2 | 1 | 1 |

Step 2, calculating traffic weight coefficients of evaluation objects in the road network at different spatial scales level by level in combination with the traffic weight coefficients of the vehicles and a composition structure of the road network.

According to the traffic weight coefficients w_{(v,l)}^{V} of the vehicle Vᵥ on different lanes Lₗ in the road network, the traffic weight coefficients of all compositions belonging to a certain specified evaluation object at one spatial scale are summed to obtain the traffic weight coefficient of the evaluation object.

In the embodiment, the traffic weight coefficients of various lanes, various intersections, and various roads are calculated by using the traffic weight coefficients w_{(v,l)}^{V} of various passing vehicles Vᵥ on the different lanes Lₗ in Table 1. Calculation results are shown in Table 2, Table 3, and Table 4.

TABLE 2
Traffic Weight Coefficients of Lanes

| Lane | qₗ^{L}/ | | | h̅ₗ^{L}/ | | | |
|---|---|---|---|---|---|---|---|
| number | (vehicle/h) | tₗ^{L}/s | d̅ₗ^{L}/s | time | mₗ^{L} | t_{f l}^{L}/s | wₗ^{L} |
| L₁ | 452 | 33.67 | 1.40 | 0.02 | 2.67% | 32.27 | 0.0215 |
| L₂ | 240 | 23.77 | 21.35 | 0.62 | 35.92% | 2.42 | 0.0009 |
| L₃ | 228 | 31.28 | 28.83 | 0.68 | 42.52% | 2.45 | 0.0008 |
| L₄ | 312 | 32.00 | 0.09 | 0.00 | 0.26% | 31.91 | 0.0147 |
| L₅ | 328 | 39.32 | 1.25 | 0.00 | 2.64% | 38.07 | 0.0184 |
| L₆ | 176 | 6.36 | 3.70 | 0.14 | 8.40% | 2.67 | 0.0007 |
| L₇ | 152 | 31.50 | 28.87 | 0.82 | 41.15% | 2.63 | 0.0006 |
| L₈ | 404 | 43.36 | 4.84 | 0.08 | 5.87% | 38.51 | 0.0229 |
| L₉ | 236 | 23.83 | 21.31 | 0.56 | 35.78% | 2.52 | 0.0009 |
| L₁₀ | 192 | 24.17 | 21.68 | 0.63 | 41.11% | 2.48 | 0.0007 |
| . . . | . . . | . . . | . . . | . . . | . . . | . . . | . . . |
| Total | 5300 | 207.70 | 79.68 | 1.77 | 5.65% | 128.02 | 1 |

TABLE 3
Traffic Weight Coefficients of Intersection I₂

| | | | | | | | | | | Various | |
|---|---|---|---|---|---|---|---|---|---|---|---|
| Entrance | Lane | Lane | qₗ^{L}/ | | | | | | | entrances | |
| direction | attribute | number | (vehicle/h) | tₗ^{L}/s | d̅ₗ^{L}/s | h̅ₗ^{L}/time | mₗ^{L} | t_{f l}^{L}/s | wₗ^{L} | w | wᵢ^{I} |
| North | Tapered | L₂₆₁ | 80 | 1.00 | 0.29 | 0.00 | 23.60% | 0.72 | 0.0001 | 0.0034 | 0.0118 |
| | section | | | | | | | | | | |
| | Tapered | L₂₆₂ | 100 | 2.32 | 1.80 | 0.08 | 41.66% | 0.52 | 0.0001 | | |
| | section | | | | | | | | | | |
| | Entrance | L₈₂ | 200 | 26.88 | 24.78 | 0.80 | 47.65% | 2.10 | 0.0006 | | |
| | lane | | | | | | | | | | |
| | Entrance | L₈₃ | 216 | 26.19 | 23.94 | 0.74 | 42.90% | 2.24 | 0.0007 | | |
| | lane | | | | | | | | | | |
| | Left | L₂₂₇ | 8 | 3.50 | 0.60 | 0.00 | 14.56% | 2.90 | 0.0000 | | |
| | turning | | | | | | | | | | |
| | Straight | L₂₁₈ | 180 | 3.98 | 0.57 | 0.00 | 10.98% | 3.41 | 0.0009 | | |
| | driving | | | | | | | | | | |
| | Straight | L₂₂₀ | 188 | 3.91 | 0.50 | 0.00 | 16.97% | 3.41 | 0.0009 | | |
| | driving | | | | | | | | | | |
| | Right | L₂₁₉ | 24 | 2.33 | 0.48 | 0.00 | 9.84% | 1.85 | 0.0001 | | |
| | turning | | | | | | | | | | |
| East | Tapered | L₁₂₆ | 76 | 1.05 | 0.26 | 0.00 | 16.39% | 0.79 | 0.0001 | 0.0026 | |
| | section | | | | | | | | | | |
| | Tapered | L₁₂₇ | 84 | 2.90 | 2.26 | 0.10 | 28.41% | 0.65 | 0.0001 | | |
| | section | | | | | | | | | | |
| | Entrance | L₁₂ | 144 | 28.61 | 25.90 | 0.75 | 39.75% | 2.71 | 0.0006 | | |
| | lane | | | | | | | | | | |
| | Entrance | L₁₃ | 148 | 24.59 | 21.93 | 0.73 | 39.25% | 2.66 | 0.0006 | | |
| | lane | | | | | | | | | | |
| | Left | L₂₁₃ | 8 | 2.50 | 0.25 | 0.00 | 7.57% | 2.25 | 0.0000 | | |
| | turning | | | | | | | | | | |
| | Straight | L₂₁₄ | 140 | 3.60 | 0.56 | 0.00 | 11.98% | 3.04 | 0.0006 | | |
| | driving | | | | | | | | | | |
| | Straight | L₂₁₆ | 128 | 3.69 | 0.59 | 0.00 | 14.72% | 3.09 | 0.0006 | | |
| | driving | | | | | | | | | | |
| | Right | L₂₁₅ | 12 | 2.67 | 0.43 | 0.00 | 12.22% | 2.23 | 0.0000 | | |
| | turning | | | | | | | | | | |
| South | Tapered | L₁₇₀ | 44 | 1.00 | 0.20 | 0.00 | 16.92% | 0.80 | 0.0000 | 0.0021 | |
| | section | | | | | | | | | | |
| | Tapered | L₁₇₁ | 60 | 1.00 | 0.21 | 0.00 | 17.48% | 0.79 | 0.0001 | | |
| | section | | | | | | | | | | |
| | Entrance | L₈₆ | 108 | 25.74 | 23.41 | 0.81 | 40.84% | 2.33 | 0.0004 | | |
| | lane | | | | | | | | | | |
| | Entrance | L₈₇ | 124 | 24.23 | 21.85 | 0.68 | 38.72% | 2.38 | 0.0004 | | |
| | lane | | | | | | | | | | |
| | Left | L₁₇₂ | 8 | 3.50 | 0.65 | 0.00 | 14.80% | 2.85 | 0.0000 | | |
| | turning | | | | | | | | | | |
| | Straight | L₁₇₃ | 100 | 4.00 | 0.57 | 0.00 | 10.34% | 3.43 | 0.0005 | | |
| | driving | | | | | | | | | | |
| | Straight | L₁₇₅ | 108 | 4.07 | 0.54 | 0.00 | 17.16% | 3.53 | 0.0006 | | |
| | driving | | | | | | | | | | |
| | Right | L₁₇₄ | 16 | 3.25 | 0.70 | 0.00 | 9.78% | 2.55 | 0.0001 | | |
| | turning | | | | | | | | | | |
| West | Tapered | L₁₂₄ | 108 | 0.53 | 3.66 | 0.07 | 34.79% | 0.53 | 0.0001 | 0.0037 | |
| | section | | | | | | | | | | |
| | Tapered | L₁₂₅ | 56 | 0.49 | 3.23 | 0.14 | 39.20% | 0.49 | 0.0000 | | |
| | section | | | | | | | | | | |
| | Entrance | L₉ | 236 | 23.83 | 21.31 | 0.56 | 35.78% | 2.52 | 0.0009 | | |
| | lane | | | | | | | | | | |
| | Entrance | L₁₀ | 192 | 24.17 | 21.68 | 0.63 | 41.11% | 2.48 | 0.0007 | | |
| | lane | | | | | | | | | | |
| | Left | L₂₀₅ | 16 | 2.58 | 0.93 | 0.00 | 20.41% | 2.58 | 0.0001 | | |
| | turning | | | | | | | | | | |
| | Straight | L₂₀₆ | 220 | 3.25 | 0.38 | 0.00 | 8.18% | 3.25 | 0.0011 | | |
| | driving | | | | | | | | | | |
| | Straight | L₂₀₈ | 180 | 3.11 | 0.51 | 0.00 | 5.15% | 3.11 | 0.0008 | | |
| | driving | | | | | | | | | | |
| | Right | L₂₀₇ | 12 | 1.90 | 0.10 | 0.00 | 10.84% | 1.90 | 0.0000 | | |
| | turning | | | | | | | | | | |

In Table 3, the “tapered section”, the “entrance lane”, the “left turning”, the “straight driving”, and the “right turning” in the lane attributes represent a stretching-tapered section lane of an intersection, an entrance canalized lane of the intersection, and a left turn traffic through lane, a straight traffic through lane, and a right turn traffic through lane in a certain entrance direction in the intersection respectively.

TABLE 4
Traffic Weight Coefficients of Roads

| | Section/ | | | | | | |
|---|---|---|---|---|---|---|---|
| | inter- | | | | | | |
| Road | section | Lane | Vehicle | | | wₛ^{S}/ | |
| number | number | number | number | w_{(v, l)}^{V} | wₗ^{L} | wᵢ^{I} | wᵣ^{R} |
| R₁ | S₁ | L₁ | V₃₂₂ | 0.000054 | 0.021 | 0.021 | 0.197 |
| | | | V₃₂₃ | 0.000067 | | | |
| | | | V₁₈₈₅ | 0.000118 | | | |
| | | | V₁₈₉₂ | 0.000112 | | | |
| | | | . . . | . . . | | | |

| S₂ | L₄ | . . . | 0.015 | 0.015 |
|---|---|---|---|---|
| I₁ | . . . | | | 0.013 |
| S₃ | L₅ | . . . | 0.018 | 0.018 |
| S₄ | L₈ | . . . | 0.023 | 0.023 |
| I₂ | . . . | | | 0.012 |
| S₅ | L₁₁ | . . . | 0.021 | 0.021 |
| S₆ | L₁₄ | . . . | 0.027 | 0.027 |
| I₃ | . . . | | | 0.012 |
| S₇ | L₁₇ | . . . | 0.021 | 0.021 |
| S₈ | L₁₈ | . . . | 0.014 | 0.014 |

| | | |
|---|---|---|
| R₂ | . . . | 0.182 |
| R₃ | . . . | 0.158 |
| R₄ | . . . | 0.198 |
| R₅ | . . . | 0.182 |
| R₆ | . . . | 0.189 |

As shown in FIG. 3, according to the lane composition of the sub-zone Z₁, the traffic weight coefficients w₁^{Z} of the sub-zone Z₁ is obtained by using the traffic weight coefficients w_{(v,l)}^{V} of various passing vehicles Vᵥ on the different lanes Lₗ in Table 1, as follows:

$${w}_{1}^{Z} = {\sum }_{s ∈ {S}_{Z , 1}^{S}} {w}_{s}^{S} + {\sum }_{i ∈ {S}_{Z , 1}^{I}} {w}_{i}^{I} = {\sum }_{l ∈ {S}_{Z , 1}^{L}} {\sum }_{v ∈ {S}_{L , l}^{V}} {w}_{( v , l )}^{V} = 0.5274$$

For the whole road network, the traffic weight coefficients W^{A} of the road network can also be obtained by summing the traffic weight coefficients w_{(v,l)}^{V} of various passing vehicles Vᵥ on the different lanes Lₗ in the road network:

$${w}^{A} = {\sum }_{l = 1}^{{N}^{L}} {w}_{l}^{L} = {\sum }_{l ∈ {S}_{A}^{L}} {\sum }_{v ∈ {S}_{L , l}^{V}} {w}_{( v , l )}^{V} = {\sum }_{v = 1}^{{N}^{V}} {w}_{v}^{V} = 1$$

Step 3, reckoning traffic operation indexes of various lanes, various sub-sections, various sections, various intersections, various roads, various sub-zones, and the road network by using an average travel time, the free-flow driving times, and the traffic weight coefficients of the vehicles.

In the embodiment, the traffic operation indexes PI_{(v,l)}^{V} of various passing vehicles Vᵥ on the different lanes Lₗ are obtained by using the free-flow driving times t_{f(v,l)}^{V} and the travel times t_{(v,l)}^{V} of the vehicles Vᵥ on the lanes Lₗ in the road network. Further, in combination with the traffic weight coefficients w_{(v,l)}^{V} various passing vehicles Vᵥ on the different lanes Lₗ in Table 1, the traffic operation indexes PIᵥ^{V} of the vehicles Vᵥ are reckoned.

$${PI}_{( v , l )}^{V} = \frac{{t}_{( v , l )}^{V}}{{t}_{{f}_{( v , l )}}^{V}} ; {PI}_{v}^{V} = \frac{\sum l ∈ {S}_{V , v}^{L} ( {PI}_{( v , l )}^{V} \times {w}_{( v , l )}^{V} )}{{\sum }_{l ∈ {S}_{V , v}^{L}} {w}_{( v , l )}^{V}}$$

Taking the vehicles V₄₆ and V₄₇ as examples, calculation results of PI_{(v,l)}^{V} and PIᵥ^{V} are shown in Table 5.

TABLE 5
Traffic Operation States of Vehicles

| Vehicle | Lane | | | | | | | | | Operation |
|---|---|---|---|---|---|---|---|---|---|---|
| number | number | t_{(v, l)}^{V}/s | d_{(v, l)}^{V}/s | h_{(v, l)}^{V}/time | m_{(v, l)}^{V} | PI_{(v, l)}^{V} | DI_{(v, l)}^{V} | HI_{(v, l)}^{V}/(times/min) | MI_{(v, l)}^{V}/(m/min) | condition |
| . . . | . . . | . . . | . . . | . . . | . . . | . . . | . . . | . . . | . . . | . . . |
| V₄₆ | L₄ | 35 | 0.0 | 0 | 0.00% | 1.00 | 0.00 | 0.00 | 0.00 | PI₄₆^{V} = 1.68 |
| | L₅ | 38 | 0.2 | 0 | 0.47% | 1.01 | 0.01 | 0.00 | 3.89 | DI₄₆^{V} = 0.68 |
| | L₇ | 41 | 38.6 | 1 | 63.55% | 17.08 | 16.08 | 25.00 | 544.17 | HI₄₆^{V} = 1.08 |
| | L₁₁ | 27 | 0.0 | 0 | 0.00% | 1.00 | 0.00 | 0.00 | 0.00 | MI₄₆^{V} = 32.91 |
| | L₁₃ | 37 | 34.6 | 1 | 54.28% | 15.42 | 14.42 | 25.00 | 493.22 | |
| | L₁₂₃ | 1 | 0.3 | 0 | 30.00% | 1.43 | 0.43 | 0.00 | 272.06 | |
| | L₂₀₀ | 4 | 0.8 | 0 | 16.60% | 1.25 | 0.25 | 0.00 | 126.30 | |
| | L₂₁₄ | 4 | 0.9 | 0 | 18.65% | 1.29 | 0.29 | 0.00 | 142.34 | |
| V₄₇ | L₂₁ | 39 | 0.0 | 0 | 0.00% | 1.00 | 0.00 | 0.00 | 0.00 | PI₄₇^{V} = 2.09 |
| | L₂₅ | 1 | 0.0 | 0 | 0.00% | 1.00 | 0.00 | 0.00 | 0.00 | DI₄₇^{V} = 1.09 |
| | L₂₆ | 52 | 49.3 | 1 | 40.00% | 19.26 | 18.26 | 22.22 | 335.71 | HI₄₇^{V} = 1.29 |
| | L₂₇₆ | 5 | 1.2 | 0 | 18.38% | 1.32 | 0.32 | 0.00 | 126.76 | MI₄₇^{V} = 29.85 |
| . . . | . . . | . . . | . . . | . . . | . . . | . . . | . . . | . . . | . . . | . . . |

In Table 5, HIᵥ^{V} is in a unit of “times/min”, and MI_{c}^{V} is in a unit of “m/min”.

Based on the acquired traffic operation indexes PI_{(v,l)}^{V} of the vehicles Vᵥ on the lanes Lₗ, in combination with the traffic weight coefficients w_{(v,l)}^{V}, acquired in step 1, of various passing vehicles Vᵥ on different lanes Lₗ in the road network, the traffic operation indexes PIₗ^{L} of various lanes in the road network are calculated:

$${PI}_{l}^{L} = \frac{{\sum }_{v ∈ {S}_{L , l}^{V}} ( {PI}_{( v , l )}^{V} \times {w}_{( v , l )}^{V} )}{{\sum }_{v ∈ {S}_{L , l}^{V}} {w}_{( v , l )}^{V}}$$

Calculation results are shown in Table 6.

TABLE 6
Traffic Operation States of Lanes

| Lane | | | HIₗ^{L}/ | MIₗ^{L}/ | V̅_{f l}^{L}/ | | | | |
|---|---|---|---|---|---|---|---|---|---|
| number | PIₗ^{L} | DIₗ^{L} | (times/min) | (m/min) | (m/s) | t_{f l}^{L}/s | d̅ₗ^{L}/s | h̅ₗ^{L}/time | mₗ^{L} |
| L₁ | 1.04 | 0.04 | 0.03 | 21.69 | 13.54 | 32.27 | 1.40 | 0.02 | 2.67% |
| L₂ | 9.81 | 8.81 | 15.28 | 288.87 | 13.40 | 2.42 | 21.35 | 0.62 | 35.92% |
| L₃ | 12.74 | 11.74 | 16.73 | 340.75 | 13.36 | 2.45 | 28.83 | 0.68 | 42.52% |
| L₄ | 1.00 | 0.00 | 0.00 | 2.22 | 14.01 | 31.91 | 0.09 | 0.00 | 0.26% |
| L₅ | 1.03 | 0.03 | 0.00 | 21.41 | 13.53 | 38.07 | 1.25 | 0.00 | 2.64% |
| L₆ | 2.39 | 1.39 | 3.07 | 67.62 | 13.42 | 2.67 | 3.70 | 0.14 | 8.40% |
| L₇ | 11.99 | 10.99 | 18.64 | 351.95 | 14.26 | 2.63 | 28.87 | 0.82 | 41.15% |
| L₈ | 1.13 | 0.13 | 0.12 | 47.57 | 13.51 | 38.51 | 4.84 | 0.08 | 5.87% |
| L₉ | 9.47 | 8.47 | 13.33 | 282.27 | 13.15 | 2.52 | 21.31 | 0.56 | 35.78% |
| L₁₀ | 9.73 | 8.73 | 15.10 | 331.45 | 13.44 | 2.48 | 21.68 | 0.63 | 41.11% |
| . . . | . . . | . . . | . . . | . . . | . . . | . . . | . . . | . . . | . . . |
| Total | 1.62 | 0.62 | 0.83 | 46.53 | 13.72 | 128.02 | 79.68 | 1.77 | 5.65% |

Further, according to the acquired traffic operation indexes PIₗ^{L} T of the lanes, in combination with the traffic weight coefficients, obtained in step 2, of various lanes, various intersections, and various roads, the traffic operation indexes of various intersections and various roads in the road network are calculated:

$${PI}_{i}^{I} = \frac{{\sum }_{l ∈ {S}_{I , i}^{L}} ( {PI}_{l}^{L} \times {w}_{l}^{L} )}{{\sum }_{l ∈ {S}_{I , i}^{L}} {w}_{l}^{L}} ; {PI}_{r}^{R} = \frac{{\sum }_{l ∈ {S}_{R , r}^{L}} ( {PI}_{l}^{L} \times {w}_{l}^{L} )}{{\sum }_{l ∈ {S}_{R , r}^{L}} {w}_{l}^{L}}$$

In the embodiment, taking the intersection I₂ as an example, calculation results of the traffic operation indexes P₂¹, of the intersection I₂ are shown in Table 7; and calculation results of the traffic operation indexes PIᵣ^{R} of various roads in the road network are shown in Table 8.

TABLE 7
Traffic Operation States of Intersection I₂

| Entrance | Lane | Lane | | | | | | | Various | Whole |
|---|---|---|---|---|---|---|---|---|---|---|
| direction | attribute | number | PIₗ^{L} | DIₗ^{L} | HIₗ^{L}/(times/min) | MIₗ^{L}/(m/min) | V̅_{f l}^{L}/(m/s) | t_{f l}^{L}/s | entrances | intersection |
| North | Tapered | L₂₆₁ | 1.40 | 0.40 | 0.00 | 206.58 | 14.59 | 0.72 | PI = 5.51 | PI₂^{I} = 5.15 |
| | section | | | | | | | | DI = 4.51 | DI₂^{I} = 4.15 |
| | Tapered | L₂₆₂ | 4.43 | 3.43 | 9.16 | 383.99 | 15.36 | 0.52 | HI = 8.42 | HI₂^{I} = 7.43 |
| | section | | | | | | | | MI = 204.01 | MI₂^{I} = 192.40 |
| | Entrance | L₈₂ | 12.82 | 11.82 | 22.90 | 395.55 | 13.84 | 2.10 | d̅ = 25.35 | t_{f} = 5.86 |
| | lane | | | | | | | | h̅ = 0.79 | V̅_{f} = 13.23 |
| | Entrance | L₈₃ | 11.69 | 10.69 | 19.83 | 349.30 | 13.57 | 2.24 | m = 25.50% | d̅ = 24.30 |
| | lane | | | | | | | | | h̅ = 0.73 |
| | Left | L₂₂₇ | 1.21 | 0.21 | 0.00 | 108.26 | 12.39 | 2.90 | | m = 24.23% |
| | turning | | | | | | | | | |
| | Straight | L₂₁₈ | 1.17 | 0.17 | 0.00 | 84.25 | 12.79 | 3.41 | | |
| | driving | | | | | | | | | |
| | Straight | L₂₂₀ | 1.15 | 0.15 | 0.00 | 77.69 | 13.16 | 3.41 | | |
| | driving | | | | | | | | | |
| | Right | L₂₁₉ | 1.26 | 0.26 | 0.00 | 127.49 | 12.52 | 1.85 | | |
| | turning | | | | | | | | | |
| East | Tapered | L₁₂₆ | 1.32 | 0.32 | 0.00 | 135.52 | 13.78 | 0.79 | PI = 5.16 | |
| | section | | | | | | | | DI = 4.16 | |
| | Tapered | L₁₂₇ | 4.49 | 3.49 | 8.82 | 243.44 | 14.28 | 0.65 | HI = 7.62 | |
| | section | | | | | | | | MI = 202.46 | |
| | Entrance | L₁₂ | 10.56 | 9.56 | 16.62 | 328.03 | 13.75 | 2.71 | d̅ = 25.16 | |
| | lane | | | | | | | | h̅ = 0.77 | |
| | Entrance | L₁₃ | 9.24 | 8.24 | 16.45 | 326.78 | 13.88 | 2.66 | m = 25.47% | |
| | lane | | | | | | | | | |
| | Left | L₂₁₃ | 1.11 | 0.11 | 0.00 | 60.96 | 13.42 | 2.25 | | |
| | turning | | | | | | | | | |
| | Straight | L₂₁₄ | 1.19 | 0.19 | 0.00 | 92.71 | 12.90 | 3.04 | | |
| | driving | | | | | | | | | |
| | Straight | L₂₁₆ | 1.19 | 0.19 | 0.00 | 90.59 | 12.36 | 3.09 | | |
| | driving | | | | | | | | | |
| | Right | L₂₁₅ | 1.19 | 0.19 | 0.00 | 104.44 | 11.83 | 2.23 | | |
| | turning | | | | | | | | | |
| South | Tapered | L₁₇₀ | 1.25 | 0.25 | 0.00 | 139.49 | 13.74 | 0.80 | PI = 4.80 | |
| | section | | | | | | | | DI = 3.80 | |
| | Tapered | L₁₇₁ | 1.26 | 0.26 | 0.00 | 152.38 | 14.53 | 0.79 | HI = 7.28 | |
| | section | | | | | | | | MI = 180.95 | |
| | Entrance | L₈₆ | 11.05 | 10.05 | 20.99 | 341.04 | 13.92 | 2.33 | d̅ = 23.24 | |
| | lane | | | | | | | | h̅ = 0.74 | |
| | Entrance | L₈₇ | 10.18 | 9.18 | 17.07 | 322.86 | 13.90 | 2.38 | m = 22.76% | |
| | lane | | | | | | | | | |
| | Left | L₁₇₂ | 1.23 | 0.23 | 0.00 | 110.92 | 12.49 | 2.85 | | |
| | turning | | | | | | | | | |
| | Straight | L₁₇₃ | 1.17 | 0.17 | 0.00 | 77.99 | 12.57 | 3.43 | | |
| | driving | | | | | | | | | |
| | Straight | L₁₇₅ | 1.15 | 0.15 | 0.00 | 75.63 | 12.89 | 3.53 | | |
| | driving | | | | | | | | | |
| | Right | L₁₇₄ | 1.27 | 0.27 | 0.00 | 124.32 | 12.08 | 2.55 | | |
| | turning | | | | | | | | | |
| West | Tapered | L₁₂₄ | 7.90 | 6.90 | 8.39 | 282.64 | 13.54 | 0.53 | PI = 4.99 | |
| | section | | | | | | | | DI = 3.99 | |
| | Tapered | L₁₂₅ | 7.65 | 6.65 | 17.65 | 347.13 | 14.76 | 0.49 | HI = 6.45 | |
| | section | | | | | | | | MI = 180.92 | |
| | Entrance | L₉ | 9.47 | 8.47 | 13.33 | 282.27 | 13.15 | 2.52 | d̅ = 23.27 | |
| | lane | | | | | | | | h̅ = 0.63 | |
| | Entrance | L₁₀ | 9.73 | 8.73 | 15.10 | 331.45 | 13.44 | 2.48 | m = 22.98% | |
| | lane | | | | | | | | | |
| | Left | L₂₀₅ | 1.36 | 0.36 | 0.00 | 153.98 | 12.58 | 2.58 | | |
| | turning | | | | | | | | | |
| | Straight | L₂₀₆ | 1.12 | 0.12 | 0.00 | 63.45 | 12.92 | 3.25 | | |
| | driving | | | | | | | | | |
| | Straight | L₂₀₈ | 1.17 | 0.17 | 0.00 | 84.73 | 13.02 | 3.11 | | |
| | driving | | | | | | | | | |
| | Right | L₂₀₇ | 1.05 | 0.05 | 0.00 | 38.01 | 12.30 | 1.90 | | |
| | turning | | | | | | | | | |

TABLE 8
Calculation Results of Traffic Operation States of Roads

| Road | | | | | | | | | | |
|---|---|---|---|---|---|---|---|---|---|---|
| number | Number | w | PI | DI | HI/(times/min) | MI/(m/min) | PIᵣ^{R} | DIᵣ^{R} | HIᵣ^{R}/(times/min) | MIᵣ^{R}/(m/min) |
| R₁ | s S_{R, 1}^{S}^{_{—}} | 0.160 | 1.05 | 0.05 | 0.04 | 26.38 | 1.90 | 0.90 | 1.39 | 56.67 |
| | I₁ | 0.013 | 5.57 | 4.57 | 7.08 | 182.38 | | | | |
| | I₂ | 0.012 | 5.15 | 4.15 | 7.43 | 192.40 | | | | |
| | I₃ | 0.012 | 6.19 | 5.19 | 7.63 | 195.87 | | | | |
| R₂ | s S_{R, 2}^{S}^{_{—}} | 0.146 | 1.09 | 0.09 | 0.08 | 31.81 | 2.09 | 1.09 | 1.44 | 62.24 |
| | I₄ | 0.013 | 4.97 | 3.97 | 6.77 | 176.75 | | | | |
| | I₅ | 0.012 | 6.21 | 5.21 | 6.43 | 180.54 | | | | |
| | I₆ | 0.011 | 7.45 | 6.45 | 7.71 | 201.07 | | | | |
| R₃ | s S_{R, 3}^{S}^{_{—}} | 0.125 | 1.09 | 0.09 | 0.10 | 33.64 | 2.27 | 1.27 | 1.47 | 63.29 |
| | I₇ | 0.011 | 6.49 | 5.49 | 7.00 | 181.83 | | | | |
| | I₈ | 0.011 | 6.99 | 5.99 | 5.88 | 160.93 | | | | |
| | I₉ | 0.011 | 6.82 | 5.82 | 7.08 | 185.10 | | | | |
| R₄ | s S_{R, 4}^{S}^{_{—}} | 0.161 | 1.10 | 0.10 | 0.14 | 30.43 | 1.95 | 0.95 | 1.41 | 58.40 |
| | I₁ | 0.013 | 5.57 | 4.57 | 7.08 | 182.38 | | | | |
| | I₄ | 0.013 | 4.97 | 3.97 | 6.77 | 176.75 | | | | |
| | I₇ | 0.011 | 6.49 | 5.49 | 7.00 | 181.83 | | | | |
| R₅ | s S_{R, 5}^{S}^{_{—}} | 0.148 | 1.10 | 0.10 | 0.14 | 29.93 | 2.04 | 1.04 | 1.36 | 57.93 |
| | I₂ | 0.012 | 5.15 | 4.15 | 7.43 | 192.40 | | | | |
| | I₅ | 0.012 | 6.21 | 5.21 | 6.43 | 180.54 | | | | |
| | I₈ | 0.011 | 6.99 | 5.99 | 5.88 | 160.93 | | | | |
| R₆ | s S_{R, 6}^{S}^{_{—}} | 0.155 | 1.10 | 0.10 | 0.12 | 30.75 | 2.12 | 1.12 | 1.45 | 60.10 |
| | I₃ | 0.012 | 6.19 | 5.19 | 7.63 | 195.87 | | | | |
| | I₆ | 0.011 | 7.45 | 6.45 | 7.71 | 201.07 | | | | |
| | I₉ | 0.011 | 6.82 | 5.82 | 7.08 | 185.10 | | | | |

Taking the sub-zone Z₁ as an example, the traffic operation indexes PI₁^{Z} of the sub-zone Z₁ are obtained by using the acquired traffic weight coefficients wₗ^{L} and the traffic operation indexes PIₗ^{L} of various lanes in the road network:

$${PI}_{1}^{Z} = \frac{{\sum }_{l ∈ {S}_{Z , z}^{L}} ( {PI}_{l}^{L} \times {w}_{l}^{L} )}{{\sum }_{l ∈ {S}_{Z , z}^{L}} {w}_{l}^{L}} = 1.51$$

For the whole road network, the traffic operation indexes PI^{A} of the road network can also be calculated by using the acquired traffic weight coefficients w and traffic operation indexes PIₗ^{L} of various lanes in the road network. Calculation results are shown in Table 6.

$${PI}^{A} = {\sum }_{l ∈ {S}_{A}^{L}} ( {PI}_{l}^{L} \times {w}_{l}^{L} ) = 1.62$$

Step 4, reckoning delay time indexes of various lanes, various sub-sections, various sections, various intersections, various roads, various sub-zones, and the road network by using an average delay time, the free-flow driving times, and the traffic weight coefficients of the vehicles, and calculating average delay times of various evaluation objects at the different spatial scales in combination with the free-flow driving times of the vehicles.

In the embodiment, the delay time indexes DI (v,l) of various passing vehicles Vᵥ on the different lanes Lₗ are obtained by using the free-flow driving times t_{f(v,l)}^{V} and the delay times d_{(v,l)}^{V} of the vehicles Vᵥ on the lanes Lₗ in the road network. Further, in combination with the traffic weight coefficients w_{(v,l)}^{V} of various passing vehicles Vᵥ on the different lanes Lₗ in Table 1, the delay time indexes DIᵥ^{V} of the vehicles Vᵥ are reckoned.

$${DI}_{( v , l )}^{V} = \frac{{d}_{( v , l )}^{V}}{{t}_{{f}_{( v , l )}}^{V}} ; {DI}_{v}^{V} = \frac{{\sum }_{l ∈ {S}_{V , v}^{L}} ( {DI}_{( v , l )}^{V} \times {w}_{( v , l )}^{V} )}{{\sum }_{l ∈ {S}_{V , v}^{L}} {w}_{( v , l )}^{V}}$$

Taking the vehicles V₄₆ and V₄₇ as examples, calculation results of DI_{(v,l)}^{V} and DIᵥ^{V} are shown in Table 5.

Based on the acquired delay time indexes DI_{(v,l)}^{V} of the vehicles Vᵥ on the lanes Lₗ, in combination with the traffic weight coefficients w_{(v,l)}^{V}, acquired in step 1, of various passing vehicles Vᵥ on different lanes Lₗ in the road network, the delay time indexes DIₗ^{L} of various lanes in the road network are calculated:

$${DI}_{l}^{L} = \frac{{\sum }_{v ∈ {S}_{L , l}^{V}} ( {DI}_{( v , l )}^{V} \times {w}_{( v , l )}^{V} )}{{\sum }_{v ∈ {S}_{L , l}^{V}} {w}_{( v , l )}^{V}}$$

Calculation results are shown in Table 6.

Further, according to the acquired delay time indexes DIₗ^{L} of the lanes, in combination with the traffic weight coefficients, obtained in step 2, of various lanes, various intersections, and various roads, the delay time indexes of various intersections and various roads in the road network are calculated:

$${DI}_{i}^{I} = \frac{{\sum }_{l ∈ {S}_{I , i}^{L}} ( {DI}_{l}^{L} \times {w}_{l}^{L} )}{{\sum }_{l ∈ {S}_{I , i}^{L}} {w}_{l}^{L}} ; {DI}_{r}^{R} = \frac{{\sum }_{l ∈ {S}_{R , r}^{L}} ( {DI}_{l}^{L} \times {w}_{l}^{L} )}{{\sum }_{l ∈ {S}_{R , r}^{L}} {w}_{l}^{L}}$$

In the embodiment, taking the intersection I₂ as an example, calculation results of the delay time indexes DI₂¹ of the intersection I₂ are shown in Table 7; and calculation results of the delay time indexes DIᵣ^{R} of various roads in the road network are shown in Table 8.

Taking the sub-zone Z₁ as an example, the delay time indexes DI₁^{Z} of the sub-zone Z₁ are obtained by using the acquired traffic weight coefficients wₗ^{L} and delay time indexes DIₗ^{L} of various lanes in the road network:

$${DI}_{1}^{Z} = \frac{{\sum }_{l ∈ {S}_{Z , z}^{L}} ( {DI}_{l}^{L} \times {w}_{l}^{L} )}{{\sum }_{l ∈ {S}_{Z , z}^{L}} {w}_{l}^{L}} = 0.51$$

For the whole road network, the delay time indexes DI^{A} of the road network can also be calculated by using the acquired traffic weight coefficients wₗ^{L} and delay time indexes DIₗ^{L} of various lanes in the road network. Calculation results are shown in Table 6.

$${DI}^{A} = {\sum }_{l ∈ {S}_{A}^{L}} ( {DI}_{l}^{L} \times {w}_{l}^{L} ) = 0.62$$

Further, by calculating products of the delay time indexes of various lanes, various sections, various intersections, and various roads in the road network and the road network, and corresponding average free-flow driving times, the average delay times of various evaluation objects can be obtained, as shown in Table 6, Table 7, and Table 9. The average delay times calculated by using the delay time indexes of various evaluation objects are consistent with results actually calculated by a definition of an average delay time.

TABLE 9
Traffic Operation State Characteristic Indexes of Roads

| Road | | | | | | | | | | | |
|---|---|---|---|---|---|---|---|---|---|---|---|
| number | Number | t_{f}/s | V̅_{f}/(m/s) | d̅/s | h̅/time | m | t_{f r}^{R}/s | V̅_{f r}^{R}/(m/s) | d̅ᵣ^{R}/s | h̅ᵣ^{R}/time | mᵣ^{R} |
| R₁ | s S_{R, 1}^{S}^{_{—}} | 103.84 | 13.59 | 5.62 | 0.06 | 3.23% | 42.31 | 13.54 | 38.18 | 0.98 | 6.98% |
| | I₁ | 5.70 | 13.34 | 26.05 | 0.67 | 22.79% | | | | | |
| | I₂ | 5.81 | 13.23 | 24.09 | 0.72 | 24.23% | | | | | |
| | I₃ | 5.93 | 13.28 | 30.79 | 0.75 | 24.59% | | | | | |
| R₂ | s S_{R, 2}^{S}^{_{—}} | 94.44 | 13.74 | 8.31 | 0.13 | 3.86% | 39.10 | 13.65 | 42.49 | 0.94 | 7.60% |
| | I₄ | 6.46 | 13.34 | 25.65 | 0.73 | 22.09% | | | | | |
| | I₅ | 5.78 | 13.26 | 30.12 | 0.62 | 22.70% | | | | | |
| | I₆ | 5.64 | 13.34 | 36.34 | 0.72 | 25.12% | | | | | |
| R₃ | s S_{R, 3}^{S}^{_{—}} | 80.78 | 13.64 | 7.37 | 0.13 | 4.11% | 33.89 | 13.57 | 43.19 | 0.83 | 7.78% |
| | I₇ | 5.70 | 13.32 | 31.26 | 0.66 | 22.74% | | | | | |
| | I₈ | 6.03 | 13.19 | 36.16 | 0.59 | 20.33% | | | | | |
| | I₉ | 5.85 | 13.32 | 34.00 | 0.69 | 23.16% | | | | | |
| R₄ | s S_{R, 4}^{S}^{_{—}} | 104.05 | 13.95 | 10.53 | 0.24 | 3.64% | 42.49 | 13.83 | 40.22 | 1.00 | 7.04% |
| | I₁ | 5.70 | 13.34 | 26.05 | 0.67 | 22.79% | | | | | |
| | I₄ | 6.46 | 13.34 | 25.65 | 0.73 | 22.09% | | | | | |
| | I₇ | 5.70 | 13.32 | 31.26 | 0.66 | 22.74% | | | | | |
| R₅ | s S_{R, 5}^{S}^{_{—}} | 95.80 | 13.71 | 9.43 | 0.23 | 3.64% | 39.21 | 13.62 | 40.86 | 0.89 | 7.09% |
| | I₂ | 5.81 | 13.23 | 24.09 | 0.72 | 24.23% | | | | | |
| | I₅ | 5.78 | 13.26 | 30.12 | 0.62 | 22.70% | | | | | |
| | I₈ | 6.03 | 13.19 | 36.16 | 0.59 | 20.33% | | | | | |
| R₆ | s S_{R, 6}^{S}^{_{—}} | 100.35 | 13.94 | 10.02 | 0.21 | 3.68% | 40.62 | 13.83 | 45.66 | 0.98 | 7.24% |
| | I₃ | 5.93 | 13.28 | 30.79 | 0.75 | 24.59% | | | | | |
| | I₆ | 5.64 | 13.34 | 36.34 | 0.72 | 25.12% | | | | | |
| | I₉ | 5.85 | 13.32 | 34.00 | 0.69 | 23.16% | | | | | |

Step 5, reckoning indexes of the numbers of times of stopping of various lanes, various sub-sections, various sections, various intersections, various roads, various sub-zones, and the road network by using an average number of times of stopping, the free-flow driving times, and the traffic weight coefficients of the vehicles, and calculating average numbers of times of stopping of various evaluation objects at the different spatial scales in combination with the free-flow driving times of the vehicles.

In the embodiment, the indexes of the numbers of times of stopping HI_{(v,l)}^{V} of various passing vehicles Vᵥ on the different lanes Lₗ are obtained by using the free-flow driving times t_{f(v,l)}^{V} and the numbers of times of stopping h_{(v,l)}^{V} of the vehicles Vᵥ on the lanes Lₗ in the road network. Further, in combination with the traffic weight coefficients w_{(v,l)}^{V} of various passing vehicles Vᵥ on the different lanes Lₗ in Table 1, the indexes of the numbers of times of stopping HIᵥ^{V} of the vehicles Vᵥ are reckoned.

$${HI}_{( v , l )}^{V} = \frac{{h}_{( v , l )}^{V}}{{t}_{{f}_{( v , l )}}^{V}} ; {HI}_{v}^{V} = \frac{{\sum }_{l ∈ {S}_{V , v}^{L}} ( {HI}_{( v , l )}^{V} \times {w}_{( v , l )}^{V} )}{{\sum }_{l ∈ {S}_{V , v}^{L}} {w}_{( v , l )}^{V}}$$

Taking the vehicles V₄₆ and V₄₇ as examples, calculation results of HI_{(v,l)}^{V} and HIᵥ^{V} are shown in Table 5.

Based on the acquired indexes of the numbers of times of stopping HI_{(v,l)}^{V} of the vehicles Vᵥ on the lanes Lₗ in combination with the traffic weight coefficients w_{(v,l)}^{V}, acquired in step 1, of various passing vehicles Vᵥ on different lanes Lₗ in the road network, the indexes of the numbers of times of stopping HIT of various lanes in the road network are calculated:

$${HI}_{l}^{L} = \frac{{\sum }_{v ∈ {S}_{L , l}^{V}} ( {HI}_{( v , l )}^{V} \times {w}_{( v , l )}^{V} )}{{\sum }_{v ∈ {S}_{L , l}^{V}} {w}_{( v , l )}^{V}}$$

Calculation results are shown in Table 6.

Further, according to the acquired indexes of the numbers of times of stopping HIₗ^{L} of the lanes, in combination with the traffic weight coefficients, obtained in step 2, of various lanes, various intersections, and various roads, the indexes of the numbers of times of stopping of various intersections and various roads in the road network are calculated:

$${HI}_{i}^{I} = \frac{{\sum }_{l ∈ {S}_{I , i}^{L}} ( {HI}_{l}^{L} \times {w}_{l}^{L} )}{{\sum }_{l ∈ {S}_{I , i}^{L}} {w}_{l}^{L}} ; {HI}_{r}^{R} = \frac{{\sum }_{l ∈ {S}_{R , r}^{L}} ( {HI}_{l}^{L} \times {w}_{l}^{L} )}{{\sum }_{l ∈ {S}_{R , r}^{L}} {w}_{l}^{L}}$$

In the embodiment, taking the intersection I₂ as an example, calculation results of the indexes of the numbers of times of stopping HI₂¹ of the intersection I₂ are shown in Table 7; and calculation results of the indexes of the numbers of times of stopping HIᵣ^{R} of various roads in the road network are shown in Table 8.

Taking the sub-zone Z₁ as an example, the indexes of the numbers of times of stopping HI₁^{Z} of the sub-zone Z are obtained by using the acquired traffic weight coefficients wₗ^{L} and indexes of the numbers of times of stopping HIₗ^{L} of various lanes in the road network:

$${HI}_{i}^{Z} = \frac{{\sum }_{l ∈ {S}_{Z , z}^{L}} ( {HI}_{l}^{L} \times {w}_{l}^{L} )}{{\sum }_{l ∈ {S}_{Z , z}^{L}} {w}_{l}^{L}} = 0.75 times / min$$

For the whole road network, the indexes of the numbers of times of stopping HI^{A} of the road network can also be calculated by using the acquired traffic weight coefficients wₗ^{L} and indexes of the numbers of times of stopping HIₗ^{L} of various lanes in the road network. Calculation results are shown in Table 6.

$${HI}^{A} = {\sum }_{l ∈ {S}_{A}^{L}} ( {HI}_{l}^{L} \times {w}_{l}^{L} ) = 0.83 times / min$$

Further, by calculating products of the indexes of the numbers of times of stopping of various lanes, various sections, various intersections, and various roads in the road network and the road network, and corresponding average free-flow driving times, the average numbers of times of stopping of various evaluation objects can be obtained, as shown in Table 6, Table 7, and Table 9. The average numbers of times of stopping calculated by using the indexes of the numbers of times of stopping of various evaluation objects are consistent with results actually calculated by a definition of the average number of times of stopping.
Step 6, reckoning indexes of mileages of congested roads of various lanes, various sub-sections, various sections, various intersections, various roads, various sub-zones, and the road network by using mileages of heavily congested roads, the free-flow driving times, and the traffic weight coefficients of the vehicles, and calculating proportions of the mileages of the heavily congested roads of various evaluation objects at the different spatial scales in combination with free-flow driving speeds of the vehicles.

In the embodiment, the indexes of the mileages of the congested roads MI_{(v,l)}^{V} of various passing vehicles Vᵥ on the different lanes Lₗ are obtained by using the free-flow driving times t_{f(v,l)}^{V} and overall mileages of the congested roads l_{c(v,l)}^{V} of the vehicles Vᵥ on the lanes Lₗ in the road network. Further, in combination with the traffic weight coefficients w_{(v,l)}^{V} of various passing vehicles Vᵥ on the different lanes Lₗ in Table 1, the indexes of the mileages of the congested roads MIᵥ^{V} of the vehicles Vᵥ are reckoned.

$${MI}_{( v , l )}^{V} = \frac{{l}_{c ( v , l )}^{V}}{{t}_{{f}_{( v , l )}}^{V}} ; {MI}_{v}^{V} = \frac{{\sum }_{l ∈ {S}_{V , v}^{L}} ( {MI}_{( v , l )}^{L} \times {w}_{( v , l )}^{V} )}{{\sum }_{l ∈ {S}_{V , v}^{L}} {w}_{( v , l )}^{V}}$$

Taking the vehicles V₄₆ and V₄₇ as examples, calculation results of MI_{(v,l)}^{V} and MIᵥ^{V} are shown in Table 5.

Based on the acquired indexes of the mileages of the congested roads MI_{(v,l)}^{V} of the vehicles Vᵥ on the lanes Lₗ, in combination with the traffic weight coefficients w_{(v,l)}^{V}, acquired in step 1, of various passing vehicles Vᵥ on different lanes Lₗ in the road network, the indexes of the mileages of the congested roads MIₗ^{L} of various lanes in the road network are calculated:

$${MI}_{l}^{L} = \frac{{\sum }_{v ∈ {S}_{L , l}^{V}} ( {MI}_{( v , l )}^{V} \times {w}_{( v , l )}^{V} )}{{\sum }_{v ∈ {S}_{L , l}^{V}} {w}_{( v , l )}^{V}}$$

Calculation results are shown in Table 6.

Further, according to the acquired indexes of the mileages of the congested roads MIₗ^{L} of the lanes, in combination with the traffic weight coefficients, obtained in step 2, of various lanes, various intersections, and various roads, the indexes of the mileages of the congested roads of various intersections and various roads in the road network are calculated:

$${MI}_{i}^{I} = \frac{{\sum }_{l ∈ {S}_{I , i}^{L}} ( {MI}_{l}^{L} \times {w}_{l}^{L} )}{{\sum }_{l ∈ {S}_{I , i}^{L}} {w}_{l}^{L}} ; {MI}_{r}^{R} = \frac{{\sum }_{l ∈ {S}_{R , r}^{L}} ( {MI}_{l}^{L} \times {w}_{l}^{L} )}{{\sum }_{l ∈ {S}_{R , r}^{L}} {w}_{l}^{L}}$$

In the embodiment, taking the intersection I₂ as an example, calculation results of the indexes of the mileages of the congested roads MI₂¹ of the intersection I₂ are shown in Table 7; and calculation results of the indexes of the mileages of the congested roads MIᵣ^{R} of various roads in the road network are shown in Table 8.

Taking the sub-zone Z₁ as an example, the indexes of the mileages of the congested roads MI₁^{Z} of the sub-zone Z₁ are obtained by using the acquired traffic weight coefficients wₗ^{L} and the indexes of the mileages of the congested roads MIₗ^{L} of various lanes in the road network:

$${MI}_{1}^{Z} = \frac{{\sum }_{l ∈ {S}_{Z , z}^{L}} ( {MI}_{l}^{L} \times {w}_{l}^{L} )}{{\sum }_{l ∈ {S}_{Z , z}^{L}} {w}_{l}^{L}} = 46.62 m / min$$

For the whole road network, the indexes of the mileages of the congested roads MI^{A} of the road network can also be calculated by using the acquired traffic weight coefficients wₗ^{L} and indexes of the mileages of the congested roads MIₗ^{L} of various lanes in the road network. Calculation results are shown in Table 6.

$${MI}^{A} = {\sum }_{l ∈ {S}_{A}^{L}} ( {MI}_{l}^{L} \times {w}_{l}^{L} ) = 46.53 m / min$$

Further, by calculating products of the indexes of the mileages of the congested roads of various lanes, various sections, various intersections, and various roads in the road network and the road network, and corresponding average free-flow driving speeds, the proportions of the mileages of the heavily congested roads of various evaluation objects can be obtained, as shown in Table 6, Table 7, and Table 9. The proportions of the mileages of the heavily congested roads calculated by using the indexes of the mileages of the congested roads of various evaluation objects are consistent with results actually calculated by a definition of the proportion of the mileage of the heavily congested road.

It should be noted that the evaluation indexes used in the specific embodiments of the present invention are the traffic operation index, the delay time index, the index of the number of times of stopping, and the index of the mileage of the congested road, which collectively constitute a new method for calculating a characteristic index system for traffic operation state evaluation. The larger the traffic operation index, the delay time index, the index of the number of times of stopping, and the index of the mileage of the congested road are, the worse the traffic operation state is, that is, the more congested the road traffic is.

The above embodiments are preferred implementations of the present invention, which are not limited by the above embodiments. Other changes, modifications, replacements, combinations, and simplification made without departing from the spirit and the principle of the present invention should all be equivalent permutations, and fall within the scope of protection of the present invention.

1. A digital road network traffic state reckoning method based on multi-scale calculation, comprising the following steps:
S1, acquiring traffic weight coefficients of vehicles according to free-flow driving times of the vehicles and an overall free-flow driving time of a road network, wherein the traffic weight coefficient of each vehicle is a ratio of the overall free-flow driving time of a certain passing vehicle in the road network to the overall free-flow driving time of all vehicles in the road network, which is obtained by summing the traffic weight coefficients of the vehicle on various through lanes in the road network, and reflects a proportion of the certain passing vehicle occupying an overall road time-space resource of the road network; and a formula of traffic weight coefficient is as follows:
$$\begin{matrix}{w}_{v}^{V} = \frac{\text{?}}{\text{?}} = \frac{\text{?}}{\text{?}} = \frac{\text{?}}{\text{?}} = \sum \text{?} \frac{\text{?}}{\text{?}} = \\ {\sum }_{l ∈ {S}_{V , v}^{L}} {w}_{( n , l )}^{V} \text{?} \frac{\text{?}}{\text{?}} = \frac{\text{?}}{\text{?}} = \frac{\text{?}}{\text{?}} = \frac{\text{?}}{\text{?}} = \text{?} \text{?} \text{?} \text{?}\end{matrix}$$
$$\text{?} \text{indicates text missing or illegible when filed}$$
wherein, wᵥ^{V} is a traffic weight coefficient of the v^{th} vehicle Vᵥ, in the raid network; t_{fv}^{V} is an overall free-flow driving time of the vehicle Vᵥ passing the road network; N^{V} is the number of vehicles passing the road network within an evaluation period; S_{V,v}^{L} is a set of lanes through which the vehicle Vᵥ passes in the road network within the evaluation period; t_{f(v,l)}^{V} is a free-flow driving time of the vehicle Vᵥ passing the l^{th} lane Lₗ in the road network; t_{fl}^{L} is an average free-flow driving time of the vehicles passing the lane Lₗ; and w_{(v,l)}^{V} is a traffic weight coefficient of the vehicle Vᵥ on the lane Lₗ;
S2, calculating traffic weight coefficients of evaluation objects in the road network at different spatial scales level by level in combination with the traffic weight coefficients of the vehicles and a composition structure of the road network, which is specifically as follows;
according to a definition of the for the traffic weight coefficient, for the traffic weight coefficients of each evaluation object in the road network at the different spatial scales, each value is a ration of the overall free-flow driving time of all the passing vehicles within a period of time to the overall free-flow driving time of all the vehicles in the whole road network for each evaluation object, and the traffic weight coefficients of all compostions belonging to one evaluation object at a same spatial scale are summed to obtain the traffic weight coefficient of the evaluation object, which is specifically as follows:
a traffic weight coefficient of the vehicle Vᵥ passing the lane Lₗ is reckoned as follows:
$${w}_{( v , l )}^{V} = \frac{\text{?}}{\text{?}} = \frac{\text{?}}{\text{?}} = \frac{\text{?}}{\text{?}} \text{?} \text{?}$$
$$\text{?} \text{indicates text missing or illegible when filed}$$
a traffic weight coefficient of the passing lane Lₗ is reckoned as follows:
$$\begin{matrix}{w}_{l}^{L} = \frac{\text{?}}{\text{?}} = \sum \text{?} \frac{\text{?}}{\text{?}} = \sum \text{?} \text{?} \\ {w}_{l}^{L} = \frac{\text{?}}{\text{?}} = \frac{\text{?}}{\text{?}} = \text{?} \text{?}\end{matrix}$$
$$\text{?} \text{indicates text missing or illegible when filed}$$
a traffic weight coefficient of a subsection Uᵤ is reckoned as follows:
$$\begin{matrix}{w}_{u}^{U} = \frac{\text{?}}{\text{?}} = \sum \text{?} \frac{\text{?}}{\text{?}} = \sum \text{?} \text{?} \\ {w}_{u}^{U} = \frac{\text{?}}{\text{?}} = \frac{\text{?}}{\text{?}} = \text{?} \text{?}\end{matrix}$$
$$\text{?} \text{indicates text missing or illegible when filed}$$
a traffic weight coefficient of a section Sₛ is reckoned as follows:
$$\begin{matrix}{w}_{s}^{S} = \frac{\text{?}}{\text{?}} = \sum \text{?} \frac{\text{?}}{\text{?}} = \sum \text{?} {w}_{u}^{U} = \\ \sum \text{?} {w}_{l}^{L} = \frac{\text{?}}{\text{?}} = \frac{\text{?}}{\text{?}} = \text{?} = \text{?}\end{matrix}$$
$$\text{?} \text{indicates text missing or illegible when filed}$$
a traffic weight coefficient of an intersection Iᵢ reckoned as follows:
$$\begin{matrix}{w}_{i}^{I} = \frac{\text{?}}{\text{?}} = \sum \text{?} \frac{\text{?}}{\text{?}} = \sum \text{?} {w}_{l}^{L} \\ {w}_{i}^{I} = \frac{\text{?}}{\text{?}} = \frac{\text{?}}{\text{?}} = \text{?} \text{?}\end{matrix}$$
$$\text{?} \text{indicates text missing or illegible when filed}$$
a traffic weight coefficient of a road Rᵣ is reckoned as follows:
$$\begin{matrix}{w}_{r}^{R} = \frac{\text{?}}{\text{?}} = \sum \text{?} {w}_{s}^{S} + \sum \text{?} {w}_{i}^{I} = \sum \text{?} {w}_{l}^{L} \\ {w}_{r}^{R} = \frac{\text{?}}{\text{?}} = \text{?} \text{?} \text{?}\end{matrix}$$
$$\text{?} \text{indicates text missing or illegible when filed}$$
a traffic weight coefficient of a sub-zone Z_{z} is reckoned as follows:
$$\begin{matrix}{w}_{z}^{Z} = \frac{\text{?}}{\text{?}} = \sum \text{?} {w}_{s}^{S} + \sum \text{?} {w}_{i}^{I} = \sum \text{?} {w}_{l}^{L} \\ {w}_{r}^{R} = \frac{\text{?}}{\text{?}} = \text{?} \text{?} \text{?}\end{matrix}$$
$$\text{?} \text{indicates text missing or illegible when filed}$$
wherein wₗ^{L} is the traffic weight coefficient of the lane Lₗ; S_{L,l}^{V} is a set of vehicles passing the lane Lₗ within the evaluation period; wᵤ^{U} is the traffic weight coefficient of the u^{th} subsection Uᵤ in the road network; S_{U,u}^{L} is a set of lanes contained in the subsection Uᵤ; wₛ^{S} is the traffic weight coefficient of the s^{th} section Sₛ in the road network; S_{S,s}^{U} is a set sub-sections contained in the section Sₛ; S_{S,s}^{L} is a set of lanes contained in the section Sₛ; wᵢ^{I} is the traffic weight coefficient of the i^{th} intersection Iᵢ in the road network; S_{I,i}^{L} is a set of lanes contained in the intersection Iᵢ; wᵣ^{R} is the traffic weight coefficient of the r^{th} road Rᵣ in the road network; S_{R,r}^{S} is a set of sections contained in the road Rᵣ; S_{R,r}^{I} is a set of intersections contained in the road Rᵣ; S_{R,r}^{L} is a set of lanes contained in the road Rᵣ; w_{z}^{Z} is the traffic weight coefficient of the z^{th} sub-zone Z_{z} in the road network; S_{Z,z}^{S} is a set of sections contained in the sub-zone Z_{z}; S_{Z,z}^{I} is a set of intersections contained in the sub-zone Z_{z}; and S_{Z,z}^{L} is a set of lanes contained in the sub-zone Z_{z}; and
according to the definition of the traffic weight coefficient of the road network, the traffic weight coefficients of all the vehicles, lanes, road sections, and intersections in the road network are summed respectively, with each sum being 1; and a formula is as follows:
$$\begin{matrix}{w}^{A} = \frac{\text{?}}{\text{?}} = {\sum }_{s = 1}^{{N}^{S}} {w}_{s}^{S} + {\sum }_{i = 1}^{{N}^{I}} {w}_{i}^{I} = {\sum }_{u = 1}^{{N}^{U}} {w}_{u}^{U} + {\sum }_{i = 1}^{{N}^{I}} {w}_{i}^{I} = {\sum }_{l = 1}^{{N}^{L}} {w}_{l}^{L} = {\sum }_{v = 1}^{{N}^{V}} {w}_{i}^{I} = \sum \text{?} \sum \text{?} {w}_{( v , l )}^{V} = 1 \\ {w}^{A} = \frac{\text{?}}{\text{?}} \text{?} \text{?} \text{?} \text{?} \text{?}\end{matrix}$$
$$\text{?} \text{indicates text missing or illegible when filed}$$
wherein w^{A} is the overall traffic weight coefficient of the road network; N^{S} is the number of sections in the road network; N^{I} is the number of in intersections in the road network: N^{U} is the number of sub-sections in the road network; and N^{L} is the number of lanes in the road network;
S3, reckoning traffic operation indexes of various lanes, various sub-sections, various sections, various intersections, various roads, various sub-zones, and the road network by using an average travel time, the free-flow driving times, and the traffic weight coefficients of the vehicles;
S4, reckoning delay time indexes of various lanes, various sub-sections, various sections, various intersections, various roads, various sub-zones, and the road network by using an average delay time, the free-flow driving times, and the traffic weight coefficients of the vehicles, and calculating average delay times of various evaluation objects at the different spatial scales in combination with the free-flow driving times of the vehicles;
S5, reckoning indexes of numbers of times of stopping of various lanes, various sub-sections, various sections, various intersections, various roads, various sub-zones, and the road network by using an average number of times of stopping, the free-flow driving times, and the traffic weight coefficients of the vehicles, and calculating average numbers of times of stopping of various evaluation objects at the different spatial scales in combination with the free-flow driving times of the vehicles; and
S6, reckoning indexes of mileages of congested roads of various lanes, various sub-sections, various sections, various intersections, various roads, various sub-zones, and the road network by using mileages of heavily congested roads, the free-flow driving times, and the traffic weight coefficients of the vehicles, and calculating proportions of the mileages of the heavily congested roads of various evaluation objects at the different spatial scales in combination with free-flow driving speeds of the vehicles.

2.-3. (canceled)

4. The digital road network traffic state reckoning method based on multi-scale calculation according to 1, wherein step S3 is specifically as follows:
the traffic operation index of each evaluation object in the road network is a ratio of an overall travel time of all the passing vehicles in each evaluation object to the overall free-flow driving time, that is, an average travel time of all the passing vehicles in a distance corresponding to a unit free-flow driving time; and
the traffic operation index of each evaluation object may be obtained by weighted summation of the traffic weight coefficients and the traffic operation indexes of the vehicles, the lanes, the sub-sections, the sections, and the intersections belonging to the evaluation object, and the traffic operation index is dimensionless, specifically as follows:
a traffic operation index of the vehicle Vᵥ passing the lane Lₗ is reckoned as follows:
$${PI}_{( v , l )}^{V} = \frac{{t}_{( v , l )}^{V}}{{t}_{f ( v , l )}^{V}} \text{?} {PI}_{( v , l )}^{V} = \text{?} \frac{{t}_{( v , l )}^{V}}{{t}_{f ( v , l )}^{V}}$$
$$\text{?} \text{indicates text missing or illegible when filed}$$
a traffic operation index of the vehicle Vᵥ is reckoned as follows:
$$\begin{matrix}{PI}_{v}^{V} = \frac{\text{?}}{\text{?}} = \frac{\text{?}}{\text{?}} \times \frac{\text{?}}{\text{?}} = \frac{\text{?}}{\text{?}} \\ {PI}_{v}^{V} = \frac{\text{?}}{\text{?}} = \frac{\text{?}}{\text{?}} = \frac{\text{?}}{\text{?}}\end{matrix}$$
$$\text{?} \text{indicates text missing or illegible when filed}$$
a traffic operation index of the lane Lₗ is reckoned as follows:
$$\begin{matrix}{PI}_{l}^{L} = \frac{\text{?}}{\text{?}} = \frac{\text{?}}{\text{?}} \times \frac{\text{?}}{\text{?}} = \frac{\text{?}}{\text{?}} \\ {PI}_{l}^{L} = \frac{\text{?}}{\text{?}} = \frac{\text{?}}{\text{?}} = \frac{\text{?}}{\text{?}}\end{matrix}$$
$$\text{?} \text{indicates text missing or illegible when filed}$$
a traffic operation index of a subsection Uᵤ is reckoned as follows:
$${PI}_{u}^{U} = \frac{{\sum }_{l ∈ {S}_{U , u}^{L}} {\sum }_{v ∈ {S}_{L , l}^{V}} {t}_{( v , l )}^{V}}{{\sum }_{l ∈ {S}_{U , u}^{L}} {\sum }_{v ∈ {S}_{L , l}^{V}} {t}_{{f}_{( v , l )}}^{V}} = \frac{{\sum }_{l ∈ {S}_{U , u}^{L}} {\sum }_{v ∈ {S}_{L , l}^{V}} ( {PI}_{( v , l )}^{V} \times {w}_{( v , l )}^{V} )}{{\sum }_{l ∈ {S}_{U , u}^{L}} {\sum }_{v ∈ {S}_{L , l}^{V}} {w}_{( v , l )}^{V}} \times \frac{{\sum }_{l ∈ {S}_{U , u}^{L}} ( {PI}_{l}^{L} \times {w}_{l}^{L} )}{{\sum }_{l ∈ {S}_{U , u}^{L}} {w}_{l}^{L}}$$
a traffic operation index of the section Sₛ is reckoned as follows:
$${PI}_{s}^{S} = \frac{{\sum }_{u ∈ {S}_{S , s}^{U}} {\sum }_{l ∈ {S}_{U , u}^{L}} {\sum }_{v ∈ {S}_{L , l}^{V}} {t}_{( v , l )}^{V}}{{\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}}^{V}} = \frac{{\sum }_{l ∈ {S}_{S , s}^{L}} {\sum }_{v ∈ {S}_{L , l}^{V}} ( {PI}_{( v , l )}^{V} \times {w}_{( v , l )}^{V} )}{{\sum }_{l ∈ {S}_{S , s}^{L}} {\sum }_{v ∈ {S}_{L , l}^{V}} {w}_{( v , l )}^{V}} = \frac{{\sum }_{l ∈ {S}_{S , s}^{L}} ( {PI}_{l}^{L} \times {w}_{l}^{L} )}{{\sum }_{l ∈ {S}_{S , s}^{L}} {w}_{l}^{L}} = \frac{{\sum }_{u ∈ {S}_{S , s}^{U}} ( {PI}_{u}^{U} \times {w}_{u}^{U} )}{{\sum }_{u ∈ {S}_{S , s}^{U}} {w}_{u}^{U}}$$
a traffic operation index of the intersection Iᵢ is reckoned as follows:
$${PI}_{i}^{I} = \frac{{\sum }_{l ∈ {S}_{I , i}^{L}} {\sum }_{v ∈ {S}_{L , l}^{V}} {t}_{( v , l )}^{V}}{{\sum }_{l ∈ {S}_{I , i}^{L}} {\sum }_{v ∈ {S}_{L , l}^{V}} {t}_{{f}_{( v , l )}}^{V}} = \frac{{\sum }_{l ∈ {S}_{I , i}^{L}} {\sum }_{v ∈ {S}_{L , l}^{V}} ( {PI}_{( v , l )}^{V} \times {w}_{( v , l )}^{V} )}{{\sum }_{l ∈ {S}_{I , i}^{L}} {\sum }_{v ∈ {S}_{L , l}^{V}} {w}_{( v , l )}^{V}} = \frac{{\sum }_{l ∈ {S}_{I , i}^{L}} ( {PI}_{l}^{L} \times {w}_{l}^{L} )}{{\sum }_{l ∈ {S}_{I , i}^{L}} {w}_{l}^{L}}$$
a traffic operation index of the road Rᵣ is reckoned as follows:
$${PI}_{r}^{R} = \frac{\begin{matrix}{\sum }_{s ∈ {S}_{R , r}^{S}} {\sum }_{u ∈ {S}_{S , s}^{U}} {\sum }_{l ∈ {S}_{U , u}^{L}} {\sum }_{v ∈ {S}_{L , l}^{V}} {t}_{( v , l )}^{V} + \\ {\sum }_{i ∈ {S}_{R , r}^{I}} {\sum }_{l ∈ {S}_{I , i}^{L}} {\sum }_{v ∈ {S}_{L , l}^{V}} {t}_{( v , l )}^{V}\end{matrix}}{\begin{matrix}{\sum }_{s ∈ {S}_{R , r}^{S}} {\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}}^{V} + \\ {\sum }_{i ∈ {S}_{R , r}^{I}} {\sum }_{l ∈ {S}_{I , i}^{L}} {\sum }_{v ∈ {S}_{L , l}^{V}} {t}_{{f}_{( v , l )}}^{V}\end{matrix}} = \frac{{\sum }_{l ∈ {S}_{R , r}^{L}} {\sum }_{v ∈ {S}_{L , l}^{V}} {t}_{( v , l )}^{V}}{{\sum }_{l ∈ {S}_{R , r}^{L}} {\sum }_{v ∈ {S}_{L , l}^{V}} {t}_{{f}_{( v , l )}}^{V}} = \frac{{\sum }_{l ∈ {S}_{R , r}^{L}} ( {PI}_{l}^{L} \times {w}_{l}^{L} )}{{\sum }_{l ∈ {S}_{R , r}^{L}} {w}_{l}^{L}}$$
a traffic operation index of a sub-zone Z_{z} is reckoned as follows:
$${PI}_{z}^{Z} = \frac{\begin{matrix}{\sum }_{s ∈ {S}_{Z , z}^{S}} {\sum }_{u ∈ {S}_{S , s}^{U}} {\sum }_{l ∈ {S}_{U , u}^{L}} {\sum }_{v ∈ {S}_{L , l}^{V}} {t}_{( v , l )}^{V} + \\ {\sum }_{i ∈ {S}_{Z , z}^{I}} {\sum }_{l ∈ {S}_{I , i}^{L}} {\sum }_{v ∈ {S}_{L , l}^{V}} {t}_{( v , l )}^{V}\end{matrix}}{\begin{matrix}{\sum }_{s ∈ {S}_{Z , z}^{S}} {\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}}^{V} + \\ {\sum }_{i ∈ {S}_{Z , z}^{I}} {\sum }_{l ∈ {S}_{I , i}^{L}} {\sum }_{v ∈ {S}_{L , l}^{V}} {t}_{{f}_{( v , l )}}^{V}\end{matrix}} = \frac{{\sum }_{l ∈ {S}_{Z , z}^{L}} {\sum }_{v ∈ {S}_{L , l}^{V}} {t}_{( v , l )}^{V}}{{\sum }_{l ∈ {S}_{Z , z}^{L}} {\sum }_{v ∈ {S}_{L , l}^{V}} {t}_{{f}_{( v , l )}}^{V}} = \frac{{\sum }_{l ∈ {S}_{Z , z}^{L}} ( {PI}_{l}^{L} \times {w}_{l}^{L} )}{{\sum }_{l ∈ {S}_{Z , z}^{L}} {w}_{l}^{L}}$$
a traffic operation index of a zone is reckoned as follows:
$${PI}_{}^{A} = \frac{\begin{matrix}{\sum }_{s ∈ {S}_{A}^{S}} {\sum }_{u ∈ {S}_{S , s}^{U}} {\sum }_{l ∈ {S}_{U , u}^{L}} {\sum }_{v ∈ {S}_{L , l}^{V}} {t}_{( v , l )}^{V} + \\ {\sum }_{i ∈ {S}_{A}^{I}} {\sum }_{l ∈ {S}_{I , i}^{L}} {\sum }_{v ∈ {S}_{L , l}^{V}} {t}_{( v , l )}^{V}\end{matrix}}{\begin{matrix}{\sum }_{s ∈ {S}_{A}^{S}} {\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}}^{V} + \\ {\sum }_{i ∈ {S}_{A}^{I}} {\sum }_{l ∈ {S}_{I , i}^{L}} {\sum }_{v ∈ {S}_{L , l}^{V}} {t}_{{f}_{( v , l )}}^{V}\end{matrix}} = \frac{{\sum }_{l ∈ {S}_{A}^{L}} {\sum }_{v ∈ {S}_{L , l}^{V}} {t}_{( v , l )}^{V}}{{\sum }_{l ∈ {S}_{A}^{L}} {\sum }_{v ∈ {S}_{L , l}^{V}} {t}_{{f}_{( v , l )}}^{V}} = {\sum }_{l ∈ {S}_{A}^{L}} ( {PI}_{l}^{L} \times {w}_{l}^{L} )$$
where PI_{(v,l)}^{V} is the traffic operation index of the vehicle Vᵥ on the lane Lₗ; t_{(v,l)}^{V} is a travel time of the vehicle Vᵥ passing the lane Lₗ; PIᵥ^{V}, PIₗ^{L}, PIᵤ^{U}, PIₛ^{S}, PIᵢ^{I}, PIᵣ^{R}, PI_{z}^{Z}, and PI^{A} represent traffic operation indexes of the vehicle Vᵥ, the lane Lₗ, the subsection Uᵤ, the section, Sₛ, the intersection Iᵢ, the road Rᵣ, the sub-zone Z_{z}, and the zone respectively; S_{A}^{S} is a set of sections contained in the zone; S_{A}^{I} is a set of intersections contained in the zone; and S_{A}^{L} is a set of lanes contained in the zone.

5. The digital road network traffic state reckoning method based on multi-scale calculation according to 1, wherein step S4 specifically comprises:
S401, reckoning the delay time indexes of various evaluation objects at multiple spatial scales, wherein
the delay time index of each evaluation object in the road network is a ratio of an overall delay time of all the passing vehicles in each evaluation object to the overall free-flow driving time, that is, an average delay time of all the passing vehicles in the distance corresponding to the unit free-flow driving time; and
the delay time index of each evaluation object may be obtained by weighted summation of the traffic weight coefficients and the delay time indexes of the vehicles, the lanes, the sub-sections, the sections, and the intersections belonging to the evaluation object, and the traffic operation index is dimensionless, having an ability to further calculate the average delay time, specifically as follows:
a delay time index of the vehicle Vᵥ passing the lane Lₗ is reckoned as follows:
$${DI}_{( v , l )}^{V} = \frac{{d}_{( v , l )}^{V}}{{t}_{{f}_{( v , l )}}^{V}}$$
a delay time index of the vehicle Vᵥ is reckoned as follows:
$${DI}_{v}^{V} = \frac{{\sum }_{l ∈ {S}_{V , v}^{L}} {d}_{( v , l )}^{V}}{{\sum }_{l ∈ {S}_{V , v}^{L}} {t}_{{f}_{l}}^{L}} = \frac{{\sum }_{l ∈ {S}_{V , v}^{L}} ( {DI}_{( v , l )}^{V} \times {t}_{{f}_{( v , l )}}^{V} )}{{\sum }_{v = 1}^{{N}^{V}} {\sum }_{l ∈ {S}_{V , v}^{L}} {t}_{{f}_{l}}^{L}} \times \frac{{\sum }_{v = 1}^{{N}^{V}} {\sum }_{l ∈ {S}_{V , v}^{L}} {t}_{{f}_{l}}^{L}}{{\sum }_{l ∈ {S}_{V , v}^{L}} {t}_{{f}_{l}}^{L}} = \frac{{\sum }_{l ∈ {S}_{V , v}^{L}} ( {DI}_{( v , l )}^{V} \times {w}_{( v , l )}^{V} )}{{\sum }_{l ∈ {S}_{V , v}^{L}} {w}_{( v , l )}^{V}}$$
a delay time index of the lane Lₗ is reckoned as follows:
$${DI}_{l}^{L} = \frac{{\sum }_{v ∈ {S}_{L , l}^{V}} {d}_{( v , l )}^{V}}{{\sum }_{v ∈ {S}_{L , l}^{V}} {t}_{{f}_{( v , l )}}^{V}} = \frac{{\sum }_{v ∈ {S}_{L , l}^{V}} {d}_{( v , l )}^{V}}{{\sum }_{v = 1}^{{N}^{V}} {\sum }_{l ∈ {S}_{V , v}^{L}} {t}_{{f}_{( v , l )}}^{V}} \times \frac{{\sum }_{v = 1}^{{N}^{V}} {\sum }_{l ∈ {S}_{V , v}^{L}} {t}_{{f}_{( v , l )}}^{V}}{{\sum }_{v ∈ {S}_{L , l}^{V}} {t}_{{f}_{( v , l )}}^{V}} = \frac{{\sum }_{v ∈ {S}_{L , l}^{V}} ( {DI}_{( v , l )}^{V} \times {w}_{( v , l )}^{V} )}{{\sum }_{v ∈ {S}_{L , l}^{V}} {w}_{( v , l )}^{V}}$$
a delay time index of a subsection Uᵤ is reckoned as follows:
$${DI}_{u}^{U} = \frac{{\sum }_{l ∈ {S}_{U , u}^{L}} {\sum }_{v ∈ {S}_{L , l}^{V}} {d}_{( v , l )}^{V}}{{\sum }_{l ∈ {S}_{U , u}^{L}} {\sum }_{v ∈ {S}_{L , l}^{V}} {t}_{{f}_{( v , l )}}^{V}} = \frac{{\sum }_{l ∈ {S}_{U , u}^{L}} {\sum }_{v ∈ {S}_{L , l}^{V}} ( {DI}_{( v , l )}^{V} \times {w}_{( v , l )}^{V} )}{{\sum }_{l ∈ {S}_{U , u}^{L}} {\sum }_{v ∈ {S}_{L , l}^{V}} {w}_{( v , l )}^{V}} \times \frac{{\sum }_{l ∈ {S}_{U , u}^{L}} ( {DI}_{l}^{L} \times {w}_{l}^{V} )}{{\sum }_{l ∈ {S}_{U , u}^{L}} {w}_{l}^{V}}$$
a delay time index of the section Sₛ is reckoned as follows:
$${DI}_{s}^{S} = \frac{{\sum }_{u ∈ {S}_{S , s}^{U}} {\sum }_{l ∈ {S}_{U , u}^{L}} {\sum }_{v ∈ {S}_{L , l}^{V}} {d}_{( v , l )}^{V}}{{\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}}^{V}} = \frac{{\sum }_{l ∈ {S}_{S , s}^{L}} {\sum }_{v ∈ {S}_{L , l}^{V}} ( {DI}_{( v , l )}^{V} \times {w}_{( v , l )}^{V} )}{{\sum }_{l ∈ {S}_{S , s}^{L}} {\sum }_{v ∈ {S}_{L , l}^{V}} {w}_{( v , l )}^{V}} = \frac{{\sum }_{l ∈ {S}_{S , s}^{L}} ( {DI}_{l}^{L} \times {w}_{l}^{L} )}{{\sum }_{l ∈ {S}_{S , s}^{L}} {w}_{l}^{L}} = \frac{{\sum }_{u ∈ {S}_{S , s}^{U}} ( {DI}_{u}^{U} \times {w}_{u}^{U} )}{{\sum }_{u ∈ {S}_{S , s}^{U}} {w}_{u}^{U}}$$
a delay time index of the intersection Iᵢ is reckoned as follows:
$${DI}_{i}^{I} = \frac{{\sum }_{l ∈ {S}_{I , i}^{L}} {\sum }_{v ∈ {S}_{L , l}^{V}} {d}_{( v , l )}^{V}}{{\sum }_{l ∈ {S}_{I , i}^{L}} {\sum }_{v ∈ {S}_{L , l}^{V}} {t}_{{f}_{( v , l )}}^{V}} = \frac{{\sum }_{l ∈ {S}_{I , i}^{L}} {\sum }_{v ∈ {S}_{L , l}^{V}} ( {DI}_{( v , l )}^{V} \times {w}_{( v , l )}^{V} )}{{\sum }_{l ∈ {S}_{I , i}^{L}} {\sum }_{v ∈ {S}_{L , l}^{V}} {w}_{( v , l )}^{V}} = \frac{{\sum }_{l ∈ {S}_{I , i}^{L}} ( {DI}_{l}^{L} \times {w}_{l}^{L} )}{{\sum }_{l ∈ {S}_{I , i}^{L}} {w}_{l}^{L}}$$
a delay time index of the road Rᵣ is reckoned as follows:
$${DI}_{r}^{R} = \frac{\begin{matrix}{\sum }_{s ∈ {S}_{R , r}^{S}} {\sum }_{u ∈ {S}_{S , s}^{U}} {\sum }_{l ∈ {S}_{U , u}^{L}} {\sum }_{v ∈ {S}_{L , l}^{V}} {d}_{( v , l )}^{V} + \\ {\sum }_{i ∈ {S}_{R , r}^{I}} {\sum }_{l ∈ {S}_{I , i}^{L}} {\sum }_{v ∈ {S}_{L , l}^{V}} {d}_{( v , l )}^{V}\end{matrix}}{\begin{matrix}{\sum }_{s ∈ {S}_{R , r}^{S}} {\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}}^{V} + \\ {\sum }_{i ∈ {S}_{R , r}^{I}} {\sum }_{l ∈ {S}_{I , i}^{L}} {\sum }_{v ∈ {S}_{L , l}^{V}} {t}_{{f}_{( v , l )}}^{V}\end{matrix}} = \frac{{\sum }_{l ∈ {S}_{R , r}^{L}} {\sum }_{v ∈ {S}_{L , l}^{V}} {d}_{( v , l )}^{V}}{{\sum }_{l ∈ {S}_{R , r}^{L}} {\sum }_{v ∈ {S}_{L , l}^{V}} {t}_{{f}_{( v , l )}}^{V}} = \frac{{\sum }_{l ∈ {S}_{R , r}^{L}} ( {DI}_{l}^{L} \times {w}_{l}^{L} )}{{\sum }_{l ∈ {S}_{R , r}^{L}} {w}_{l}^{L}}$$
a delay time index of a sub-zone Z_{z} is reckoned as follows:
$${DI}_{z}^{Z} = \frac{\begin{matrix}{\sum }_{s ∈ {S}_{Z , z}^{S}} {\sum }_{u ∈ {S}_{S , s}^{U}} {\sum }_{l ∈ {S}_{U , u}^{L}} {\sum }_{v ∈ {S}_{L , l}^{V}} {d}_{( v , l )}^{V} + \\ {\sum }_{i ∈ {S}_{Z , z}^{I}} {\sum }_{l ∈ {S}_{I , i}^{L}} {\sum }_{v ∈ {S}_{L , l}^{V}} {d}_{( v , l )}^{V}\end{matrix}}{\begin{matrix}{\sum }_{s ∈ {S}_{Z , z}^{S}} {\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}}^{V} + \\ {\sum }_{i ∈ {S}_{Z , z}^{I}} {\sum }_{l ∈ {S}_{I , i}^{L}} {\sum }_{v ∈ {S}_{L , l}^{V}} {t}_{{f}_{( v , l )}}^{V}\end{matrix}} = \frac{{\sum }_{l ∈ {S}_{Z , z}^{L}} {\sum }_{v ∈ {S}_{L , l}^{V}} {d}_{( v , l )}^{V}}{{\sum }_{l ∈ {S}_{Z , z}^{L}} {\sum }_{v ∈ {S}_{L , l}^{V}} {t}_{{f}_{( v , l )}}^{V}} = \frac{{\sum }_{l ∈ {S}_{Z , z}^{L}} ( {DI}_{l}^{L} \times {w}_{l}^{L} )}{{\sum }_{l ∈ {S}_{Z , z}^{L}} {w}_{l}^{L}}$$
a delay time index of a zone is reckoned as follows:
$${DI}_{}^{A} = \frac{\begin{matrix}{\sum }_{s ∈ {S}_{A}^{S}} {\sum }_{u ∈ {S}_{S , s}^{U}} {\sum }_{l ∈ {S}_{U , u}^{L}} {\sum }_{v ∈ {S}_{L , l}^{V}} {d}_{( v , l )}^{V} + \\ {\sum }_{i ∈ {S}_{A}^{I}} {\sum }_{l ∈ {S}_{I , i}^{L}} {\sum }_{v ∈ {S}_{L , l}^{V}} {d}_{( v , l )}^{V}\end{matrix}}{\begin{matrix}{\sum }_{s ∈ {S}_{A}^{S}} {\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}}^{V} + \\ {\sum }_{i ∈ {S}_{A}^{I}} {\sum }_{l ∈ {S}_{I , i}^{L}} {\sum }_{v ∈ {S}_{L , l}^{V}} {t}_{{f}_{( v , l )}}^{V}\end{matrix}} = \frac{{\sum }_{l ∈ {S}_{A}^{L}} {\sum }_{v ∈ {S}_{L , l}^{V}} {d}_{( v , l )}^{V}}{{\sum }_{l ∈ {S}_{A}^{L}} {\sum }_{v ∈ {S}_{L , l}^{V}} {t}_{{f}_{( v , l )}}^{V}} = {\sum }_{l ∈ {S}_{A}^{L}} ( {DI}_{l}^{L} \times {w}_{l}^{L} )$$
wherein DI_{(v,l)}^{V} is the delay time index of the vehicle Vᵥ on the lane Lₗ; d_{(v,l)}^{V} is the delay time of the vehicle Vᵥ passing the lane Lₗ; and DIᵥ^{V}, DIₗ^{L}, DIᵤ^{U}, DIₛ^{S}, DIᵢ^{I}, DIᵣ^{R}, DI_{z}^{Z}, and DI^{A} represent the delay time indexes of the vehicle Vᵥ, the lane Lₗ, the subsection Uᵤ, the road Sₛ, the intersection Iᵢ, the road Rᵣ, the sub-zone Z_{z}, and the zone respectively; and
S402, calculating the average delay times of various evaluation objects, wherein
according to the acquired delay time indexes of the different evaluation objects at the multiple spatial scales, the average delay time of each evaluation object is calculated, which is specifically as follows:
an average delay time of the vehicle Vᵥ passing the lane Lₗ is reckoned as follows:
$${d}_{( v , l )}^{V} = {DI}_{( v , l )}^{V} \times {t}_{{f}_{( v , l )}}^{V} {d}_{( v , l )}^{V} = {DI}_{( v , l )}^{V} \text{?} {t}_{f ( v , l )}^{V} \text{?}$$
$$\text{?} \text{indicates text missing or illegible when filed}$$
an average delay time of the vehicle Vᵥ is reckoned as follows:
$${d}_{v}^{V} = \sum \text{?} {d}_{( v , l )}^{V} = {DI}_{v}^{V} \times \sum \text{?} {t}_{l}^{L} = {DI}_{v}^{V} \times {t}_{{f}_{l}}^{L} = {DI}_{v}^{V} \times {t}_{{f}_{v}}^{V}$$
$${d}_{v}^{V} = \text{?} = \text{?} \text{?} \text{?} = {D}_{v}^{V} \text{?} {t}_{fv}^{V}$$
$$\text{?} \text{indicates text missing or illegible when filed}$$
an average delay time of the lane Lₗ is reckoned as follows:
$${\overline{d}}_{l}^{L} = \frac{\text{?}}{\text{?}} = \frac{\text{?}}{\text{?}} \times \frac{\text{?}}{\text{?}} = {DI}_{l}^{L} \times {t}_{{f}_{l}}^{L}$$
$${\overline{d}}_{l}^{L} = \frac{v {S}_{L , l}^{V\_} {d}_{( v , l )}^{V} ℸ}{{N}_{L , l}^{V}} = \frac{v {S}_{L , l}^{V\_} {d}_{( v , l )}^{V} ℸ , v {S}_{L , l}^{V\_} {t}_{f ( v , l )}^{V} ℸ}{v {S}_{L , l}^{V\_} {t}_{f ( v , l )}^{V} ℸ {N}_{L , l}^{V}} = {DI}_{l}^{L} \text{?} {t}_{fl}^{L}$$
$$\text{?} \text{indicates text missing or illegible when filed}$$
an average delay time of a subsection Uᵤ is reckoned as follows:
$${\overline{d}}_{u}^{U} = \frac{\text{?}}{\text{?}} = \frac{\text{?}}{\text{?}} \times \frac{\text{?}}{\text{?}} = {DI}_{u}^{U} \times {t}_{{f}_{u}}^{U}$$
$${\overline{d}}_{u}^{U} = \frac{\text{?}}{\text{?}} = \frac{\text{?}}{\text{?}} = {DI}_{u}^{U} \text{?} {t}_{fu}^{U}$$
$$\text{?} \text{indicates text missing or illegible when filed}$$
an average delay time of the section Sₛ is reckoned as follows:
$${\overline{d}}_{s}^{S} = \frac{\text{?}}{\text{?}} = \frac{\text{?}}{\text{?}} \times \frac{\text{?}}{\text{?}} = {DI}_{s}^{S} \times {t}_{{f}_{s}}^{S}$$
$${\overline{d}}_{s}^{S} = \frac{\text{?}}{\text{?}} = \frac{\text{?}}{\text{?}} = {DI}_{s}^{S} \text{?} {t}_{fs}^{S}$$
$$\text{?} \text{indicates text missing or illegible when filed}$$
an average delay time of the intersection Iᵢ is reckoned as follows:
$${\overline{d}}_{i}^{I} = \frac{\text{?}}{\text{?}} = \frac{\text{?}}{\text{?}} \times \frac{\text{?}}{\text{?}} = {DI}_{i}^{I} \times {t}_{{f}_{i}}^{I}$$
$${\overline{d}}_{i}^{I} = \frac{\text{?}}{\text{?}} = \frac{\text{?}}{\text{?}} = {DI}_{i}^{I} \text{?} {t}_{fi}^{I}$$
$$\text{?} \text{indicates text missing or illegible when filed}$$
an average delay time of the road Rᵣ is reckoned as follows:
$${\overline{d}}_{r}^{R} = \frac{\text{?}}{\text{?}} = \frac{\text{?}}{\text{?}} \times \frac{\text{?}}{\text{?}} = {DI}_{r}^{R} \times {t}_{{f}_{r}}^{R}$$
$${\overline{d}}_{r}^{R} = \frac{\text{?}}{\text{?}} = \frac{\text{?}}{\text{?}} = {DI}_{r}^{R} \text{?} {t}_{fr}^{R}$$
$$\text{?} \text{indicates text missing or illegible when filed}$$
an average delay time of a sub-zone Z_{z} is reckoned as follows:
$${\overline{d}}_{z}^{Z} = \frac{\text{?}}{\text{?}} = \frac{\text{?}}{\text{?}} \times \frac{\text{?}}{\text{?}} = {DI}_{z}^{Z} \times {t}_{{f}_{z}}^{Z}$$
$${\overline{d}}_{z}^{Z} = \frac{\text{?}}{\text{?}} = \frac{\text{?}}{\text{?}} = {DI}_{z}^{Z} \text{?} {t}_{fz}^{Z}$$
$$\text{?} \text{indicates text missing or illegible when filed}$$
an average delay time of the zone is reckoned as follows:
$${\overline{d}}^{A} = \frac{\text{?}}{\text{?}} = \frac{\text{?}}{\text{?}} \times \frac{\text{?}}{\text{?}} = {DI}^{A} \times {t}_{f}^{A}$$
$${\overline{d}}^{A} = \frac{\text{?}}{\text{?}} = \frac{\text{?}}{\text{?}} = {DI}^{A} \text{?} {t}_{f}^{A}$$
$$\text{?} \text{indicates text missing or illegible when filed}$$
wherein dᵥ^{V} is the delay time of the vehicle Vᵥ; d̅ₗ^{L}, d̅ᵤ^{U}, d̅ₛ^{S}, d̅ᵢ^{I}, d̅ᵣ^{R}, d̅_{z}^{Z}, and d̅^{A} represent the average delay times of the lane Lₗ, the subsection Uᵤ, the section Sₛ, the intersection Iᵢ, the road Rᵣ, the sub-zone Z_{z}, and the zone respectively; N_{L,l}^{V}, N_{U,u}^{V}, Y, N_{S,s}^{V}, N_{I,i}^{V}, N_{R,r}^{V}, and N_{Z,z}^{V} represent numbers of vehicles passing the lane Lₗ, the subsection Uᵤ, the section Sₛ, the intersection Iᵢ, the road Rᵣ, the sub-zone Z_{z} within the evaluation period respectively; and t_{fu}^{U}, t_{fs}^{S}, t_{fi}^{I}, t_{fr}^{R}, t_{fz}^{Z}, and t_{f}^{A} represent the average free-flow driving times of the subsection Uᵤ, the section Sₛ, the intersection Iᵢ, the road Rᵣ, the sub-zone Z_{z}, and the zone respectively.

6. The digital road network traffic state reckoning method based on multi-scale calculation according to 1, wherein step S5 specifically comprises:
S501, reckoning the indexes of the numbers of times of stopping of various evaluation objects at the multiple spatial scales, wherein
the index of the number of times of stopping of each evaluation object in the road network is a ratio of an overall number of times of stopping of all the passing vehicles in each evaluation object to the overall free-flow driving time, that is, an average number of times of stopping of all the passing vehicles in the distance corresponding to the unit free-flow driving time; and
the index of the number of times of stopping of each evaluation object may be obtained by weighted summation of the traffic weight coefficients and the indexes of the numbers of times of stopping of the vehicles, the lanes, the sub-sections, the sections, and the intersections belonging to the evaluation object, and the index of the number of times of stopping is in a unit of “times/min”, having an ability to further calculate the average number of times of stopping, specifically as follows:
an index of number of times of stopping of the vehicle Vᵥ passing the lane Lₗ is reckoned as follows:
$${HI}_{( v , l )}^{V} = \frac{{h}_{( v , l )}^{V}}{{t}_{{f}_{( v , l )}}^{V}} {HI}_{( v , l )}^{V} = \frac{{h}_{( v , l )}^{V}}{{t}_{f ( v , l )}^{V}}$$
an index of number of times of stopping of the vehicle Vᵥ is reckoned as follows:
$${HI}_{v}^{V} = \frac{\text{?}}{\text{?}} = \frac{\text{?}}{\text{?}} \times \frac{\text{?}}{\text{?}} = \frac{\text{?}}{\text{?}}$$
$${HI}_{v}^{V} = \frac{\text{?}}{\text{?}} = \frac{\text{?}}{\text{?}} = \frac{\text{?}}{\text{?}}$$
$$\text{?} \text{indicates text missing or illegible when filed}$$
an index of number of times of stopping of the lane Lₗ is reckoned as follows:
$${HI}_{l}^{L} = \frac{\text{?}}{\text{?}} = \frac{\text{?}}{\text{?}} \times \frac{\text{?}}{\text{?}} = \frac{\text{?}}{\text{?}}$$
$${HI}_{l}^{L} = \frac{\text{?}}{\text{?}} = \frac{\text{?}}{\text{?}} = \frac{\text{?}}{\text{?}}$$
$$\text{?} \text{indicates text missing or illegible when filed}$$
an index of number of times of stopping of the subsection Uᵤ is reckoned as follows:
$${HI}_{u}^{U} = \frac{\text{?}}{\text{?}} = \frac{\text{?}}{\text{?}} = \frac{\text{?}}{\text{?}}$$
$${HI}_{u}^{U} = \frac{\text{?}}{\text{?}} = \frac{\text{?}}{\text{?}} = \frac{\text{?}}{\text{?}}$$
$$\text{?} \text{indicates text missing or illegible when filed}$$
an index of number of times of stopping of the section Sₛ is reckoned as follows:
$${HI}_{s}^{S} = \frac{\text{?}}{\text{?}} = \frac{\text{?}}{\text{?}} = \frac{\text{?}}{\text{?}} = \frac{\text{?}}{\text{?}}$$
$${HI}_{s}^{S} = \frac{\text{?}}{\text{?}} = \frac{\text{?}}{\text{?}} = \frac{\text{?}}{\text{?}} = \frac{\text{?}}{\text{?}}$$
$$\text{?} \text{indicates text missing or illegible when filed}$$
an index of number of times of stopping of the intersection Iᵢ is reckoned as follows:
$${HI}_{i}^{I} = \frac{\text{?}}{\text{?}} = \frac{\text{?}}{\text{?}} = \frac{\text{?}}{\text{?}}$$
$${HI}_{i}^{I} = \frac{\text{?}}{\text{?}} = \frac{\text{?}}{\text{?}} = \frac{\text{?}}{\text{?}}$$
$$\text{?} \text{indicates text missing or illegible when filed}$$
an index of number of times of stopping of the road Rᵣ is reckoned as follows:
$${HI}_{r}^{R} = \frac{\text{?}}{\text{?}} = \frac{\text{?}}{\text{?}} = \frac{\text{?}}{\text{?}}$$
$${HI}_{r}^{R} = \frac{\text{?}}{\text{?}} = \frac{\text{?}}{\text{?}} = \frac{\text{?}}{\text{?}}$$
$$\text{?} \text{indicates text missing or illegible when filed}$$
an index of number of times of stopping of the sub-zone Z_{z} is reckoned as follows:
$${HI}_{z}^{Z} = \frac{\text{?}}{\text{?}} = \frac{\text{?}}{\text{?}} = \frac{\text{?}}{\text{?}}$$
$${HI}_{z}^{Z} = \frac{\text{?}}{\text{?}} = \frac{\text{?}}{\text{?}} = \frac{\text{?}}{\text{?}}$$
$$\text{?} \text{indicates text missing or illegible when filed}$$
an index of number of times of stopping of the zone is reckoned as follows:
$${HI}^{A} = \frac{\text{?}}{\text{?}} = \frac{\text{?}}{\text{?}} = \sum \text{?} ( {HI}_{l}^{L} \times {w}_{l}^{L} )$$
$${HI}^{A} = \frac{\text{?}}{\text{?}} = \frac{\text{?}}{\text{?}} = ( \text{?} \text{?} )$$
$$\text{?} \text{indicates text missing or illegible when filed}$$
wherein HI_{(v,l)}^{V} is the index of the number of times of stopping of the vehicle Vᵥ on the lane Lₗ; h_{(v,l)}^{V} is the number of times of stopping of the vehicle Vᵥ passing the lane Lₗ; and HIᵥ^{V}, HIₗ^{L}, HIᵤ^{U}, HIₛ^{S}, HIᵢ^{I}, HIᵣ^{R}, HI_{z}^{Z}, and HI^{A} represent the indexes of number of times of stopping of the vehicle Vᵥ, the lane Lₗ, the subsection Uᵤ, the section Sₛ, the intersection Iᵢ, the road Rᵣ, the sub-zone Z_{z}, and the zone respectively; and
S502, calculating the average numbers of times of stopping of various evaluation objects, wherein
according to the acquired indexes of number of times of stopping of the different evaluation objects at the multiple spatial scales, the average numbers of times of stopping of various evaluation objects are calculated, which are specifically as follows:
an average number of times of stopping of the vehicle Vᵥ passing the lane Lₗ is reckoned as follows:
$${h}_{( v , l )}^{V} = {HI}_{( v , l )}^{V} \times {t}_{{f}_{( v , l )}^{V}}$$
an average number of times of stopping of the vehicle Vᵥ is reckoned as follows:
$${h}_{v}^{V} = \sum \text{?} {h}_{( v , l )}^{V} = {HI}_{v}^{V} \times \sum \text{?} {t}_{{f}_{l}^{L}} = {HI}_{v}^{V} \times {t}_{{f}_{v}^{V}}$$
$${h}_{v}^{V} = \frac{\text{?}}{\text{?}} = \frac{\text{?}}{\text{?}} = \text{?} \text{?}$$
$$\text{?} \text{indicates text missing or illegible when filed}$$
an average number of times of stopping of the lane Lₗ is reckoned as follows:
$${\overline{h}}_{l}^{L} = \frac{\text{?}}{\text{?}} = \frac{\text{?}}{\text{?}} \times \frac{\text{?}}{\text{?}} = {HI}_{I}^{L} \times {t}_{{f}_{l}^{L}}$$
$${\overline{h}}_{l}^{L} = \frac{\text{?}}{\text{?}} = \frac{\text{?}}{\text{?}} = \text{?} \text{?}$$
$$\text{?} \text{indicates text missing or illegible when filed}$$
an average number of times of stopping of the subsection Uᵤ is reckoned as follows:
$${\overline{h}}_{u}^{U} = \frac{\text{?}}{\text{?}} = \frac{\text{?}}{\text{?}} \times \frac{\text{?}}{\text{?}} = {HI}_{u}^{U} \times {t}_{{f}_{u}^{U}}$$
$${\overline{h}}_{u}^{U} = \frac{\text{?}}{\text{?}} = \frac{\text{?}}{\text{?}} = \text{?} \text{?}$$
$$\text{?} \text{indicates text missing or illegible when filed}$$
an average number of times of stopping of the section Sₛ is reckoned as follows:
$${\overline{h}}_{s}^{S} = \frac{\text{?}}{\text{?}} = \frac{\text{?}}{\text{?}} \times \frac{\text{?}}{\text{?}} = {HI}_{s}^{S} \times {t}_{{f}_{s}^{S}}$$
$${\overline{h}}_{s}^{S} = \frac{\text{?}}{\text{?}} = \frac{\text{?}}{\text{?}} = \text{?} \text{?}$$
$$\text{?} \text{indicates text missing or illegible when filed}$$
an average number of times of stopping of the intersection Iᵢ is reckoned as follows:
$${\overline{h}}_{i}^{I} = \frac{\text{?}}{\text{?}} = \frac{\text{?}}{\text{?}} \times \frac{\text{?}}{\text{?}} = {HI}_{s}^{S} \times {t}_{{f}_{s}^{S}}$$
$${\overline{h}}_{i}^{I} = \frac{\text{?}}{\text{?}} = \frac{\text{?}}{\text{?}} = \text{?} \text{?}$$
$$\text{?} \text{indicates text missing or illegible when filed}$$
an average number of times of stopping of the road Rᵣ is reckoned as follows:
$${\overline{h}}_{r}^{R} = \frac{\text{?}}{\text{?}} = \frac{\text{?}}{\text{?}} \times \frac{\text{?}}{\text{?}} = {HI}_{r}^{R} \times {t}_{{f}_{r}^{R}}$$
$${\overline{h}}_{r}^{R} = \frac{\text{?}}{\text{?}} = \frac{\text{?}}{\text{?}} = \text{?} \text{?}$$
$$\text{?} \text{indicates text missing or illegible when filed}$$
an average number of times of stopping of the sub-zone Z_{z} is reckoned as follows:
$${\overline{h}}_{z}^{Z} = \frac{\text{?}}{\text{?}} = \frac{\text{?}}{\text{?}} \times \frac{\text{?}}{\text{?}} = {HI}_{z}^{Z} \times {t}_{{f}_{z}^{Z}}$$
$${\overline{h}}_{z}^{Z} = \frac{\text{?}}{\text{?}} = \frac{\text{?}}{\text{?}} = \text{?} \text{?}$$
$$\text{?} \text{indicates text missing or illegible when filed}$$
an average number of times of stopping of the zone is reckoned as follows:
$${\overline{h}}^{A} = \frac{\text{?}}{\text{?}} = \frac{\text{?}}{\text{?}} \times \frac{\text{?}}{\text{?}} = {HI}^{A} \times {t}_{{f}^{A}}$$
$${\overline{h}}^{A} = \frac{\text{?}}{\text{?}} = \frac{\text{?}}{\text{?}} = \text{?} \text{?}$$
$$\text{?} \text{indicates text missing or illegible when filed}$$
wherein hᵥ^{V} is the number of times of stopping of the vehicle Vᵥ; and h̅ₗ^{L}, h̅ᵤ^{U}, h̅ₛ^{S}, h̅ₗ^{L}, h̅ᵣ^{R}, h̅_{z}^{Z}, and h̅^{A} represent the average numbers of times of stopping of the lane Lₗ, the subsection Uᵤ, the second Sₛ, the intersection Iᵢ, the road Rᵣ, the sub-zone Z_{z}, and the zone respectively.

7. The digital road network traffic state reckoning method based on multi-scale calculation according to 1, wherein step S6 specifically comprises:
S601, reckoning the indexes of the mileages of the congested roads of various evaluation objects at the multiple spatial scales, wherein
the index of the mileage of the congested roads of each evaluation object in the road network is a ratio of an overall mileage of a heavily congested road of all the passing vehicles in each evaluation object to the overall free-flow driving time, that is, an average mileage of a heavily congested road of all the passing vehicles in the distance corresponding to the unit free-flow driving time; and
the index of the mileage of the congested road of each evaluation object may be obtained by weighted summation of the traffic weight coefficients and the indexes of the mileages of the congested roads of the vehicles, the lanes, the sub-sections, the sections, and the intersections belonging to the evaluation object, and the index of the mileage of the congested road is in a unit of “m/min”, having an ability to further calculate the proportion of the mileage of the heavily congested road, specifically as follows:
an index of a mileage of a congested road of the vehicle Vᵥ passing the lane Lₗ is reckoned as follows:
$${MI}_{( v , l )}^{V} = \frac{{l}_{{C}_{( v , l )}^{V}}}{{t}_{{f}_{( v , l )}^{V}}} {MI}_{( v , l )}^{V} = \frac{{l}_{c ( v , l )}^{V}}{{t}_{f ( v , l )}^{V}}$$
an index of a mileage of a congested road of the vehicle Vᵥ is reckoned as follows:
$${MI}_{v}^{V} = \frac{\text{?}}{\text{?}} = \frac{\text{?}}{\text{?}} \times \frac{\text{?}}{\text{?}} = \frac{\text{?}}{\text{?}}$$
$${MI}_{v}^{V} = \frac{\text{?}}{\text{?}} = \frac{\text{?}}{\text{?}} = \frac{\text{?}}{\text{?}}$$
$$\text{?} \text{indicates text missing or illegible when filed}$$
an index of a mileage of a congested road of the lane Lₗ is reckoned as follows:
$${MI}_{l}^{L} = \frac{\text{?}}{\text{?}} = \frac{\text{?}}{\text{?}} \times \frac{\text{?}}{\text{?}} = \frac{\text{?}}{\text{?}}$$
$${MI}_{l}^{L} = \frac{\text{?}}{\text{?}} = \frac{\text{?}}{\text{?}} = \frac{\text{?}}{\text{?}}$$
$$\text{?} \text{indicates text missing or illegible when filed}$$
an index of a mileage of a congested road of the subsection Uᵤ is reckoned as follows:
$${MI}_{u}^{U} = \frac{{\sum }_{l ∈ {S}_{U , u}^{L}} {\sum }_{v ∈ {S}_{L , l}^{V}} \text{?}}{{\sum }_{l ∈ {S}_{U , u}^{L}} {\sum }_{v ∈ {S}_{L , l}^{V}} {t}_{{f}_{( v , l )}}^{V}} = \frac{{\sum }_{l ∈ {S}_{U , u}^{L}} {\sum }_{v ∈ {S}_{L , l}^{V}} ( \text{?} \times \text{?} )}{{\sum }_{l ∈ {S}_{U , u}^{L}} {\sum }_{v ∈ {S}_{L , l}^{V}} \text{?}} = \frac{{\sum }_{l ∈ {S}_{U , u}^{L}} ( \text{?} \times \text{?} )}{{\sum }_{l ∈ {S}_{U , u}^{L}} \text{?}}$$
$${MI}_{u}^{U} = \frac{\text{?}}{\text{?}} = \frac{\text{?}}{\text{?}} = \frac{\text{?}}{\text{?}}$$
$$\text{?} \text{indicates text missing or illegible when filed}$$
an index of a mileage of a congested road of the section Sₛ is reckoned as follows:
$${MI}_{s}^{S} = \frac{{\sum }_{u ∈ {S}_{S , s}^{U}} {\sum }_{l ∈ {S}_{U , u}^{L}} {\sum }_{v ∈ {S}_{L , l}^{V}} \text{?}}{{\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}}^{V}} = \frac{{\sum }_{l ∈ {S}_{S , s}^{L}} {\sum }_{v ∈ {S}_{L , l}^{V}} ( \text{?} \times {w}_{( v , l )}^{V} )}{{\sum }_{l ∈ {S}_{S , s}^{L}} {\sum }_{v ∈ {S}_{L , l}^{V}} {w}_{( v , l )}^{V}} = \frac{{\sum }_{l ∈ {S}_{S , s}^{L}} ( \text{?} \times {w}_{l}^{L} )}{{\sum }_{l ∈ {S}_{S , s}^{L}} {w}_{l}^{L}} = \frac{{\sum }_{u ∈ {S}_{S , s}^{U}} ( \text{?} \times {w}_{u}^{U} )}{{\sum }_{u ∈ {S}_{S , s}^{U}} {w}_{u}^{U}}$$
$${MI}_{s}^{S} = \frac{\text{?}}{\text{?}} = \frac{\text{?}}{\text{?}} = \frac{\text{?}}{\text{?}} = \frac{\text{?}}{\text{?}}$$
$$\text{?} \text{indicates text missing or illegible when filed}$$
an index of a mileage of a congested road of the intersection Iᵢ is reckoned as follows:
$${MI}_{i}^{I} = \frac{{\sum }_{l ∈ {S}_{I , i}^{L}} {\sum }_{v ∈ {S}_{L , l}^{V}} \text{?}}{{\sum }_{l ∈ {S}_{I , i}^{L}} {\sum }_{v ∈ {S}_{L , l}^{V}} {t}_{{f}_{( v , l )}}^{V}} = \frac{{\sum }_{l ∈ {S}_{I , i}^{L}} {\sum }_{v ∈ {S}_{L , l}^{V}} ( \text{?} \times {w}_{( v , l )}^{V} )}{{\sum }_{l ∈ {S}_{I , i}^{L}} {\sum }_{v ∈ {S}_{L , l}^{V}} {w}_{( v , l )}^{V}} = \frac{{\sum }_{l ∈ {S}_{I , i}^{L}} ( \text{?} \times {w}_{l}^{L} )}{{\sum }_{l ∈ {S}_{I , i}^{L}} {w}_{l}^{L}}$$
$${MI}_{i}^{I} = \frac{\text{?}}{\text{?}} = \frac{\text{?}}{\text{?}} = \frac{\text{?}}{\text{?}}$$
$$\text{?} \text{indicates text missing or illegible when filed}$$
an index of a mileage of a congested road of the road Rᵣ is reckoned as follows:
$${MI}_{r}^{R} = \frac{\begin{matrix}{\sum }_{s ∈ {S}_{R , r}^{S}} {\sum }_{u ∈ {S}_{S , s}^{U}} {\sum }_{l ∈ {S}_{U , u}^{L}} {\sum }_{v ∈ {S}_{L , l}^{V}} \text{?} + \\ \text{?} {\sum }_{l ∈ {S}_{I , i}^{L}} {\sum }_{v ∈ {S}_{L , l}^{V}} \text{?}\end{matrix}}{\begin{matrix}{\sum }_{s ∈ {S}_{R , r}^{S}} {\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}}^{V} + \\ \text{?} {\sum }_{l ∈ {S}_{I , i}^{L}} {\sum }_{v ∈ {S}_{L , l}^{V}} {t}_{{f}_{( v , l )}}^{V}\end{matrix}} = \frac{{\sum }_{l ∈ {S}_{R , r}^{L}} {\sum }_{v ∈ {S}_{L , l}^{V}} \text{?}}{{\sum }_{l ∈ {S}_{R , r}^{L}} {\sum }_{v ∈ {S}_{L , l}^{V}} {t}_{{f}_{( v , l )}}^{V}} = \frac{{\sum }_{l ∈ {S}_{R , r}^{L}} ( \text{?} \times {w}_{l}^{L} )}{{\sum }_{l ∈ {S}_{R , r}^{L}} {w}_{l}^{L}}$$
$${MI}_{r}^{R} = \frac{\text{?}}{\text{?}} = \frac{\text{?}}{\text{?}} = \frac{\text{?}}{\text{?}}$$
$$\text{?} \text{indicates text missing or illegible when filed}$$
an index of a mileage of a congested road of the sub-zone Z_{z} is reckoned as follows:
$${MI}_{z}^{Z} = \frac{\begin{matrix}{\sum }_{s ∈ {S}_{Z , z}^{S}} {\sum }_{u ∈ {S}_{S , s}^{U}} {\sum }_{l ∈ {S}_{U , u}^{L}} {\sum }_{v ∈ {S}_{L , l}^{V}} \text{?} + \\ \text{?} {\sum }_{l ∈ {S}_{I , i}^{L}} {\sum }_{v ∈ {S}_{L , l}^{V}} \text{?}\end{matrix}}{\begin{matrix}{\sum }_{s ∈ {S}_{Z , z}^{S}} {\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}}^{V} + \\ \text{?} {\sum }_{l ∈ {S}_{I , i}^{L}} {\sum }_{v ∈ {S}_{L , l}^{V}} {t}_{{f}_{( v , l )}}^{V}\end{matrix}} = \frac{{\sum }_{l ∈ {S}_{Z , z}^{L}} {\sum }_{v ∈ {S}_{L , l}^{V}} \text{?}}{{\sum }_{l ∈ {S}_{Z , z}^{L}} {\sum }_{v ∈ {S}_{L , l}^{V}} {t}_{{f}_{( v , l )}}^{V}} = \frac{{\sum }_{l ∈ {S}_{Z , z}^{L}} ( \text{?} \times {w}_{l}^{L} )}{{\sum }_{l ∈ {S}_{Z , z}^{L}} {w}_{l}^{L}}$$
$${MI}_{z}^{Z} = \frac{\text{?}}{\text{?}} = \frac{\text{?}}{\text{?}} = \frac{\text{?}}{\text{?}}$$
$$\text{?} \text{indicates text missing or illegible when filed}$$
an index of a mileage of a congested road of the zone is reckoned as follows:
$${MI}^{A} = \frac{\begin{matrix}{\sum }_{s ∈ {S}_{A}^{S}} {\sum }_{u ∈ {S}_{S , s}^{U}} {\sum }_{l ∈ {S}_{U , u}^{L}} {\sum }_{v ∈ {S}_{L , l}^{V}} \text{?} + \\ \text{?} {\sum }_{l ∈ {S}_{I , i}^{L}} {\sum }_{v ∈ {S}_{L , l}^{V}} \text{?}\end{matrix}}{\begin{matrix}{\sum }_{s ∈ {S}_{A}^{S}} {\sum }_{u ∈ {S}_{S , s}^{U}} {\sum }_{l ∈ {S}_{U , u}^{L}} {\sum }_{v ∈ {S}_{L , l}^{V}} {t}_{{f}_{( v , l )}}^{V} + \\ \text{?} {\sum }_{l ∈ {S}_{I , i}^{L}} {\sum }_{v ∈ {S}_{L , l}^{V}} {t}_{{f}_{( v , l )}}^{V}\end{matrix}} = \frac{{\sum }_{l ∈ {S}_{A}^{L}} {\sum }_{v ∈ {S}_{L , l}^{V}} \text{?}}{{\sum }_{l ∈ {S}_{A}^{L}} {\sum }_{v ∈ {S}_{L , l}^{V}} {t}_{{f}_{( v , l )}}^{V}} = {\sum }_{l ∈ {S}_{A}^{L}} ( {MI}_{l}^{L} \times {w}_{l}^{L} )$$
$${MI}^{A} = \frac{\text{?}}{\text{?}} = \frac{\text{?}}{\text{?}} = ( \text{?} )$$
$$\text{?} \text{indicates text missing or illegible when filed}$$
wherein MI_{(v,l)}^{V} is the index of the mileage of the congested road of the vehicle Vᵥ on the lane Lₗ; l_{c(v,l)}^{V} is the mileage of the congested road of the vehicle Vᵥ passing the lane Lₗ; and MIᵥ^{V}, MIₗ^{L}, MIᵤ^{U}, MIₛ^{S}, MIᵢ^{I}, MIᵣ^{R}, MI_{z}^{Z}, and MI^{A} represent the indexes of the mileages of the congested roads of the vehicle Vᵥ, the lane Lₗ, the subsection Uᵤ, the section Sₛ, the intersection Iᵢ, the road Rᵣ, the sub-zone Z_{z}, and the zone respectively; and
S602, calculating the proportions of the mileages of the heavily congested roads of various evaluation objects, wherein
according to the acquired index of the mileage of the congested road of the different evaluation objects at the multiple spatial scales, the proportion of the mileage of the heavily congested road of each evaluation object is calculated, which is specifically as follows:
a proportion of a mileage of a heavily congested road of the vehicle Vᵥ passing the lane Lₗ is reckoned as follows:
$${m}_{( v , l )}^{V} = \frac{\text{?}}{\text{?}} = \frac{\text{?}}{{t}_{{f}_{( v , l )}}^{V}} \times \frac{\text{?}}{\text{?}} = \frac{\text{?}}{\text{?}} {m}_{( v , l )}^{V} = \frac{{l}_{c ( v , l )}^{V}}{{l}_{( v , l )}^{V}} = \frac{{l}_{c ( v , l )}^{V}}{{t}_{f ( v , l )}^{V}} \text{?} \frac{{t}_{f ( v , l )}^{V}}{{l}_{( v , l )}^{V}} = \frac{{MI}_{( v , l )}^{V}}{{V}_{f ( v , l )}^{V}}$$
$$\text{?} \text{indicates text missing or illegible when filed}$$
a proportion of a mileage of a heavily congested road of the vehicle Vᵥ is reckoned as follows:
$${m}_{v}^{V} = \frac{\text{?}}{{\sum }_{l ∈ {S}_{V , v}^{L}} {l}_{( v , l )}^{V}} = \frac{{\sum }_{l ∈ {S}_{V , v}^{L}} \text{?}}{{\sum }_{l ∈ {S}_{V , v}^{L}} \text{?}} \times \frac{{\sum }_{l ∈ {S}_{V , v}^{L}} \text{?}}{{\sum }_{l ∈ {S}_{V , v}^{L}} {l}_{( v , l )}^{V}} = \frac{{MI}_{v}^{V}}{{\overline{{V}_{f}}}_{v}^{V}}$$
$${m}_{v}^{V} = \frac{\text{?}}{\text{?}} = \frac{\text{?}}{\text{?}} = \frac{{MI}_{v}^{V}}{{\overline{{V}_{f}}}_{v}^{V}}$$
$$\text{?} \text{indicates text missing or illegible when filed}$$
a proportion of a mileage of a heavily congested road of the lane Lₗ is reckoned as follows:
$${m}_{l}^{L} = \frac{{\sum }_{v ∈ {S}_{L , l}^{V}} \text{?}}{{\sum }_{v ∈ {S}_{L , l}^{V}} {l}_{( v , l )}^{V}} = \frac{{\sum }_{v ∈ {S}_{L , l}^{V}} \text{?}}{{\sum }_{v ∈ {S}_{L , l}^{V}} \text{?}} \times \frac{{\sum }_{v ∈ {S}_{L , l}^{V}} \text{?}}{{\sum }_{v ∈ {S}_{L , l}^{V}} {l}_{( v , l )}^{V}} = \frac{{MI}_{l}^{L}}{{\overline{{V}_{f}}}_{l}^{L}}$$
$${m}_{l}^{L} = \frac{\text{?}}{\text{?}} = \frac{\text{?}}{\text{?}} = \frac{{MI}_{l}^{L}}{{\overline{{V}_{f}}}_{l}^{L}}$$
$$\text{?} \text{indicates text missing or illegible when filed}$$
a proportion of a mileage of a heavily congested road of the subsection Uᵤ is reckoned as follows:
$${m}_{u}^{U} = \frac{{\sum }_{l ∈ {S}_{U , u}^{L}} {\sum }_{v ∈ {S}_{L , l}^{V}} \text{?}}{{\sum }_{l ∈ {S}_{U , u}^{L}} {\sum }_{v ∈ {S}_{L , l}^{V}} {l}_{( v , l )}^{V}} = \frac{{\sum }_{l ∈ {S}_{U , u}^{L}} {\sum }_{v ∈ {S}_{L , l}^{V}} \text{?}}{{\sum }_{l ∈ {S}_{U , u}^{L}} {\sum }_{v ∈ {S}_{L , l}^{V}} \text{?}} \times \frac{{\sum }_{l ∈ {S}_{U , u}^{L}} {\sum }_{v ∈ {S}_{L , l}^{V}} \text{?}}{{\sum }_{l ∈ {S}_{U , u}^{L}} {\sum }_{v ∈ {S}_{L , l}^{V}} {l}_{( v , l )}^{V}} = \frac{{MI}_{u}^{U}}{{\overline{{V}_{f}}}_{u}^{U}}$$
$${m}_{u}^{U} = \frac{\text{?}}{\text{?}} = \frac{\text{?}}{\text{?}} = \frac{{MI}_{u}^{U}}{{\overline{{V}_{f}}}_{u}^{U}}$$
$$\text{?} \text{indicates text missing or illegible when filed}$$
a proportion of a mileage of a heavily congested road of the section Sₛ is reckoned as follows:
$${m}_{s}^{S} = \frac{{\sum }_{u ∈ {S}_{S , s}^{U}} {\sum }_{l ∈ {S}_{U , u}^{L}} {\sum }_{v ∈ {S}_{L , l}^{V}} \text{?}}{{\sum }_{u ∈ {S}_{S , s}^{U}} {\sum }_{l ∈ {S}_{U , u}^{L}} {\sum }_{v ∈ {S}_{L , l}^{V}} {l}_{( v , l )}^{V}} = \\ \frac{{\sum }_{u ∈ {S}_{S , s}^{U}} {\sum }_{l ∈ {S}_{U , u}^{L}} {\sum }_{v ∈ {S}_{L , l}^{V}} \text{?}}{{\sum }_{u ∈ {S}_{S , s}^{U}} {\sum }_{l ∈ {S}_{U , u}^{L}} {\sum }_{v ∈ {S}_{L , l}^{V}} \text{?}} \times \frac{{\sum }_{u ∈ {S}_{S , s}^{U}} {\sum }_{l ∈ {S}_{U , u}^{L}} {\sum }_{v ∈ {S}_{L , l}^{V}} \text{?}}{{\sum }_{u ∈ {S}_{S , s}^{U}} {\sum }_{l ∈ {S}_{U , u}^{L}} {\sum }_{v ∈ {S}_{L , l}^{V}} {l}_{( v , l )}^{V}} = \frac{{MI}_{s}^{S}}{{\overline{{V}_{f}}}_{s}^{S}}$$
$${m}_{s}^{S} = \frac{\text{?}}{\text{?}} = \frac{\text{?}}{\text{?}} = \frac{{MI}_{s}^{S}}{{\overline{{V}_{f}}}_{s}^{S}}$$
$$\text{?} \text{indicates text missing or illegible when filed}$$
a proportion of a mileage of a heavily congested road of the intersection Iᵢ is reckoned as follows:
$${m}_{i}^{I} = \frac{{\sum }_{l ∈ {S}_{I , i}^{L}} {\sum }_{v ∈ {S}_{L , l}^{V}} \text{?}}{{\sum }_{l ∈ {S}_{I , i}^{L}} {\sum }_{v ∈ {S}_{L , l}^{V}} {l}_{( v , l )}^{V}} = \frac{{\sum }_{l ∈ {S}_{I , i}^{L}} {\sum }_{v ∈ {S}_{L , l}^{V}} \text{?}}{{\sum }_{l ∈ {S}_{I , i}^{L}} {\sum }_{v ∈ {S}_{L , l}^{V}} \text{?}} \times \frac{{\sum }_{l ∈ {S}_{I , i}^{L}} {\sum }_{v ∈ {S}_{L , l}^{V}} \text{?}}{{\sum }_{l ∈ {S}_{I , i}^{L}} {\sum }_{v ∈ {S}_{L , l}^{V}} {l}_{( v , l )}^{V}} = \frac{{MI}_{i}^{I}}{{\overline{{V}_{f}}}_{i}^{I}}$$
$${m}_{i}^{I} = \frac{\text{?}}{\text{?}} = \frac{\text{?}}{\text{?}} = \frac{{MI}_{i}^{I}}{{\overline{{V}_{f}}}_{i}^{I}}$$
$$\text{?} \text{indicates text missing or illegible when filed}$$
a proportion of a mileage of a heavily congested road of the road Rᵣ is reckoned as follows:
$${m}_{r}^{R} = \frac{{\sum }_{l ∈ {S}_{R , r}^{L}} {\sum }_{v ∈ {S}_{L , l}^{V}} \text{?}}{{\sum }_{l ∈ {S}_{R , r}^{L}} {\sum }_{v ∈ {S}_{L , l}^{V}} {l}_{( v , l )}^{V}} = \frac{{\sum }_{l ∈ {S}_{R , r}^{L}} {\sum }_{v ∈ {S}_{L , l}^{V}} \text{?}}{{\sum }_{l ∈ {S}_{R , r}^{L}} {\sum }_{v ∈ {S}_{L , l}^{V}} \text{?}} \times \frac{{\sum }_{l ∈ {S}_{R , r}^{L}} {\sum }_{v ∈ {S}_{L , l}^{V}} \text{?}}{{\sum }_{l ∈ {S}_{R , r}^{L}} {\sum }_{v ∈ {S}_{L , l}^{V}} {l}_{( v , l )}^{V}} = \frac{{MI}_{r}^{R}}{{\overline{{V}_{f}}}_{r}^{R}}$$
$${m}_{r}^{R} = \frac{\text{?}}{\text{?}} = \frac{\text{?}}{\text{?}} = \frac{{MI}_{r}^{R}}{{\overline{{V}_{f}}}_{r}^{R}}$$
$$\text{?} \text{indicates text missing or illegible when filed}$$
a proportion of a mileage of a heavily congested road of the sub-zone Z_{z} is reckoned as follows:
$${m}_{z}^{Z} = \frac{{\sum }_{l ∈ {S}_{Z , z}^{L}} {\sum }_{v ∈ {S}_{L , l}^{V}} \text{?}}{{\sum }_{l ∈ {S}_{Z , z}^{L}} {\sum }_{v ∈ {S}_{L , l}^{V}} {l}_{( v , l )}^{V}} = \frac{{\sum }_{l ∈ {S}_{Z , z}^{L}} {\sum }_{v ∈ {S}_{L , l}^{V}} \text{?}}{{\sum }_{l ∈ {S}_{Z , z}^{L}} {\sum }_{v ∈ {S}_{L , l}^{V}} \text{?}} \times \frac{{\sum }_{l ∈ {S}_{Z , z}^{L}} {\sum }_{v ∈ {S}_{L , l}^{V}} \text{?}}{{\sum }_{l ∈ {S}_{Z , z}^{L}} {\sum }_{v ∈ {S}_{L , l}^{V}} {l}_{( v , l )}^{V}} = \frac{{MI}_{z}^{Z}}{{\overline{{V}_{f}}}_{z}^{Z}}$$
$${m}_{z}^{Z} = \frac{\text{?}}{\text{?}} = \frac{\text{?}}{\text{?}} = \frac{{MI}_{z}^{Z}}{{\overline{{V}_{f}}}_{z}^{Z}}$$
$$\text{?} \text{indicates text missing or illegible when filed}$$
a proportion of a mileage of a heavily congested road of the zone is reckoned as follows:
$${m}^{A} = \frac{{\sum }_{l ∈ {S}_{A}^{L}} {\sum }_{v ∈ {S}_{L , l}^{V}} \text{?}}{{\sum }_{l ∈ {S}_{A}^{L}} {\sum }_{v ∈ {S}_{L , l}^{V}} {l}_{( v , l )}^{V}} = \frac{{\sum }_{l ∈ {S}_{A}^{L}} {\sum }_{v ∈ {S}_{L , l}^{V}} \text{?}}{{\sum }_{l ∈ {S}_{A}^{L}} {\sum }_{v ∈ {S}_{L , l}^{V}} \text{?}} \times \frac{{\sum }_{l ∈ {S}_{A}^{L}} {\sum }_{v ∈ {S}_{L , l}^{V}} \text{?}}{{\sum }_{l ∈ {S}_{A}^{L}} {\sum }_{v ∈ {S}_{L , l}^{V}} {l}_{( v , l )}^{V}} = \frac{{MI}^{A}}{{\overline{{V}_{f}}}^{A}}$$
$${m}^{A} = \frac{\text{?}}{\text{?}} = \frac{\text{?}}{\text{?}} = \frac{{MI}^{A}}{{\overline{{V}_{f}}}^{A}}$$
$$\text{?} \text{indicates text missing or illegible when filed}$$
wherein m_{(v,l)}^{V} is the proportion of the mileage of the heavily congested road of the vehicle Vᵥ on the lane Lₗ; l_{(v,l)}^{V} is a vehicle mileage of the vehicle Vᵥ passing the lane Lt; V_{f(v,l)}^{V} is a flow-free driving speed of the vehicle Vᵥ passing the lane Lₗ; mᵥ^{V}, mₗ^{L}, mᵤ^{U}, mₛ^{S}, mᵢ^{I}, mᵣ^{R}, m_{z}^{Z}, and m^{A} represent proportions of mileages of heavily congested roads of the vehicle Vᵥ, the lane Lₗ, the subsection Uᵤ, the section Sₛ, the intersection Iᵢ, the road Rᵣ, the sub-zone Z_{z}, and the zone respectively; and V̅_{fv}^{V}, V̅_{fl}^{L}, V̅_{fu}^{U}, V̅_{fs}^{S}, V̅_{fi}^{I}, V̅_{fr}^{R}, V̅_{fz}^{Z}, and V̅_{f}^{A} represent average flow-free driving speeds of the vehicle Vᵥ, the lane Lₗ, the subsection Uᵤ, the section Sₛ, the intersection Iᵢ, the road Rᵣ, the sub-zone Z_{z}, and the zone respectively.

8. The digital road network traffic state reckoning method based on multi-scale calculation according to 1, wherein a new method for calculating traffic operation state evaluation characteristic indexes is formed collectively by four indexes: the traffic operation index, the delay time index, the index of the number of times of stopping, and the index of the mileage of the congested road, wherein the larger the traffic operation index, the delay time index, the index of the number of times of stopping, and the index of the mileage of the congested road are, the worse the traffic operation state is, that is, the more congested the road traffic is.
